(19) United States
(12) Patent Application Publication
(10) Pub. No.: US 2026/0251861 A1
(43) Pub. Date: Aug. 27, 2026

(54) 3D PRINTED REFLECTOR STRUCTURE IN CAVITY

(71) Applicant: POET Technologies, Inc., Petaluma, CA (US)

(72) Inventor: SURESH VENKATESAN, Los Gatos, CA (US)

(21) Appl. No.: 19/548,262

(22) Filed: Feb. 24, 2026

Related U.S. Application Data
(60) Provisional application No. 63/762,164, filed on Feb. 24, 2025.

(51) Int. Cl. G02B 6/42

(52) U.S. Cl. CPC G02B 6/4214; G02B 6/4228; G02B 6/424; G02B 6/4245

(57) ABSTRACT

Reflector structures in photonic integrated circuits may be formed using two-photon polymerization within cavities that intersect planar waveguides. A reflector structure may comprise a substrate having a planar waveguide, a cavity formed in the substrate that intersects the core of the planar waveguide, and a reflector element formed in the cavity using two-photon polymerization. The reflector element may comprise a reflector base, a reflector top, or both. The reflector element may include a reflective surface configured to redirect optical signals between the planar waveguide and a mounted device positioned above or below the cavity. The contoured reflective surface may be planar, curved in two dimensions, or curved in three dimensions. A reflective layer may be formed on the contoured surface, or the reflector may operate by total internal reflection. Integrated lens features may be formed with the reflector element to condition optical signals, improving coupling efficiency to mounted devices.

### CROSS REFERENCE TO RELATED APPLICATIONS

This application claims the benefit of priority to U.S. Provisional Application No. 63/762,164, entitled, “3D Printed Reflector Structure in Cavity”, filed Feb. 24, 2025, the entirety of which is incorporated herein by reference.

### BACKGROUND

This disclosure relates to photonic integrated circuits and, more particularly, to techniques for coupling optical signals between planar waveguides and optical devices mounted on a substrate.

Photonic integrated circuits (PICs) rely on the efficient guidance and manipulation of light within planar waveguides fabricated on a substrate. In some implementations, an optical signal is exchanged between a planar waveguide and an optical device mounted on the substrate and positioned outside the primary optical signal propagation plane of the planar waveguide. Examples of such mounted devices include photodetectors and other receiving devices, lasers and other emitting devices, and optical fibers.

Existing approaches for coupling optical signals between planar waveguides and mounted devices may be constrained by coupling performance, fabrication considerations, and operational bandwidth. In addition, such coupling may be sensitive to installation and alignment variations and may present integration challenges with established fabrication processes.

There remains interest in coupling techniques that provide reliable optical signal transfer between planar waveguides and mounted devices while remaining compatibility with semiconductor fabrication processes.

### BRIEF DESCRIPTION OF THE DRAWINGS

Embodiments disclosed herein pertain to the formation of photonic integrated circuit assemblies comprising planar waveguides coupled to one or more mounted or otherwise integrated optical devices.

FIG. 1A shows a schematic cross-sectional drawing of an embodiment of an upward-facing reflector structure comprising a substrate having a planar waveguide, a cavity formed in the substrate that intersects the planar waveguide, a reflector base formed in the cavity using two-photon polymerization, and a reflective layer formed on the reflector base.

FIG. 1B shows a schematic cross-sectional drawing of an embodiment of a downward-facing reflector structure comprising a substrate having a planar waveguide, a cavity formed in the substrate that intersects the planar waveguide, a reflector base formed in the cavity using two-photon polymerization, and a reflective layer formed on the reflector base.

FIG. 1C shows a schematic cross-sectional drawing of an embodiment of an upward-facing reflector structure configured as a TIR reflector wherein the reflector structure comprises a substrate having a planar waveguide, a cavity formed in the substrate that intersects the planar waveguide, and a reflector top formed in the cavity using two-photon polymerization.

FIG. 1D shows a schematic cross-sectional drawing of an embodiment of a downward-facing reflector structure configured as a TIR reflector wherein the reflector structure comprises a substrate having a planar waveguide, a cavity formed in the substrate that intersects the planar waveguide, and a reflector base formed in the cavity using two-photon polymerization.

FIG. 2A shows a schematic cross-sectional drawing of the embodiment of the upward-facing reflector structure of FIG. 1A further comprising an optional reflector top formed using two-photon polymerization wherein the reflector top includes one or more optional lens features.

FIG. 2B shows a schematic cross-sectional drawing of the embodiment of the downward-facing reflector structure of FIG. 1B further comprising an optional reflector top and one or more optional lens features formed in the reflector base using two-photon polymerization.

FIG. 2C shows a schematic cross-sectional drawing of the embodiment of the upward-facing TIR reflector structure of FIG. 1C further comprising an optional reflector base and two optional lens features formed in the reflector top wherein the optional lens features are formed using two-photon polymerization.

FIG. 2D shows a schematic cross-sectional drawing of the embodiment of the downward-facing TIR reflector structure of FIG. 1D further comprising an optional reflector top and two optional lens features formed in the reflector base wherein the optional lens features are formed using two-photon polymerization.

FIG. 2E shows a schematic top view drawing of an embodiment of a reflector structure as in FIG. 2A having the optional lens features formed using two-photon polymerization.

FIG. 2F shows a schematic top view drawing of an embodiment of a reflector structure as in FIG. 2C having the optional lens features formed using two-photon polymerization.

FIG. 2G shows a table having a summary of some features of the embodiments shown in FIGS. 1A-1D and 2A-2D.

FIG. 3A shows a schematic perspective drawing of a two-photon polymerization apparatus forming a reflector base in a cavity as in an embodiment of a reflector structure.

FIG. 3B shows a schematic perspective drawing of a two-photon polymerization apparatus forming a reflector top in a cavity as in an embodiment of a reflector structure.

FIG. 4A shows a schematic perspective drawing of a reflector base that may be used in the formation of upward-facing embodiments wherein the reflector base is configured having a linear slope.

FIG. 4B shows a schematic perspective drawing of a reflector top that may be used in the formation of upward-facing embodiments wherein the reflector top is configured having a linear slope.

FIG. 4C shows a schematic perspective drawing of a reflector base that may be used in the formation of downward-facing embodiments wherein the reflector base is configured having a linear slope.

FIG. 4D shows a schematic perspective drawing of a reflector top that may be used in the formation of downward-facing embodiments wherein the reflector top is configured having a linear slope.

FIG. 4E shows a schematic perspective drawing of a reflector base that may be used in the formation of upward-facing embodiments wherein the reflector base is configured having two-dimensional curvature.

FIG. 4F shows a schematic perspective drawing of a reflector top that may be used in the formation of upward-facing embodiments wherein the reflector top is configured having two-dimensional curvature.

FIG. 4G shows a schematic perspective drawing of a reflector base that may be used in the formation of downward-facing embodiments wherein the reflector base is configured having two-dimensional curvature.

FIG. 4H shows a schematic perspective drawing of a reflector top that may be used in the formation of downward-facing embodiments wherein the reflector top is configured having two-dimensional curvature.

FIG. 4I shows a schematic perspective drawing of a reflector base that may be used in the formation of upward-facing embodiments wherein the reflector base is configured having three-dimensional curvature.

FIG. 4J shows a schematic perspective drawing of a reflector top that may be used in the formation of upward-facing embodiments wherein the reflector top is configured having three-dimensional curvature.

FIG. 4K shows a schematic perspective drawing of a reflector base that may be used in the formation of downward-facing embodiments wherein the reflector base is configured having three-dimensional curvature.

FIG. 4L shows a schematic perspective drawing of a reflector top that may be used in the formation of downward-facing embodiments wherein the reflector top is configured having three-dimensional curvature.

FIG. 5A shows a schematic perspective drawing of an embodiment of an upward-facing reflector structure having a reflector base formed in a cavity, wherein the reflector structure is configured to reflect an optical signal through the top of the cavity.

FIG. 5B shows a schematic perspective drawing of an embodiment of a downward-facing reflector structure having a reflector base formed in a cavity, wherein the reflector structure is configured to reflect an optical signal through the bottom of the cavity.

FIG. 5C shows a schematic perspective drawing of an embodiment of an upward-facing reflector structure having a reflector top formed in a cavity, wherein the reflector structure is configured to reflect an optical signal through the top of the cavity.

FIG. 5D shows a schematic perspective drawing of an embodiment of a downward-facing reflector structure having a reflector top formed in a cavity, wherein the reflector structure is configured to reflect an optical signal through the bottom of the cavity.

FIG. 5E shows a schematic perspective drawing of an embodiment of an upward-facing reflector structure having a reflector base formed in a cavity and a reflector top formed on the reflector base wherein the reflector structure is configured to reflect an optical signal through the top of the cavity.

FIG. 5F shows a schematic perspective drawing of an embodiment of a downward-facing reflector structure having a reflector base formed in a cavity and a reflector top formed on the reflector base wherein the reflector structure is configured to reflect an optical signal through the bottom of the cavity.

FIG. 6 shows a schematic perspective drawing of a cavity formed in a substrate wherein a wall of the cavity intersects a planar waveguide to form a terminal facet of the planar waveguide.

FIG. 7 shows a flowchart for method 190 of forming a cavity in an interposer substrate wherein the cavity intersects a planar waveguide.

FIG. 8A shows cross-sectional schematic drawing of an interposer substrate having a planar waveguide and an optional electrical interconnect layer formed on a substrate as in Step 190-1 of method 190.

FIG. 8B shows a cross-sectional schematic drawing of a patterned mask layer formed on an interposer substrate as in Step 190-2 of method 190.

FIG. 8C shows a cross-sectional schematic drawing of an interposer substrate having a cavity formed in a planar waveguide layer as in Step 190-3 of method 190.

FIG. 8D shows a cross-sectional schematic drawing of an interposer substrate having a cavity formed in a planar waveguide layer after removal of a patterned mask layer that illustrates the formation of a substrate having a cavity that intersects a planar waveguide formed in the substrate within which a reflector base may be formed in embodiments using two-photon polymerization.

FIG. 9A shows a schematic cross-sectional drawing that illustrates the divergence of an example optical signal propagating from a planar waveguide in an embodiment of a reflector structure.

FIG. 9B shows a schematic cross-sectional drawing that illustrates the reduction in divergence of an example optical signal propagating from a patterned planar waveguide core in an embodiment of a reflector structure configured having a spot size converter.

FIG. 10A shows a schematic cross-sectional drawing of a PIC assembly comprising an embodiment of a reflector structure configured having a reflective layer and formed in a cavity using two-photon polymerization wherein the reflector structure is configured having a spot size converter, and wherein the PIC assembly includes a mounted photodiode receptive to an optical signal reflected from the reflector structure.

FIG. 10B shows a schematic cross-sectional drawing of a PIC assembly comprising an embodiment of a reflector structure configured as a TIR reflector and formed in a cavity using two-photon polymerization wherein the reflector top is configured having a curved contoured reflecting surface, an optional lens feature, and a spot size converter, and wherein the PIC assembly includes a mounted photodiode receptive to an optical signal reflected from the reflector structure.

FIG. 10C shows a schematic cross-sectional drawing of a PIC assembly comprising an embodiment of a reflector structure configured having a reflective layer and formed in a cavity using two-photon polymerization wherein the substrate having the reflector structure is mounted on a mounting structure and wherein the reflector structure is configured to reflect an optical signal from a planar waveguide toward the bottom of the cavity.

FIG. 10D shows a schematic cross-sectional drawing of a PIC assembly comprising an embodiment of a reflector structure configured as a TIR reflector and formed in a cavity using two-photon polymerization wherein the substrate having the reflective structure is mounted on a mounting structure and wherein the reflector structure is configured to reflect an optical signal from a planar waveguide toward the bottom of the cavity.

FIG. 11 shows a schematic cross-sectional drawing of a PIC assembly comprising an embodiment of a reflector structure and a mounted photodiode wherein the reflector structure is configured as a TIR reflector formed using two-photon polymerization wherein the reflector top of the reflector structure further comprises one or more of a lens feature and a lens mount formed using two-photon polymerization.

FIG. 12 shows a schematic cross-sectional drawing of a PIC assembly comprising an embodiment of a reflector structure and a mounted optical fiber cable wherein the reflector structure is configured as a TIR reflector and formed using two-photon polymerization and wherein the reflector structure further comprises an optional lens feature formed between the reflector top and an end facet of the mounted optical fiber.

FIG. 13A shows a flowchart for method 182 of forming embodiments of an upward-facing reflector structure configured having a reflective layer formed on a reflector base wherein the reflector base is formed using two-photon polymerization.

FIG. 13B shows a flowchart for the formation of an optional reflector top on an embodiment of an upward-facing reflector structure configured having a reflective layer and formed using method 182 wherein the optional reflector top is formed on the reflective layer using two-photon polymerization.

FIG. 13C shows a flowchart for the formation of an optional reflector top on an embodiment of an upward-facing reflector structure configured having a reflective layer and formed using method 182 wherein the optional reflector top is formed on the reflective layer using a conformal fill layer.

FIG. 14 shows schematic perspective drawings that illustrate steps in the formation of embodiments formed using method 182.

FIG. 15A shows a flowchart for a method 183 of forming embodiments of an upward-facing reflector structure configured as a TIR reflector wherein the reflector base is firstly formed using two-photon polymerization and wherein the reflector top is subsequently formed using two-photon polymerization.

FIG. 15B shows a flowchart for method 183 of forming embodiments of an upward-facing reflector structure configured as a TIR reflector wherein the reflector base is firstly formed using two-photon polymerization and wherein the reflector top is subsequently formed using a conformal fill layer.

FIG. 16 shows schematic perspective drawings that illustrate steps in the formation of embodiments formed using method 183.

FIG. 17A shows a flowchart for method 184 of forming embodiments of an upward-facing reflector structure configured as a TIR reflector wherein the reflector top is formed using two-photon polymerization.

FIG. 17B shows a flowchart for a method 184 of forming embodiments of an upward-facing reflector structure configured as a TIR reflector wherein the reflector top is firstly formed using two-photon polymerization and wherein the reflector base is subsequently formed using two-photon polymerization.

FIG. 17C shows a flowchart for method 184 of forming embodiments of an upward-facing reflector structure configured as a TIR reflector wherein the reflector top is firstly formed using two-photon polymerization and wherein the reflector base is subsequently formed using a conformal fill layer.

FIG. 18 shows schematic perspective drawings that illustrate steps in the formation of embodiments formed using method 184.

FIG. 19 shows a flowchart for method 185 of forming embodiments of an upward-facing reflector structure configured as a TIR reflector wherein the reflector top is formed using two-photon polymerization.

FIG. 20 shows schematic perspective drawings that illustrate steps in the formation of embodiments formed using method 185.

FIG. 21 shows a flowchart for method 186 of forming embodiments of an upward-facing reflector structure configured having a reflector top formed on a reflective layer wherein the reflector top is formed using two-photon polymerization.

FIG. 22 shows schematic perspective drawings that illustrate steps in the formation of embodiments formed using method 186.

FIG. 23A shows a flowchart for method 192 of forming embodiments of a downward-facing reflector structure configured having a reflective layer formed on a reflector base wherein the reflector base is formed using two-photon polymerization.

FIG. 23B shows a flowchart for the formation of an optional reflector top on an embodiment of a downward-facing reflector structure configured having a reflective layer and formed using method 192 wherein the optional reflector top is formed on the reflective layer using two-photon polymerization.

FIG. 23C shows a flowchart for the formation of an optional reflector top on an embodiment of a downward-facing reflector structure configured having a reflective layer and formed using method 192 wherein the optional reflector top is formed on the reflective layer using a conformal fill layer.

FIG. 24 shows schematic perspective drawings that illustrate steps in the formation of embodiments formed using method 192.

FIG. 25A shows a flowchart for method 193 of forming embodiments of a downward-facing reflector structure configured as a TIR reflector wherein the reflector base is formed using two-photon polymerization (no reflector top).

FIG. 25B shows a flowchart for the formation of an optional reflector top on an embodiment of a downward-facing reflector structure configured as a TIR reflector and formed used the method 193 wherein the optional reflector top is formed using two-photon polymerization.

FIG. 25C shows a flowchart for the formation of an optional reflector top on an embodiment of a downward-facing reflector structure configured as a TIR reflector and formed used the method 193 wherein the optional reflector top is formed using a conformal fill layer.

FIG. 26 shows schematic perspective drawings that illustrate steps in the formation of embodiments formed using method 193.

FIG. 27A shows a flowchart for method 194 of forming embodiments of a downward-facing reflector structure configured as a TIR reflector wherein the reflector top is firstly formed using two-photon polymerization and wherein the reflector base is subsequently formed using two-photon polymerization.

FIG. 27B shows a flowchart for method 194 of forming embodiments of a downward-facing reflector structure configured as a TIR reflector wherein the reflector top is firstly formed using two-photon polymerization, and wherein the reflector base is subsequently formed using a conformal fill layer.

FIG. 28 shows schematic perspective drawings that illustrate steps in the formation of embodiments formed using method 194.

FIG. 29 shows an embodiment of a PIC assembly comprising a plurality of reflector assemblies wherein the reflector assemblies are formed using two-photon polymerization.

FIG. 30A shows a schematic perspective drawing of a reflector base that may be used in the formation of upward-facing embodiments wherein the reflector base is configured having a linear slope and wherein the reflector base is configured to receive a signal from an upper portion of the cavity and reflect the signal to the planar waveguide

FIG. 30B shows a schematic perspective drawing of a reflector top that may be used in the formation of upward-facing embodiments wherein the reflector top is configured having a linear slope.

FIG. 30C shows a schematic perspective drawing of a reflector base that may be used in the formation of downward-facing embodiments wherein the reflector base is configured having a linear slope.

FIG. 30D shows a schematic perspective drawing of a reflector top that may be used in the formation of downward-facing embodiments wherein the reflector top is configured having a linear slope.

FIG. 30E shows a schematic perspective drawing of a reflector base that may be used in the formation of upward-facing embodiments wherein the reflector base is configured having two-dimensional curvature.

FIG. 30F shows a schematic perspective drawing of a reflector top that may be used in the formation of upward-facing embodiments wherein the reflector top is configured having two-dimensional curvature.

FIG. 30G shows a schematic perspective drawing of a reflector base that may be used in the formation of downward-facing embodiments wherein the reflector base is configured having two-dimensional curvature.

FIG. 30H shows a schematic perspective drawing of a reflector top that may be used in the formation of downward-facing embodiments wherein the reflector top is configured having two-dimensional curvature.

FIG. 30I shows a schematic perspective drawing of a reflector base that may be used in the formation of upward-facing embodiments wherein the reflector base is configured having three-dimensional curvature.

FIG. 30J shows a schematic perspective drawing of a reflector top that may be used in the formation of upward-facing embodiments wherein the reflector top is configured having three-dimensional curvature.

FIG. 30K shows a schematic perspective drawing of a reflector base that may be used in the formation of downward-facing embodiments wherein the reflector base is configured having three-dimensional curvature.

FIG. 30L shows a schematic perspective drawing of a reflector top that may be used in the formation of downward-facing embodiments wherein the reflector top is configured having three-dimensional curvature.

FIG. 31A shows a schematic cross-sectional drawing of a PIC assembly configured having a mounted device and an embodiment of an upward-facing reflector structure, wherein the PIC assembly includes a reflector structure receptive to an optical signal from the mounted device, and wherein the reflector structure is configured having a reflective layer and formed in a cavity using two-photon polymerization.

FIG. 31B shows a schematic cross-sectional drawing of a PIC assembly configured having a mounted device and an embodiment of an upward-facing reflector structure, wherein the PIC assembly includes a reflector structure receptive to an optical signal from the mounted device, and wherein the reflector structure is configured as a TIR reflector formed in a cavity using two-photon polymerization.

FIG. 32A shows a schematic cross-sectional drawing of a PIC assembly configured having an underlying mounting structure and an embodiment of a downward-facing reflector structure, wherein the reflector structure is receptive to an optical signal from the underlying mounting structure, and wherein the reflector structure is configured having a reflective layer and is formed in a cavity using two-photon polymerization.

FIG. 32B shows a schematic cross-sectional drawing of a PIC assembly configured having an underlying mounting structure and an embodiment of a downward-facing reflector structure, wherein the reflector structure is receptive to an optical signal from the underlying mounting structure, and wherein the reflector structure is configured as a TIR reflector and formed in a cavity using two-photon polymerization.

Other aspects and features of embodiments will become apparent to those skilled in the art upon review of the following detailed description in conjunction with the accompanying figures.

### DETAILED DESCRIPTION

Embodiments are disclosed herein that pertain to structures, assemblies, and methods of formation of reflector structures used in the formation of photonic integrated circuits wherein the reflector structures are formed in part from two-photon polymerization processes.

Reflector structures are utilized in embodiments to couple optical signals into, and out, of planar waveguides formed on a substrate. A cavity formed in the substrate to intersect the planar waveguide enables access between the axis of the planar waveguide and a device mounted on the substrate to which the reflector is coupled to facilitate the transfer optical signals between the planar waveguide and the mounted device.

Reflector structures formed using two-photon polymerization enable the formation of contoured reflector surfaces. Contoured reflector surfaces are utilized in reflector structures formed using a reflective layer, and in reflector structures formed using the principle of total internal reflectance (TIR) for which a portion of a reflector having a higher index of refraction is formed on a portion of a reflector structure having a lower index of refraction without the requirement for a reflective metal layer, for example.

In methods disclosed herein, all or a portion of the reflector structures are formed using two-photon polymerization. The use of two-photon polymerization to form all or a portion of a reflector structure enables the formation of complex contours, enables the formation of lens features within the reflector structure to facilitate improved focusing of optical signals both prior to incidence on the reflective contour and upon reflection from the reflective contour of the reflective structure. A reflective contour, as used herein, refers to a surface that contributed all or in part to the redirection of optical signals. In reflector structures 100, for example, that have a reflective metal layer formed on a contoured base, the contoured reflective surface may be the reflecting surface of the metal layer. In a TIR reflector, the contoured reflective surface may be the reflecting contour of the higher reflective surface of a reflector top and may include the reflecting contour of the reflector base.

In some embodiments disclosed herein, a reflector structure having a reflective layer is formed, wherein a reflector base is formed using two-photon polymerization, wherein the reflector base is formed in a cavity facing a terminal facet of a planar waveguide intersected by the cavity, and wherein a reflective layer is formed on the reflector base. Two-photon polymerization facilitates the formation of simple and complex surface contours in the base prior to the formation of the reflective layer on the base.

In some embodiments disclosed herein, a reflector structure may be further formed having a reflector top formed on the reflective layer, wherein the reflector top is formed from two photon polymerization, and wherein the reflector top may be formed having a refractive index matching that of the planar waveguide core of the planar waveguide core intersected by the cavity, and wherein the reflector top may be formed having a lens feature to facilitate the focusing of optical signals in one or more of prior to incidence on the reflective layer and after reflection from the reflective layer.

In some embodiments disclosed herein, a reflector structure having a TIR reflector structure is formed, wherein a reflector base is formed using two-photon polymerization, wherein the reflector base is formed in a cavity facing a terminal facet of a planar waveguide intersected by the cavity, and wherein a reflective top is formed on the reflector base having a higher refractive index than that of the base. Two-photon polymerization facilitates the formation of simple and complex surface contours in the base prior to the formation of the reflector top on the base.

In some embodiments disclosed herein, reflector structures configured as TIR reflector structures may be formed having a reflector top formed using two-photon polymerization, wherein the reflector top may be formed having a refractive index matching that of the planar waveguide core of the planar waveguide core intersected by the cavity, and wherein the reflector top may be formed having a lens feature to facilitate the focusing of optical signals in one or more of prior to incidence on the reflective layer and after reflection from the reflective layer.

Embodiments disclosed herein may be configured as upward-facing reflector structures, wherein an upward-facing reflector structure, as used herein, refers to a reflector structure for which an optical signal is reflected from a planar waveguide intersected by the cavity toward an upper portion of the cavity within which the reflector structure is formed. The upper portion of the cavity, as referred to herein, refers to the portion of the cavity firstly formed in a patterning step in the formation of the cavity. (Having the opening.)

Embodiments of assemblies may be formed having an upward-facing reflector structure and a mounted device, wherein the mounted device is mounted to be receptive to reflected optical signals from the planar waveguide. Mounted devices in such assemblies may be, for example, devices having a receiving aperture such as a photodiode, an optical fiber cable, among other devices. And in yet other embodiments of assemblies formed having an upward-facing reflector structure and a mounted device, the planar waveguide may be receptive to an optical signal from the mounted device and reflected by the reflector structure. Mounted devices in such assemblies may be, for example, an optical fiber cable, a device having an emitting feature such as a laser, among other devices.

Other embodiments disclosed herein may be configured as downward-facing reflector structures, wherein a downward-facing reflector structure, as used herein, refers to a reflector structure for which an optical signal is reflected from a planar waveguide intersected by the cavity toward a lower portion of the cavity within which the reflector structure is formed. The lower portion of the cavity, as referred to herein, refers to the portion of the cavity lastly formed in a patterning step in the formation of the cavity. (The closed end.)

Embodiments of assemblies may be formed having a downward-facing reflector structure and a mounted device wherein the mounted device is mounted to be receptive to reflected optical signals from the planar waveguide. Mounted devices in such assemblies may be, for example, an interposer to which the substrate having the reflector structure is mounted and having a receiving aperture, devices having a receiving aperture such as a photodiode, an optical fiber cable, among other devices. And in yet other embodiments of assemblies formed having a reflector structure and a mounted device, the planar waveguide may be receptive to an optical signal from the mounted device and reflected by the reflector structure. Mounted devices in such assemblies may be, for example, an interposer to which the substrate having the reflector structure is mounted wherein the interposer is configured having a receiving aperture, a device having an emitting feature such as a laser, among other devices.

In embodiments of reflector structure described herein formed all or in part using two-photon polymerization, may be formed having reflective surface contours that are linearly sloping with distance from the terminal facet of the planar waveguide intercepted by the cavity, having reflective contours that are sloped in two dimensions with distance from the terminal facet of the planar waveguide intercepted by the cavity, having reflective contours that are sloped in three dimensions with distance from the terminal facet of the planar waveguide intercepted by the cavity, and combinations of these dependencies with distance from the terminal facet.

One or more lens features may be formed within the portion of the reflector structures formed using two-photon polymerization to facilitate the focusing of optical signals prior to incidence on the reflective surface contour of the reflector structure and after reflection.

### Definitions

A “planar waveguide”, as used herein, refers to a signal carrying core and one or more cladding layers surrounding the core. The core layer, typically formed from a layer having a refractive index higher than the surrounding cladding layers, forms a path for the confinement of optical signals. In embodiments, the signal carrying portion of a waveguide may be a single core surrounded by one or more cladding layers. In some embodiments, a rib waveguide may be used wherein the cladding may not completely surround the waveguide core. In some embodiments, the core layer may comprise a plurality of layers that together form a core layer, wherein the layers in the plurality of core layers may have more than one refractive index. In some embodiments, the core layer may comprise a plurality of cores that together form a signal carrying core of a planar waveguide. For simplicity, in embodiments described herein, the core of the planar waveguide is described as a patterned layer having a higher index of refraction than the surrounding layers. It should be understood, however, that other embodiments having signal carrying layers that are formed using one or more of a rib waveguide core, a core comprised of a plurality of layers, and a core comprised of one or more cores, may be used. The core of a planar waveguide may be formed, for example, from silicon, silicon oxynitride, silicon nitride, silicon oxide, among other layers. Cladding layers may be formed, for example, from one or more films having a lower refractive index than the signal carrying core. Examples of cladding layers are silicon oxide, silicon oxynitride, polymer layers, among others.

Two-photon polymerization, two-photon polymerization process, and two-photon polymerization processing, as used herein, refers to a 3D microfabrication technique that leverages the nonlinear optical phenomenon of two-photon absorption to achieve high-resolution, three-dimensional structures. Unlike conventional single-photon polymerization, which relies on linear absorption of light, two-photon polymerization necessitates the simultaneous absorption of two photons by a photosensitive molecule within the focal volume of a tightly focused laser beam. This nonlinear process exhibits a strong intensity dependence, confining the polymerization reaction to a small (sub-diffraction-limited) region.

The two-photon polymerization process typically employs a pulsed laser operating in the near-infrared spectrum, as the low photon energy minimizes linear absorption while maximizing the probability of two-photon absorption within the tightly confined focal volume. A photosensitive resin, herein referred to as two-photon polymerization precursor, comprising molecules that undergo a chemical transformation upon light exposure, is employed as the fabrication medium. As the laser beam is precisely scanned through the resin or precursor, two-photon absorption occurs exclusively at the focal point, initiating polymerization and forming a solid three-dimensional structure. By meticulously controlling the trajectory of the laser beam in three dimensions, intricate three-dimensional shapes can be generated with sub-micrometer resolution. In some embodiments, the resolution of the polymerization structures may be less than one micrometer. In some embodiments, the resolution of the polymerization may be in the range of 0.1 to 1 micrometer. And in some embodiments, the resolution may be less than 0.1 micrometer resolution.

A key advantage of two-photon polymerization lies in its ability to achieve high spatial resolution. The nonlinear nature of two-photon absorption confines the polymerization reaction to a significantly smaller volume compared to single-photon processes, enabling the fabrication of features with sub-micrometer dimensions. The use of two-photon polymerization enables the capability to fabricate complex three-dimensional structures in a single exposure, eliminating the need for multiple processing steps often required in other microfabrication techniques.

A “polymerizing precursor”, as used herein, refers to a material having properties such that the absorption of light, typically in the ultraviolet range, leads to cross-linking of molecular bonds within the material. A “polymerizing precursor” may be a photoresist. A “polymerizing precursor” may be all or a portion of a photoinitiator, a photopolymer, a UV-curable resin, among other materials having the property that the absorption of light, typically in the ultraviolet range, can lead to cross-linking of polymeric molecular chains within a light exposed layer. In two-photon polymerization, the UV energy is provided with the absorption of two sub-UV photons per cross-linking event in the material to facilitate localized cross-linking. Unlike an exposure that alters the properties of a layer with a broad exposure, as in photolithography for example, the two-photon polymerization process is a highly localized process occurring within a concentrated volume provided with the aid of a focusing apparatus wherein the polymerization is initiated with the absorption of two sub-UV wavelengths of light to facilitate cross-linking. In an example, the wavelength of light used in the two-photon polymerization process may be in the range of 600-900 nm corresponding to photon energies in the range of 2.06-1.38 eV. The wavelengths in this range of wavelengths are longer than the wavelengths of light used in the ultraviolet polymerization processes, that may be, for example, in the range of 250-400 nm, and smaller (corresponding to photon energies in the range of 4.96-3.10). These ranges provide an example of the wavelengths and corresponding photon energy that may be used in a typical two-photon polymerization process. Other wavelengths of excitation energy may also be used in the two-photon polymerization processes disclosed herein. With sub-100 nm wavelengths in use in current advanced lithography tools for advanced semiconductor processing, the photosensitive materials for processing at these wavelengths are available. Although higher resolution is anticipated with smaller wavelengths, the optical power sources required may be more costly. Additionally, the two-photon polymerization process requires some degree of selectivity between the energy of the source photon at the longer wavelength, and the energy required for cross linking of the precursor.

In methods disclosed herein, two-photon polymerization is used to provide high resolution polymerized structures in combination with other fabrication techniques to enable the formation of contoured reflecting surfaces, lens features, and mounting structures used in the formation of the embodiments of reflector structures disclosed herein.

“Two-photon polymerization”, as used herein, refers to the technique for forming all or a portion of a layer using a polymerizing precursor material that when exposed to a highly focused source can result in the polymerization of the precursor to form a solidified layer. Herein, the term, “two-photon polymerization” refers to use of one or more processing steps in which the technique of using the absorption of two photons by a polymerizing precursor to form all or a portion of a polymerized layer is used. Structures, and assemblies that include these structures, can thusly be formed from the utilization of two-photon polymerization processes. In an embodiment, for example, of a reflector structure comprising a substrate having a planar waveguide, a cavity formed in the substrate that intersects the planar waveguide, a reflector base formed in the cavity using two-photon polymerization, and a reflective layer formed on the reflector base, the reflector base comprises a cross-linked polymerizable resin. In this and other embodiments disclosed herein, the reflector structure is formed having the cross-linked polymerized resin.

Two-photon polymerization processes are used in commercially available equipment such as the Sonata 1000 series tool manufactured by Vanguard Automation GmbH. Herein, “two-photon polymerization” may be abbreviated to “2PP”, particularly in the drawings provided herein.

A “reflective layer”, as used herein, refers to a layer formed in an embodiment of a reflector structure having properties conducive to the redirection of incident light. A “reflective layer” may be formed, for example, from a metal, such as silver, aluminum, and gold, among many others, alloys of these metals, and other metal alloys. “Reflective layers” may be formed from dielectric materials. And “reflective layers” may be formed from one or more layers of metal and dielectric. Dielectric materials may be used in some embodiments, to passivate a metal surface to prevent oxidation, corrosion, discoloration, among other deleterious effects of exposure to ambient on the reflective properties of reflective layers formed all or in part from a metal layer.

A “total internal reflectance reflector” and a “TIR reflector”, as used herein, refers to a reflector structure that exploits the phenomenon of total internal reflection to guide and redirect light. In embodiments, optical signals propagating within a medium having a higher refractive index that encounter a boundary with a medium of lower refractive index will be reflected back into the higher-index medium for optical signals incident on the boundary at an angle that exceeds a critical value. TIR reflectors are typically constructed from a first material having a first refractive index, coupled to a second material having a second refractive index, wherein the first refractive index is greater than the second refractive index to ensure that incident light rays on the boundary between the media having the first and second refractive indices undergo total internal reflection, enabling efficient light guidance and redirection within the device.

A “contoured reflector surface” of a reflector base, as used herein, refers to the surface of a reflector base that contributes all or in part to the reflection of an optical signal in an embodiment of a reflector structure.

A “contoured reflector surface” of a reflector top, as used herein, refers to the surface of a reflector top that contributes all or in part to the reflection of an optical signal in an embodiment of a reflector structure.

A “contoured reflector surface” of a reflective layer, as used herein, refers to the surface of a reflective layer that contributes all or in part to the reflection of an optical signal in an embodiment of a reflector structure.

A “reflector base”, as used herein, refers to a portion of an embodiment of a reflector structure formed below the interface of the contoured reflective surfaces of the reflector structure, wherein the interface of the contoured reflective surfaces of the reflector structure is the interface formed between the contoured reflective surfaces of one or more of a reflector base, a reflector top, and a reflective layer that redirects the pathway of an incident optical signal. An interface of contoured reflective surfaces may comprise, for example, the contoured reflective surface of a reflective layer formed on a reflector base, and the contoured reflective surface of a reflector top formed on the reflector base for an embodiment of an upward-facing reflector structure. In another example, an interface of contoured reflective surfaces may comprise, for example, a contoured reflector surface of a reflective layer formed on an underlying reflector base, and the contoured reflector surface of the underlying reflector base in an embodiment of a downward-facing reflector structure. In an example comprising an embodiment of an upward-facing TIR reflector structure, an interface of contoured reflector surfaces comprises, for example, the contoured reflective surface of the reflector top, and the contoured reflective surface of the reflector base. In embodiments, the “reflector base” as used herein, refers to the portion of the embodiment of the reflector structure that resides below the interface having the one or more contoured reflective surfaces.

The “reflector top”, as used herein, refers to the portion of an embodiment of a reflector structure that resides above the interface of contoured reflective surfaces of the reflector structure.

In embodiments, a reflector structure may be formed having more than one contoured reflective surface at a reflective interface, such as for example in a structure having a transparent reflector top formed on a reflective layer. An optical signal encountering the interface between the transparent reflector top and an underlying reflective layer will be reflected at the interface between the reflector top and the reflective layer. In an embodiment configured as a TIR reflector, a contoured reflective interface may be formed, for example, between a reflector top having a high refractive index material and a reflector base having a low refractive index material wherein both the reflector top and the reflector base are considered to have a contoured reflective surface at the contoured reflective interface between the reflector top and the reflector base. The “reflector top” as used herein is the portion of the reflector structure that resides above the contoured reflective interface and the “reflector base” is the portion of the reflector structure that resides below the contoured reflective interface.

An “upward-facing reflector structure”, as used herein, refers to an embodiment of a reflector structure having a contoured reflecting surface that simultaneously faces a terminal facet formed from a planar waveguide or spot size converter intersected by the cavity, and an upper portion of a cavity formed in a substrate, wherein the bottom of the substrate within which the cavity is formed defines an orientation that is “lower”. By contrast, the top of a substrate within which the cavity is formed, defines an orientation that is “upper” as in the “upper” portion of a cavity. The “upper” portion of a cavity is formed in closer proximity to the top of the substrate wherein the top of the substrate is the portion of the substrate on which the patterned mask layer used in the formation of the cavity is formed.

A “downward-facing reflector structure”, as used herein, refers to an embodiment of a reflector structure having a contoured reflecting surface that simultaneously faces a terminal facet formed from a planar waveguide or spot size converter intersected by the cavity, and a lower portion of a cavity formed in a substrate, wherein the bottom of the substrate within which the cavity is formed defines an orientation that is “lower”. By contrast, the top of a substrate within which the cavity is formed, defines an orientation that is “upper” as in the “upper” portion of a cavity.

A “lens feature”, as used herein, refers to all or a portion of a reflector base or a reflector top in an embodiment of a reflector structure that facilitates the focusing an optical signal. A “lens feature” may be, for example, a portion of a three-dimensional reflector structure included in an embodiment of a reflector structure for the purpose of focusing an optical signal coupled to the embodiment of the reflector structure. In the embodiments of the reflector structures disclosed herein and formed from two-photon polymerization, an optical signal propagating from a planar waveguide to a contoured surface of a reflective layer may encounter along its path to a contoured reflector surface, a lens feature formed all or in part from two-photon polymerization a structure that focuses fully or in part the optical signal prior to incidence on the contoured reflector surface. In another example, an optical signal reflected from the contoured reflector surface may encounter a lens feature formed all or in part from two-photon polymerization a structure that focuses fully or in part, the optical signal subsequent to the reflection from the contoured reflective surface of the embodiment of the reflector structure.

A “conformal fill layer” as used herein, refers to a layer such as a dielectric film, a semiconductor film, and a polymer film, among others, that may be used to fill a portion of a cavity formed in a substrate. A conformal fill layer may be, for example, a layer deposited using chemical vapor deposition, atomic layer deposition, nanolayer deposition, thermal vapor deposition, spin on, among other forms of material deposition that enable the formation of a layer of material. A “conformal fill layer”, as used herein, refers to the use of a fill layer to conformally fill a cavity or recess formed in a substrate. The techniques listed are not limited, in general, to applications having cavities such as are used and described herein in embodiments. “Conformal fill layer” as used herein, thusly refers to the use of one or more of these and other techniques for forming a layer, that may be used to conformally fill a cavity. A conformal fill layer is described herein in contrast to a layer deposited using two-photon polymerization, wherein the layer formed using two-photon polymerization is formed using focused light concentrated in a high intensity focal volume.

A “substratum”, as used herein, refers to a substrate used in the formation of a composite substrate comprising a planar waveguide layer, an optional electrical interconnect layer, and the substrate upon which the planar waveguide layer and the optional electrical interconnect layer are formed. Herein, the term “substratum” is used to differentiate the substrate underlying the planar waveguide layer and optional electrical interconnect layer and the term “substrate” used to identify the assembly comprising the planar waveguide layer, the optional electrical interconnect layer, and the substratum upon which embodiments of reflector structures are formed. A “substratum” as used herein, may be formed from a single layer such as silicon or other semiconductor material, or may be formed of one or more semiconductor layer, insulating layer, and metal layer.

Various embodiments are described herein with reference to the accompanying drawings that are intended to convey the scope of the invention to those skilled in the art. Accordingly, features and components described in the examples of embodiments described herein may be combined with features and components of other embodiments. The present invention is not limited to the relative sizes and spacings illustrated in the accompanying figures. It should be understood that a “layer” as referenced herein may include a single material layer or a plurality of layers. For example, an “insulating layer” may include a single layer of a specific dielectric material such as silicon dioxide, or may include a plurality of layers such as one or more layers of silicon dioxide and one or more other layers such as silicon nitride, aluminum nitride, among others. The term “insulating layer” in this example, refers to the functional characteristic layer provided for the purpose of providing the insulation property, and is not limited as such to a single layer of a specific material. Similarly, an electrical interconnect layer, as used herein, refers to a composite layer that includes both the electrically conductive materials for transmitting electrical signals and the intermetal and other layers required to insulate the electrically conductive materials. An electrical interconnect layer, as described herein may therefore include a patterned layer of electrically conducting material such as copper or aluminum as well as the intermetal dielectric material such as silicon dioxide, and spacer layers above and below the electrically conductive materials, for example, among other layers. Additionally, references herein to a layer formed “on” a substrate or other layer may refer to the layer formed directly on the substrate or other layer or on an intervening layer or layers formed on the substrate or other layer. References to the term “optical” devices, as used herein, may refer to a purely optical device such as a waveguide that does not have an electrical feature and to an optoelectrical device that has both an optical feature and an electrical feature, unless specified otherwise. An optical device, as used herein, is a device such as a waveguide, an arrayed waveguide, a spot size converter, a lens, a grating, among others, and an optoelectrical device is a device such as a laser or a photodetector that includes an optical feature and an electrical feature. In embodiments described herein, the use of the term “optical device” may include both optical devices and optoelectrical devices.

The acronym “WG”, as used herein, refers to “waveguide”. The acronym “PWG”, as used herein, refers to “planar waveguide”. The acronym “PIC”, as used herein, refers to “photonic integrated circuit”. The acronym “2PP”, as used herein, refers to “two-photon polymerization”. Other acronyms may also be used as noted herein.

Embodiments of assemblies disclosed herein may be used in the formation of PICs and thus the term “PIC” may be used interchangeably with “assembly” in reference to assemblies that utilize embodiments disclosed herein.

### Embodiments

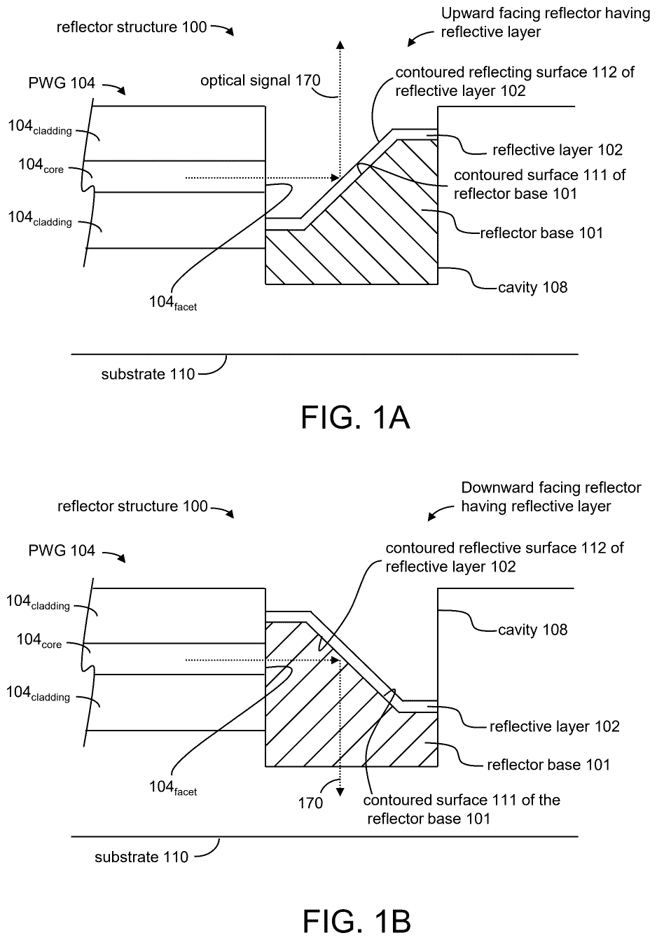

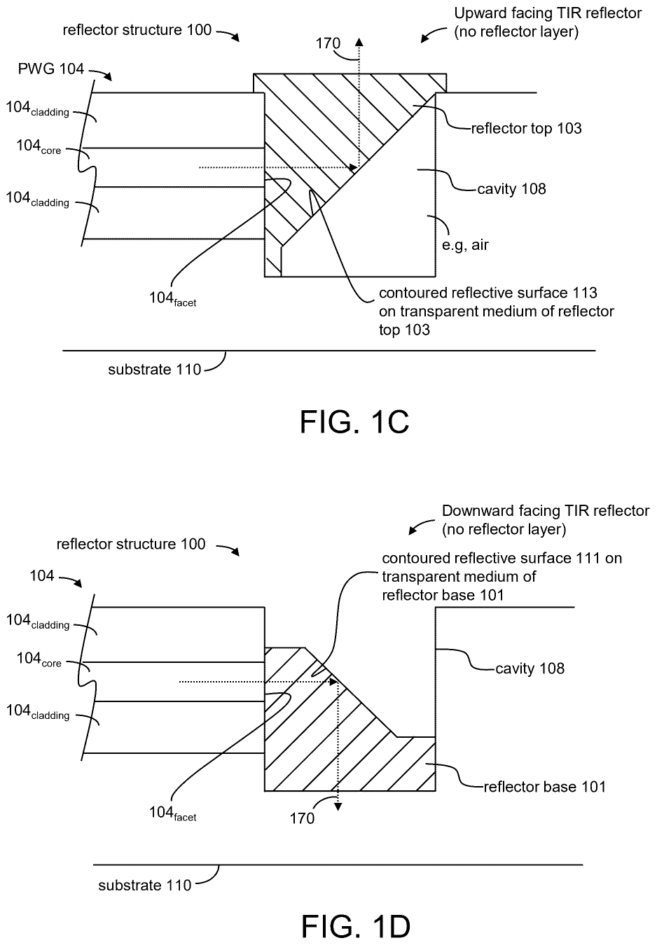

FIG. 1A shows a schematic cross-sectional drawing of an embodiment of a reflector structure 100 configured as an upward-facing reflector structure to receive an optical signal propagating from terminal waveguide facet 104_{facet} to reflective layer 102 and to reflect the optical signal toward the upper portion of the cavity 108. The embodiment of the reflector structure 100 shown in FIG. 1A comprises substrate 110 configured having planar waveguide 104, a cavity 108 formed in the substrate 110 that intersects the planar waveguide core 104_{core} of the planar waveguide 104, a reflector base 101 formed in the cavity 108 using two-photon polymerization, and a reflective layer 102 formed on the reflector base 101. The directional change in the propagating optical signal provided by the reflective layer 102 may enable, for example, processing of the reflected optical signal by a receiving device mounted on the top surface of the substrate 110 within which the cavity 108 is formed.

The substrate 110 in the embodiment shown in FIG. 1A is shown having planar waveguide 104 comprising a patterned planar waveguide core 104_{core} surrounded by one or more layers of planar waveguide cladding 104_{cladding}. Cavity 108 is formed in substrate 110 such that a wall of cavity 108 intersects the core layer of the planar waveguide 104 to form the terminal waveguide facet 104_{facet} that faces the reflective layer 102. In the embodiment, the reflector base 101 is formed having a contoured surface 111 that varies linearly with distance from the wall of the cavity 108 having the terminal waveguide facet 104_{facet}. In other embodiments, as further described herein, the contoured surface 111 of the reflector base 101 may be one or more of linearly varying, curvilinearly varying in two dimensions, and curvilinearly varying in three dimensions. In embodiments having a reflective layer 102, as for example, the embodiment shown in FIG. 1A, the thickness of the reflective layer 102 may be uniform such that the contoured reflecting surface 112 of the reflective layer 102 follows the contoured surface 111 of the reflector base 101. In other embodiments, the thickness of the reflective layer 102 may be non-uniform such that the contoured reflecting surface 112 of the reflective layer 102 does not follow the contoured surface 111 of the reflector base 101.

In some embodiments, the reflective layer 102 may be a metal layer such as a layer of aluminum. In other embodiments, the reflective layer may be a layer of gold. And in yet other embodiments, reflective layer 102 may be a layer of silver. In some embodiments, reflective layer 102 may be formed from one or more of aluminum, gold, silver, and other reflective metal layers. In some embodiments, reflective layer 102 may be formed from a plurality of metal layers. And in some embodiments, alloys of metal layers may be used in one or more layers of reflective layer 102. The reflectivity of a metallic layer may be highly dependent on the quality and purity of the surface finish, and as such, reflective layer 102 may include a passivation layer such as a transparent dielectric. Dielectrics such as silicon nitride, silicon oxide, silicon oxynitride, among others may be used in the formation of reflective layer 102.

FIG. 1B shows a schematic cross-sectional drawing of an embodiment of a reflector structure 100 configured as a downward-facing reflector structure to receive an optical signal propagating from terminal waveguide facet 104_{facet} to reflective layer 102 and to reflect the optical signal toward the lower portion of the cavity 108 having the reflector base 101. The embodiment of the reflector structure 100 shown in FIG. 1B comprises substrate 110 configured having planar waveguide 104, a cavity 108 formed in the substrate 110 that intersects the patterned planar waveguide core 104_{core} of planar waveguide 104, a base structure 101 formed in the cavity 108 using two-photon polymerization, and a reflective layer 102 formed on the reflector base 101. The directional change in the propagating optical signal provided by the reflective layer 102 may enable, for example, processing of the reflected optical signal by a receiving device mounted below the bottom surface of the substrate 110 within which the cavity 108 is formed. Reflector base 101, in the embodiment shown in FIG. 1B is formed from a material that is transparent, or substantially transparent, to the one or more wavelength of the optical signal propagating in the reflector structure 100.

The substrate 110 in the embodiment shown in FIG. 1B is shown having planar waveguide 104 comprising a patterned planar waveguide core 104_{core} surrounded by one or more layers of planar waveguide cladding 104_{cladding}. Cavity 108 is formed in substrate 110 such that a wall of the cavity 108 intersects the patterned planar waveguide core 104_{core} of the planar waveguide 104 to form the terminal waveguide facet 104_{facet} that faces the reflective layer 102. In the embodiment, the reflector base 101 is formed having a contoured surface 111 that varies linearly with distance from the wall of the cavity 108 having the terminal waveguide facet 104_{facet}. In other embodiments, as further described herein, the contoured surface 111 of the reflector base 101 may be one or more of linearly varying, curvilinearly varying in two dimensions, and curvilinearly varying in three dimensions. In embodiments having a reflective layer 102, as for example, the embodiment shown in FIG. 1B, the contoured reflecting surface 112 of reflective layer 102 is formed on contoured surface 111 of the reflector base 101. In downward-facing embodiments configured as in the embodiment shown in FIG. 1B having the contoured reflecting surface 112 of reflective layer 102, the contoured reflecting surface 112 conforms with the contoured surface 111 of the reflector base. As such, variations in the thickness have lesser or no influence on the direction of the reflected signal, so long as the thickness is beyond the thickness at which the reflective layer becomes opaque to the optical signal incident on the reflective layer. Although structures disclosed herein are not limited to reflective layers having fully opaque properties, the transition from partially transparent reflective layers to full opaque reflective layers is typically between 50 and 200 angstroms, and may depend on the properties of the materials used to form the reflective layer 102.

In some embodiments such as the downward-facing embodiment of the reflector structure 100 shown in FIG. 1B, cavity 108 may be extended to the bottom of the substrate 110 such that the reflected optical signal does not encounter the underlying substrate material below the cavity 108. In other embodiments, cavity 108 may be formed such that the cavity 108 stops within the substrate 110. In some embodiments, the cavity 108 may be formed in the substrate 110, and the backside of the wafer may be polished or otherwise ground back fully or in part so that the substrate material between the bottom side of the substrate and the bottom of the cavity is removed.

Reflector structures 100 disclosed herein may be formed having reflective layers 102 as shown, for example, in FIGS. 1A and 1B, may be formed without reflective layers 102. Embodiments in which the reflector structures 100 are formed without reflective layers 102 include reflector structures that utilize the principle of total internal reflection (TIR). Embodiments of TIR reflectors, disclosed herein, are formed having a high index of refraction material coupled to the terminal facet 104_{facet} of the planar waveguide 104, and a lower refractive index material to form a reflective interface between the material having the high index of refraction and the material having the lower index of refraction.

FIG. 1C shows a schematic cross-sectional drawing of an embodiment of a reflector structure 100 configured as an upward-facing TIR reflector structure to receive an optical signal propagating from terminal waveguide facet 104_{facet} to reflective surface 113 of reflector top 103 and to reflect the optical signal toward the upper portion of the cavity 108. The embodiment of the reflector structure 100 shown in FIG. 1C comprises substrate 110 having planar waveguide 104, cavity 108 formed in the substrate 110 that intersects the planar waveguide 104, and a reflector top 103 formed in the cavity 108 using two-photon polymerization. The reflector top 103, in the embodiment, may be formed in cavity 108 such that the contoured reflecting surface 113 is formed on the reflector top 103 having a refractive index that is greater than the refractive index of the portion of the structure underlying the reflector top 103 in the embodiment shown. The embodiment shown in FIG. 1C shows an open space underlying the reflector top 103 that may be filled, for example, with ambient air. Other gaseous material may be used in other embodiments. And in other embodiments, the portion of the reflector structure 100 may be filled, all or in part, with a solid or liquid material.

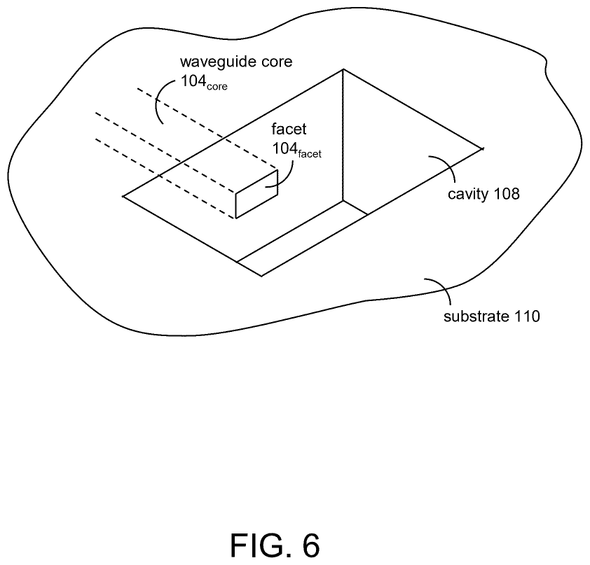

In the embodiment, an optical signal propagating from the terminal facet 104_{facet} and incident on the contoured reflective surface 113, will be reflected for portions of the optical signal that are incident upon the contoured reflecting surface 113 having an angle of incidence greater than a critical angle required for internal reflection. (the effect of TIR is described in more detail herein in conjunction with FIG. 6B.)

In the embodiment of the reflector structure 100 shown in FIG. 1B, reflector top 103 is formed using two-photon polymerization. The formation of the reflector top 103 in cavity 108 enables the formation of embodiments of reflector structure 100 having precise control over the shape of the contoured reflecting surfaces 113 formed in cavity 108 for reflector structures 100 that include TIR reflector structures.

FIG. 1D shows a schematic cross-sectional drawing of an embodiment of reflector structure 100 configured as a downward-facing TIR reflector structure to receive an optical signal propagating from terminal waveguide facet 104_{facet} to contoured reflective surface 111 of reflector base 101 and to reflect the optical signal toward the lower portion of the cavity 108 having the reflector base 101. The embodiment of the reflector structure 100 shown in FIG. 1D comprises substrate 110 having planar waveguide 104, cavity 108 formed in substrate 110 that intersects the planar waveguide 104, and a reflector base 101 formed in cavity 108 using two-photon polymerization.

Reflector base 101 is formed in cavity 108 having contoured reflecting surface 111. The reflector base 101, in the embodiment, may be formed in cavity 108 such that the contoured reflecting surface 111 is formed on the reflector base 101 having a refractive index that is greater than the refractive index of the portion of the structure overlying the reflector base 101 in the embodiment shown. The embodiment of the reflector structure shown in FIG. 1D shows an open space above reflector base 101 that may be filled, for example, with ambient air. Other gaseous material may be used in other embodiments. And in other embodiments, the portion of the reflector structure 100 above the contoured reflector surface 111 may be filled, all or in part, with a solid or liquid material.

In the embodiment in FIG. 1D, an optical signal propagating from the terminal facet 104_{facet} and incident on the contoured reflective surface 111, will be reflected for portions of the optical signal that are incident upon the contoured reflecting surface 111 having an angle of incidence greater than a critical angle required for internal reflection. (the effect of TIR is described in more detail herein in conjunction with FIG. 6B.)

In the embodiment shown in FIG. 1D, reflector base 101 may be formed using two-photon polymerization. The formation of the reflector base 101 in cavity 108 enables the formation of reflector structures 100 having precise control over the shape of the contoured reflecting surfaces 111 formed in cavity 108 for reflector structures 100 that may function using the principles of TIR as described in conjunction with the embodiment shown in FIGS. 1D and 1n other embodiments disclosed herein.

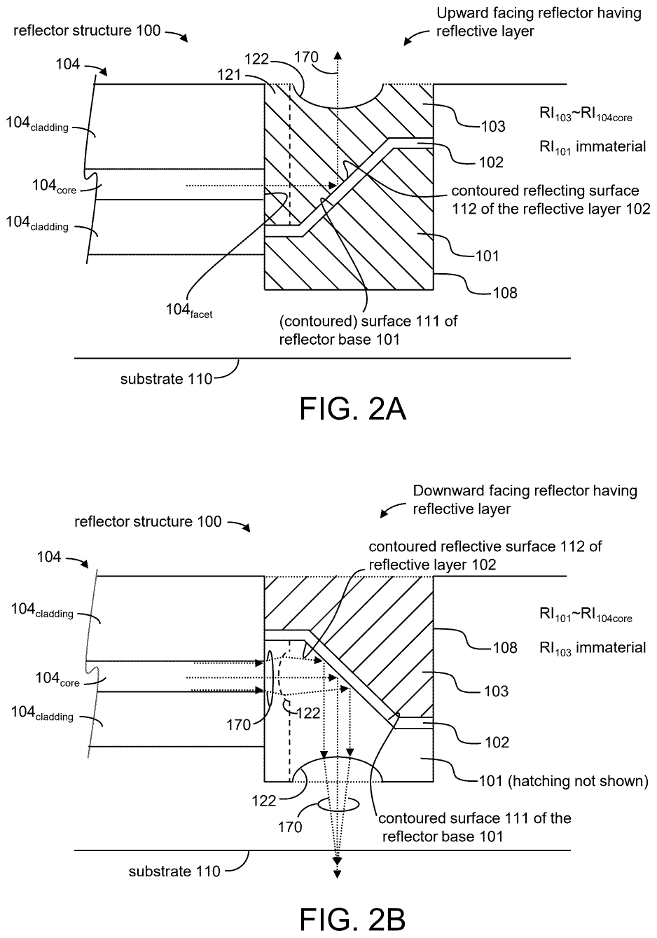

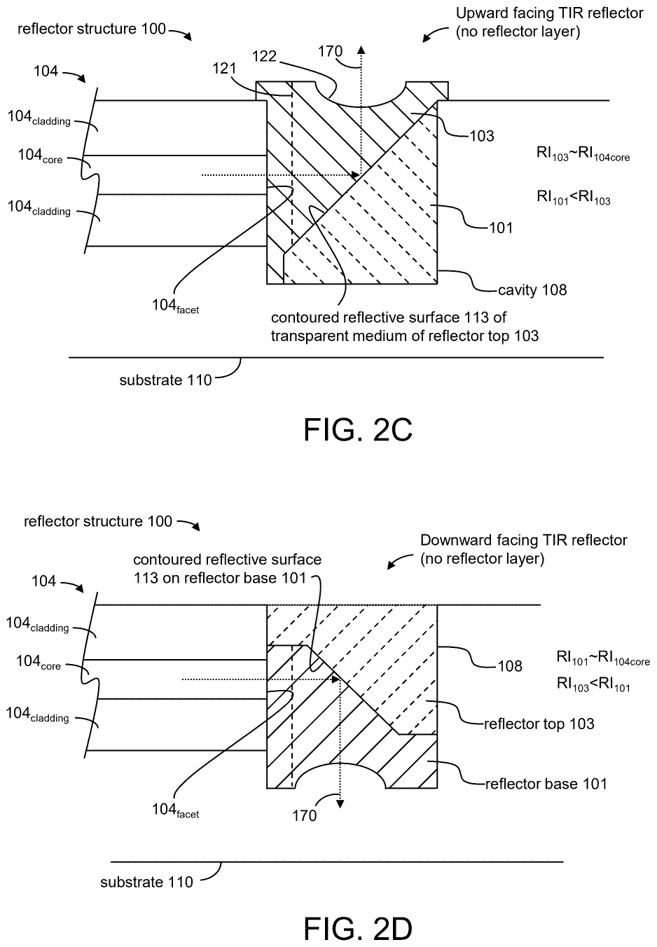

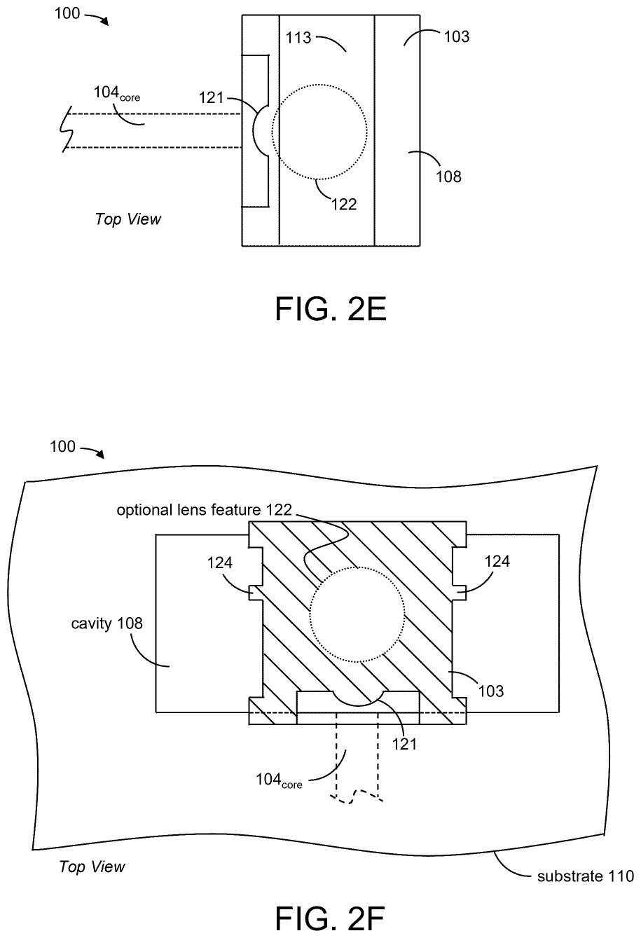

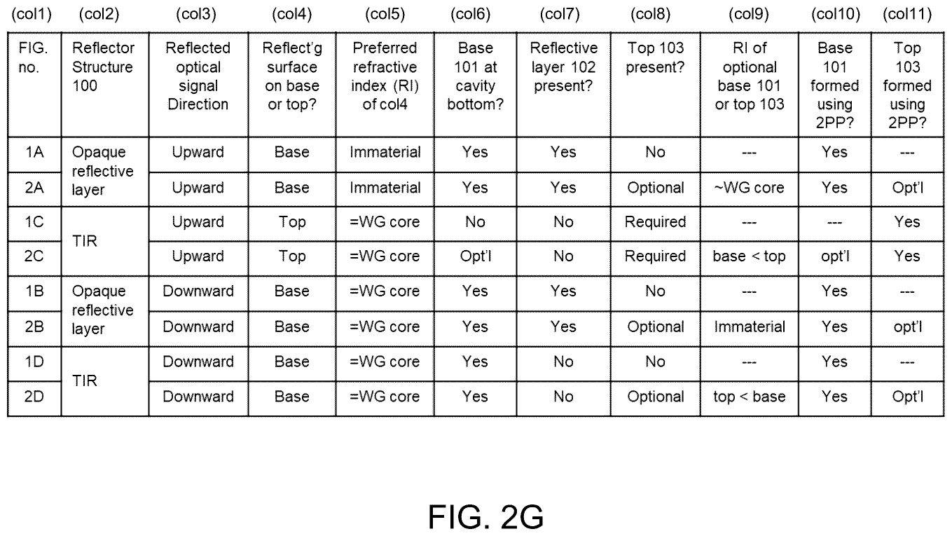

FIG. 2A shows a schematic cross-sectional drawing of the embodiment of the upward-facing reflector structure of FIG. 1A further comprising an optional reflector top 103 formed using two-photon polymerization wherein the reflector top 103 includes one or more optional lens features 122. In the embodiment of reflector structure 100 shown in FIG. 2A, the open volume of FIG. 1A above the reflective layer 102 is shown filled with a solid material. In embodiments, the refractive index of the material used to form the reflector top 103 is equal to, or approximately equal to, the refractive index of the planar waveguide core 104_{core} of the planar waveguide 104. Materials used to form reflector top 103 having refractive index that are equal to, or approximately equal to, the refractive index of the planar waveguide core 104_{core} can lead to reduced divergence of optical signals propagating from the terminal facet 104_{facet} of the planar waveguide 104 into cavity 108.

The reflector top 103 shown in FIG. 2A, formed using two-photon polymerization, may be formed having optional lens features 122 that may enable focusing of the optical signals reflected from the reflective layer 102 in the embodiment. As optical signals are reflected from the reflective layer 102, in the embodiment, and are incident on the lens features 122, the optical signals may undergo focusing using lens features such as lens features 122 formed in the optical path using a reflector top 103 formed from two-photon polymerization. Formation of the reflector top 103 using two-photon polymerization, facilitates and enables the incorporation of such lens features 122 into embodiments of reflector structure 100. In addition to the lens features 122 shown in FIG. 2A, the embodiment also shows optional vertical lens feature 121 formed in close proximity to terminal facet 104_{facet} of planar waveguide 104 to receive and focus optical signals propagating from the terminal facet 104_{facet}. The vertical lens structure, shown in more detail in the top view of FIG.

FIG. 2B shows a schematic cross-sectional drawing of an embodiment of a downward-facing reflector structure as in FIG. 1B further comprising an optional reflector top 103 and one or more optional lens features 121,122 formed in the reflector base 101 using two-photon polymerization. In the embodiment, the reflector base is shown without hatching for clarity to illustrate the path of an optical signal 170 propagating from the terminal facet 104_{facet} through the vertical lens feature 121 to the reflective layer 102 and through lens feature 122 at the base of the cavity 108. The optical signal 170 typically has a broad height and width confined largely within the planar waveguide core 104_{core} while propagating within the planar waveguide 104. As the propagating signal emerges from the planar waveguide core 104_{core}, some divergence of the optical signal may be anticipated. The extent of the divergence may be minimized by closely matching the refractive index of the reflector base, in the embodiment, with the refractive index of the planar waveguide core 104_{core}. The divergence in the optical signal 170, may be further reduced in embodiments, with the inclusion of one or more lens features 122. Optical signal 170, identified in FIG. 2B with labeled dotted lines, is shown in the embodiment to illustrate the signal divergence and to illustrate the effect of having a first lens feature 122 in close proximity to the terminal facet 104_{facet} and a second lens feature 122 formed at the base of the cavity 108. The effect of the lens on height and width of the optical signal 170 can be seen in the illustration. Lens features 122 may be formed in embodiments having one or more of a reflector base 101 and a reflector top 103 formed using two-photon polymerization. The lens feature 122 shown in the embodiment in FIG. 2B is shown having three-dimensional curvature. In other embodiments, a lens feature may be a two-dimensional lens feature such that the focusing of the optical signal is limited to either the width or height of the optical signal. A vertical lens 121, for example, may act to reduce only the width of the optical beam emerging from the terminal facet 104_{facet}.

In embodiments with minimal or no divergence, due, for example, to closely matched refractive indices between the reflector base 101 and the planar waveguide core 104_{core}, lens 122 may be used to reduce the spot size of the optical signal 170 as the optical signal 170 propagates through the reflector structure 100.

In FIG. 2B, the embodiment of the reflector structure 100 is shown having a layer of substrate 110 between the bottom of the cavity 108 and the bottom of the substrate 110. In some embodiments, cavity 108 may be made deeper into the substrate 110 than illustrated or the substrate may be made thinner such that no substrate layer is present between the bottom of the cavity 108 and the bottom of the substrate 110.

FIG. 2C shows a schematic cross-sectional drawing of an embodiment of an upward-facing reflector structure configured as a TIR reflector, as in FIG. 1C, further comprising an optional reflector base 101 and one or more optional lens features 122 formed in the reflector top 103 also formed using two-photon polymerization. In the embodiment, the reflector top 103 is shown having lens feature 122. Lens feature 122 may be formed using two-photon polymerization. Reflector top 103 also shows vertical lens feature 121. Vertical lens feature 121, as illustrated, is a vertical lens configured to reduce the width of the propagating optical signal as the optical signal propagates through the vertical lens feature 121. Lens feature 122 shown in FIG. 2C formed at the top of the reflector top 103 enables further focusing of the optical signal after reflecting from the contoured reflective surface 113 of the reflective top 103.

The embodiment of reflector structure 100 in FIG. 2C shows optional reflector base 101 below the reflector top 103 of the reflector structure 100 configured as a TIR reflector. Reflector base 101 may be formed, for example, using two-photon polymerization. Reflector base 101 may also be formed using a conformal fill layer. Conformal fill layers may be formed using plasma deposition, using a liquid deposition followed by a thermal treatment, among other methods of forming conformal layers suitable to fill all or a portion of the space below the reflector top 103 in the embodiments. The refractive index of optional reflector base 101 is less than the refractive index of the reflector top 103 in the embodiment to ensure internal reflectance of the optical signal 170 from the contoured reflective surface 113 at the interface between the reflector top 103 and the reflector base 101.

FIG. 2D shows a schematic cross-sectional drawing of an embodiment of a downward-facing reflector structure configured as a TIR reflector, as in the embodiment shown in FIG. 1D, further comprising one or more optional lens features 122 in the reflector base 101 formed using two-photon polymerization, and an optional reflector top 103 that may be formed using one or more two-photon polymerization and other conformal fill processing. Lens features 122 are as described in conjunction with embodiments of the reflector base 101 having lens structures 121,122 formed using two-photon polymerization as in, for example, FIG. 2B.

FIGS. 2E and 2F show top views of embodiments of reflector structure 100 as configured, for example, in FIGS. 2A and 2C, respectively. The top view of FIG. 2E shows a vertical lens feature 121 formed in proximity to the terminal facet 104_{facet} and lens feature 122 formed at the top of the cavity 108. The contoured reflecting surface 113 is shown below the lens feature 122 and facing the terminal facet 104_{facet} of the planar waveguide core 104_{core}. The top view of FIG. 2F also shows vertical lens feature 121 formed in proximity to the terminal facet 104_{facet} of the planar waveguide core 104_{core} and also shows lens feature 122 formed at the top of cavity 108. Cavity 108, in the embodiment, is formed substantially larger than the reflector top 103 shown in the embodiment. Cavities 108 that are formed substantially larger than the reflector top 103 may enable more effective removal of non-polymerized precursor material from the cavity 108 after formation of the reflector top 103. Cavities 108 that are formed substantially larger than the reflector top 103 may also enable more effective formation of a reflector base 101 in embodiments in which a reflector base 101 is formed after the formation of the reflector top 103. Filling of all or a portion of the cavity 108 may be facilitated more easily with larger cavities. Larger cavities 108 may also provide improved access to non-polymerized precursor material during the formation of reflector top 103 formed using two-photon polymerization in embodiments, and in other embodiments, disclosed herein. Included in the embodiment of the reflector structure shown in FIG. 2F are pedestals 124, which may be used to provide additional support and rigidity to the reflector structure 100. In some embodiments, pedestal 124 may extend to the bottom of cavity 108. In other embodiments, pedestal 124 may extend partway to the bottom of cavity 108. Pedestal features 124 may be used in embodiments to provide one or more of rigidity and support, among other benefits, to the reflector structures 100 formed all or in part from using two-photon polymerization.

FIG. 2G shows a table having a summary of some features of the embodiments shown in FIGS. 1A-1D and 2A-2D.

The first column of the table in FIG. 2G shows the relevant figure number for the information contained in the other columns in the table. The second column shows the reflector type for the embodiments shown in the figures in the first column. Two types of reflectors are provided in embodiments, namely, a first reflector type that includes an opaque reflective layer and a second type employing the principle of total internal reflection, that does not use an opaque reflective layer.

Numbered column references are provided above the corresponding columns in the table in FIG. 2G for clarity.

The third column lists the orientation of the reflector structure, either upward-facing or downward-facing. An embodiment configured having an upward-facing reflector structure is an embodiment of reflector structure 100 wherein the one or more contoured reflector surfaces of reflector structure 100 faces the terminal facet of planar waveguide 104 intersected by cavity 108 and faces an upper portion of the cavity 108. The upper portion of cavity 108, as further described herein, is the portion of the cavity 108 formed closest to the top of the substrate 110 wherein the top of the substrate 110 is the surface of the substrate 110 upon which the patterned mask layer 116 that is used to facilitate the formation of the cavity 108 is formed. A reflected optical signal propagating from planar waveguide 104 in an embodiment of reflector structure 100 configured to be upward-facing, will be reflected toward an upper portion of the cavity 108 after reflection from a reflective layer 102 or a reflective interface of a TIR reflector. Some embodiments disclosed herein having reflector structures 100 configured to be upward-facing, may be configured to reflect an optical signal propagating from, or through, the upper portion of cavity 108 to the one or more contoured reflecting surfaces of the reflector structure 100 and the terminal facet 104_{facet} of planar waveguide 104.

In an embodiment of a reflector structure 100 configured to be downward-facing, the one or more contoured reflective surfaces of reflector structure 100 face the terminal facet of planar waveguide 104 and a lower portion of the cavity 108. A reflected optical signal propagating from planar waveguide 104 in an embodiment of reflector structure 100 configured to be downward-facing, will propagate toward a lower portion of cavity 108 after reflection from a reflective layer 102 or a reflective interface of a TIR reflector. The lower portion of cavity 108, as further described herein, is the portion of the cavity 108 formed closest to the bottom of the substrate 110 wherein the bottom of the substrate 110 is the surface of the substrate 110 underlying the closed bottom end of the cavity 108. Some embodiments disclosed herein having reflector structures 100 configured to be downward-facing, may be configured to reflect an optical signal propagating from, or through, the lower portion of cavity 108 to the one or more contoured reflecting surfaces of the reflector structure 100 and the terminal facet 104_{facet} of planar waveguide 104.

The fourth column of the table in FIG. 2G lists the location of the primary reflector surface, being either on the reflector base or the reflector top. The fifth column lists a preferred refractive index for the reflector base 101 or reflector top 103 listed in the fourth column. The refractive index of the material coupled to the planar waveguide 104 may preferably be equal to, or approximately equal to, the refractive index of the planar waveguide core 104_{core} of the planar waveguide 104. Matching of the refractive indices, although beneficial in some configurations, is not required in all embodiments. The refractive index of the reflector base 101 for an embodiment of reflector structure 100 configured as in FIGS. 1A and 2A, for example, formed below the reflective layer 102, is largely or completely immaterial for highly opaque reflective layers 102 formed on the reflector base 101.

The sixth column of the table in FIG. 2G lists whether or not a reflector base 101 is formed at the bottom of cavity 108. Reflector base 101 may be required in some embodiments, may be optional in some embodiments, and may not be present in other embodiments. The configuration of the reflector structure 100 shown in FIG. 1C, for example, is formed without a reflector base 101. A similar embodiment shown in FIG. 2C is optionally configured with reflector base 101. Reflector base 101 is required in many of the embodiments listed in the table in FIG. 2G and described herein such as in the TIR reflector structures of FIGS. 1B and 2B, among others.

The seventh column in the table in FIG. 2G lists whether or not a reflective layer 102 is formed in the reflector structure 100. Reflective layers 102 are not provided in embodiments configured as TIR reflectors.

The eighth column in the table in FIG. 2G lists whether or not a reflector top 103 is formed on the reflector base 101, either optionally or as a requirement for the embodiment of the reflector structure 101 for the configurations illustrated in the figures listed in the first column.

The ninth column shows a preferred configuration of the refractive index of the material used in the embodiments of first column.

The tenth column in the table in FIG. 2G lists the embodiments of the first column for which all or a portion of the reflector base 101 is formed using two-photon polymerization, either as a requirement or an option. The reflector base 101 may be formed using two-photon polymerization for all configurations with the exceptions of the embodiments configured as TIR reflector structures as shown in FIGS. 1C and 2C, wherein the embodiment shown in FIG. 1C is formed without a reflector base 101, and the embodiment shown in FIG. 2C may be formed having a reflector base 101 using two-photon polymerization or a conformal fill layer. Two-photon polymerization is used for the formation of all or a portion of the reflector bases 101 in the embodiments configured as in FIGS. 1A,1B, and 1D and in FIGS. 2A, 2B, and 2D.

And the eleventh column in the table in FIG. 2G lists the embodiments of the first column for which all or a portion of the reflector top 103 is formed using two-photon polymerization, either as a requirement or an option. The reflector top 103 is formed using two-photon polymerization in the embodiments configured as TIR reflectors and shown in FIGS. 1C and 2C.

The embodiments in FIGS. 1A, 1B, and 1D, are configured without reflector top 103. And the embodiments in FIGS. 2A, 2B, and 2D, are configured with a reflector top 103 that may be formed using two-photon polymerization or other means, such as a conformal fill layer.

The information provided in FIG. 2G shows a summary of the embodiments described in FIGS. 1A-1D and 2A-2D to illustrate configurations of embodiments having all or a portion of reflector base 101 and reflector top 103 formed using two-photon polymerization. Column references are provided above the table in FIG. 2G for clarity.

### Example Two-Photon Polymerization Apparatus

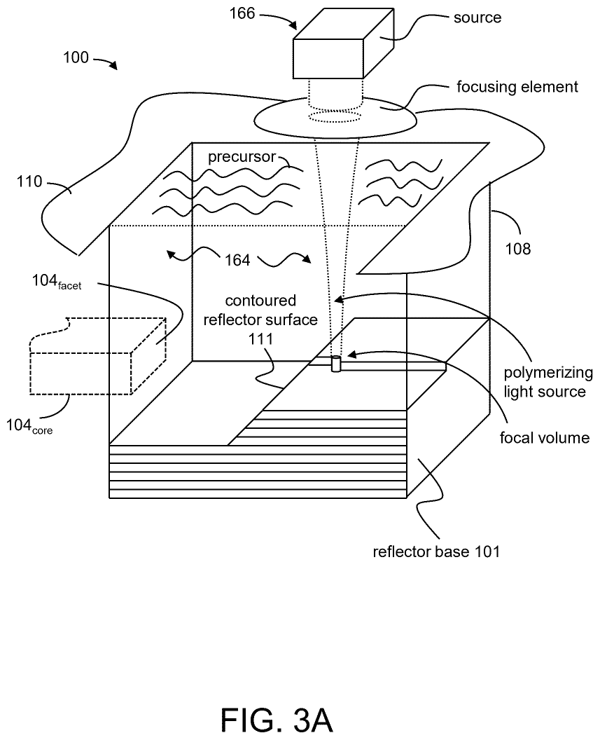

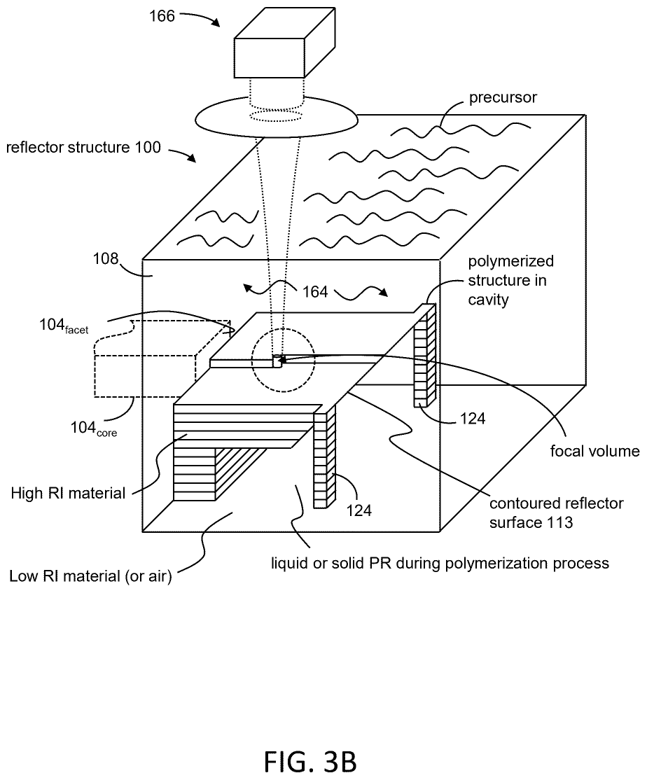

FIG. 3A shows a schematic perspective drawing of a two-photon polymerization apparatus 166 forming a reflector base 101 in an example cavity 108. FIG. 3B shows a schematic perspective drawing of a two-photon polymerization apparatus 166 forming a reflector top 103 in another example cavity 108. Cavities 108 in substrate 110 in FIGS. 3A and 3B are shown filled with two-photon polymerization precursor 164. The two-photon polymerization precursor may be in a liquid form, for example, dispensed into cavity 108 using automated dispensing apparatus. In some embodiments, a solid form of two-photon polymerization precursor 164 may be used. Other means for providing two-photon polymerization precursor 164 may also be used. Two-photon polymerization processing apparatus 166, in the illustration, comprises a source, a focusing element, and a two-photon polymerization processing beam incident on the two-photon polymerization precursor 164 in cavity 108. The incident beams of the two-photon polymerization apparatus 166 are focused using the focusing element to form a focal volume within the precursor. The focal volume provides a concentrated energy density sufficient to polymerize the precursor material to form polymerized precursor material. The polymerized precursor material is used to form all or a portion of the reflector structure 100 by rastering of the focal volume within the polymer precursor 164 in cavity 108. In embodiments, the rastering may be automated using automated two-photon polymerization apparatus. As the focal volume is rastered through the precursor, polymerized layers of the precursor are formed such as the reflector base 101 shown partially formed in FIG. 3A, and the reflector top 103 shown partially formed in FIG. 3B.

Formation of reflector base 101, using two-photon polymerization apparatus as shown in the illustration in FIG. 3A, enables the formation of simple and complex contoured reflector surfaces 111. Contoured reflector surfaces 111 may be linearly varying reflector surfaces in some embodiments. In other embodiments, contoured reflector surfaces 111 formed using two-photon polymerization may be formed having one or more of two-dimensional and three-dimensional curvature. Two-dimensional and three-dimensional curvature of the contoured reflecting surface 111 may enable, for example, focusing of optical signals reflected from the contoured reflecting surface 111. Reflector base 101 formed using two-photon polymerization, in some embodiments, may have additional layers formed on the contoured reflecting surface 111, such as, for example, reflective layer 102. Reflective layer 102 may be formed on the contoured reflecting surface 111 to conform to the contoured reflecting surface 111 formed using two-photon polymerization. Other layers, such as reflector top 103, may be formed using either two-photon polymerization processing or other methods, on the reflective layer 102. Use of two-photon polymerization to form the reflector base 101, and the contoured reflecting surface 111 of the reflector base 101, enables a range of processing alternatives for forming the reflector top 103 above the contoured reflector surface 111, either directly, or on other intermediate layers such as reflective layer 102.

Formation of the reflector top 103, using two-photon polymerization apparatus as shown in the illustration in FIG. 3B, enables the formation of simple and complex contoured reflector surfaces 113. Contoured reflector surfaces 113 may be linearly varying reflector surfaces in some embodiments. In other embodiments, contoured reflector surfaces 113 formed using two-photon polymerization may be formed having one or more of two-dimensional and three-dimensional curvature. Two-dimensional and three-dimensional curvature of the contoured reflecting surface 113 may enable, for example, focusing of optical signals reflected from the contoured reflecting surface 113. Reflector top 103 formed using two-photon polymerization, in some embodiments, may have additional layers formed below the contoured reflecting surface 113, such as, for example, reflector base 101. Reflector base 101 may be formed below the contoured reflecting surface 113 to conform to the contoured reflecting surface 113 formed using two-photon polymerization. The reflector base 101 may be formed using either two-photon polymerization processing or other methods below the reflector top 103. Use of two-photon polymerization to form the reflector top 103, and the contoured reflecting surface 113 of the reflector top 103, enables a range of processing alternatives for forming the reflector base 101 below the contoured reflector surface 113.

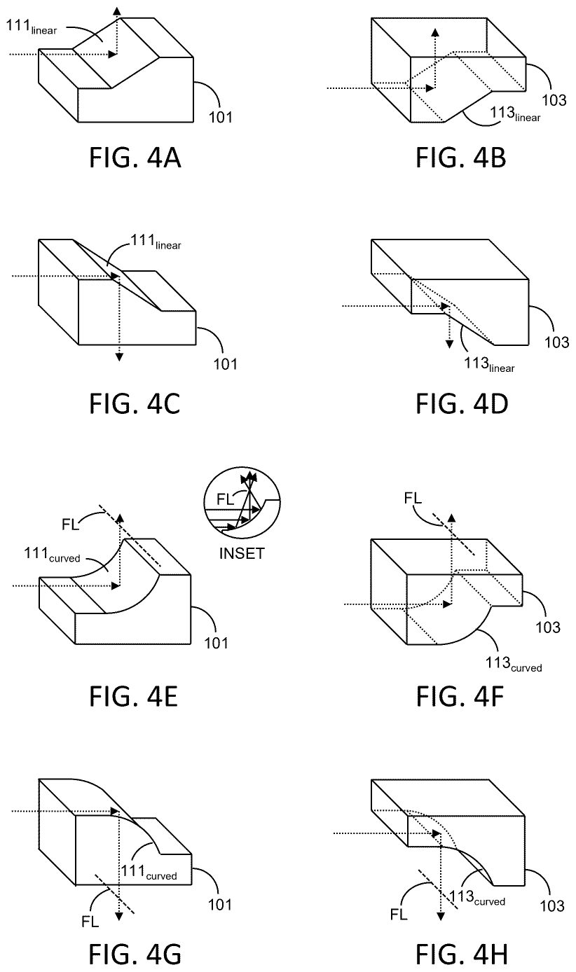

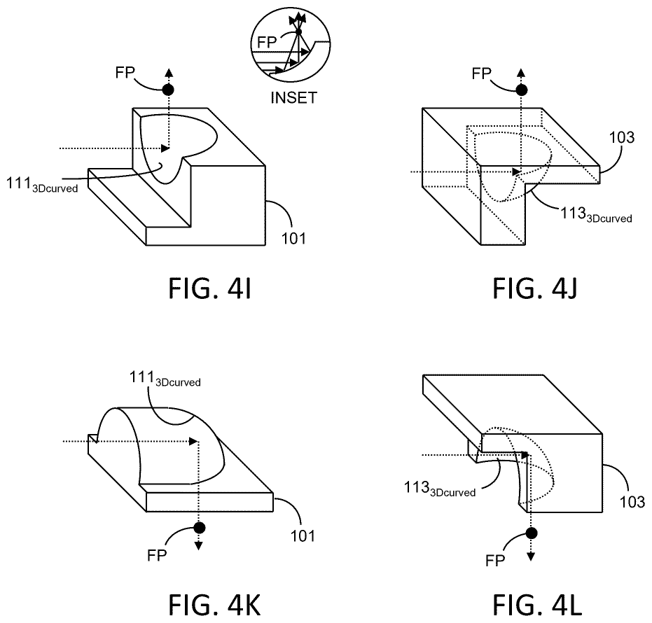

Embodiments having contoured reflecting surface 111 of reflector base 101 and contoured reflecting surface 113 of reflector top 103 that vary linearly with distance from the terminal facet 104_{facet}, are further described in the following paragraphs in conjunction with the descriptions of FIGS. 4A-4D. Embodiments include upward-facing embodiments in FIGS. 4A and 4B, and downward-facing embodiments in FIGS. 4C and 4D.

Embodiments having contoured reflecting surface 111 of reflector base 101 and contoured reflecting surface 113 of reflector top 103 that vary two-dimensionally with distance from the terminal facet 104_{facet}, are further described in the following paragraphs in conjunction with the descriptions of FIGS. 4E-4H. Embodiments include upward-facing embodiments in FIGS. 4E and 4F, and downward-facing embodiments in FIGS. 4G and 4H.

Embodiments having contoured reflecting surface 111 of reflector base 101 and contoured reflecting surface 113 of reflector top 103 that vary in three dimensions with distance from the terminal facet 104_{facet} are further described in the following paragraphs in conjunction with the descriptions of FIGS. 4I-4L. Embodiments include upward-facing embodiments in FIGS. 4I and 4J, and downward-facing embodiments in FIGS. 4K and 4L. Contoured reflecting surfaces 111,113 formed using combinations of linear and curved surfaces may also be used in embodiments.

### Reflector Base and Top Structures

FIG. 4A shows a schematic perspective drawing of a portion of an embodiment of reflector base 101 having a slope that varies linearly with distance from the terminal facet 104_{facet} that may be used to form some embodiments of reflector structure 100 configured to be upward-facing reflector structures. Terminal facet 104_{facet}, in the embodiment, is positioned as, for example, to provide optical signal 170 to the reflector structure 100 as indicated by the dotted line with the arrow shown in FIG. 4A (as referenced throughout herein.) In this configuration, and as shown for example, in the cross-sectional drawing of FIG. 1A, the contoured reflecting surface 111, as used herein, is said to be “facing” the terminal facet 104_{facet} of the planar waveguide 104 that is intersected by the wall of cavity 108.

Repeated for reference, a contoured reflecting surface formed on the reflector base 101 is contoured reflecting surface 111 and a contoured reflecting surface formed on the reflector top 103 is contoured reflecting surface 113. A contoured reflecting surface having linear slope and formed on reflector base 101 is contoured reflecting surface 111ₗᵢₙₑₐᵣ. A contoured reflecting surface having linear slope and formed on reflector top 103 is contoured reflecting surface 113ₗᵢₙₑₐᵣ.

FIG. 4B shows a schematic perspective drawing of a portion of an embodiment of reflector top 103 having a slope that varies linearly with distance from the terminal facet 104_{facet} that may be used to form some embodiments of reflector structure 100 configured to be upward-facing reflector structures. Terminal facet 104_{facet}, in the embodiment, is positioned as, for example, to provide optical signal 170 to the reflector structure 100 as indicated by the dotted line with the arrow shown in FIG. 4B (as referenced throughout herein.) In this configuration, and as shown for example, in the cross-sectional drawing of FIG. 1A, the contoured reflecting surface 111ₗᵢₙₑₐᵣ, as used herein, is said to be “facing” the terminal facet 104_{facet} of the planar waveguide 104 that is intersected by the wall of cavity 108.

The embodiments shown in FIGS. 4B and 4C are formed using transparent, or semitransparent, materials to enable the optical signals propagating in the reflector base 101 in FIG. 4B and the reflector top 103 in FIG. 4C to reach the contoured reflecting surface 111,113 in the embodiments shown.

FIGS. 4C and 4D show embodiments of reflector base 101 and reflector top 103, respectively, that are configured to be used in reflector structures 100 configured to be downward-facing reflector structures. Reflector bases 101 and reflector tops 103 in embodiments of reflector structures 100 may be formed using two-photon polymerization processes.

FIG. 4E shows a schematic perspective drawing of a portion of an embodiment of a reflector base 101 for which the contoured reflecting surface 111 is configured having two-dimensional curvature. The two-dimensional curvature, in the embodiment, varies with distance from the terminal facet 104_{facet} of planar waveguide 104. In some embodiments of reflector structure 100, terminal facet 104_{facet} may be positioned facing contoured reflecting surface 111_{curved} to the left of the contoured reflecting surface 111 of base 101 (as shown, for example, in the positioning between the terminal facet 104_{facet} and the contoured reflecting surface 111 in the embodiment in FIG. 1A).

FIG. 4E shows a schematic perspective drawing of a portion of an embodiment of reflector base 101 having a slope that varies curvilinearly with distance from the terminal facet 104_{facet} that may be used to form some embodiments of reflector structure 100 configured to be upward-facing reflector structures. Terminal facet 104_{facet}, in the embodiment, is positioned as, for example, to provide optical signal 170 to the reflector structure 100 as indicated by the dotted line with the arrow shown in FIG. 4E (as referenced throughout herein.) In this configuration, and as shown for example, in the cross-sectional drawing of FIG. 1A, the contoured reflecting surface 111, as used herein, is said to be “facing” the terminal facet 104_{facet} of the planar waveguide 104 that is intersected by the wall of cavity 108.

The contoured reflecting surface 111_{curved} shown in FIGS. 4E-4H, are configured having two-dimensional curvature to enable a reduction in the breadth of the optical signal 170 along focal line “FL” as indicated by the dotted lines labeled “FL” in FIGS. 4E-4H by the focusing of the optical signal upon reflection from the contoured reflecting surface 111_{curved}. The INSET in FIG. 4E illustrates how the optical signal may be brought to a common focal point over the height of the optical signal 170 in the cross-section shown for some embodiments having two-dimensional curvature in the contoured reflecting surface 111_{curved}.

FIG. 4F shows a schematic perspective drawing of a portion of an embodiment of reflector top 103 having a slope that varies curvilinearly with distance from the terminal facet 104_{facet} that may be used to form some embodiments of reflector structure 100 configured to be upward-facing reflector structures. Terminal facet 104_{facet}, in the embodiment, is positioned as, for example, to provide optical signal 170 to the reflector structure 100 as indicated by the dotted line with the arrow shown in FIG. 4F (as referenced throughout herein.) In this configuration, and as shown for example, in the cross-sectional drawing of FIG. 1A, the contoured reflecting surface 111_{curved}, as used herein, is said to be “facing” the terminal facet 104_{facet} of the planar waveguide 104 that is intersected by the wall of cavity 108.

The embodiments shown in FIGS. 4F and 4G are formed using transparent, or semitransparent, materials to enable the optical signals propagating in the reflector base 101 in FIG. 4F and the reflector top 103 in FIG. 4G to reach the contoured reflecting surface 111,113 in the embodiments shown.

FIGS. 4G and 4H show embodiments of reflector base 101 and reflector top 103, respectively, that are configured for reflector structures 100 that are downward-facing reflector structures. Reflector bases 101 and reflector tops 103 in embodiments of reflector structures 100 may be formed using two-photon polymerization processes.

FIG. 4I shows a schematic perspective drawing of a portion of an embodiment of a reflector base 101 for which the contoured reflecting surface 111_{3Dcurved} is configured having three-dimensional curvature. The three-dimensional curvature, in the embodiment, varies with distance from the terminal facet 104_{facet} of planar waveguide 104. In some embodiments of reflector structure 100, terminal facet 104_{facet} may be positioned facing contoured reflecting surface 111_{3Dcurved} to the left of the contoured reflecting surface 111 of base 101 (as shown, for example, in the positioning between the terminal facet 104_{facet} and the contoured reflecting surface 111 in the embodiment in FIG. 1A).

FIG. 4I shows a schematic perspective drawing of a portion of an embodiment of reflector base 101 having a slope that varies in three dimensions with distance from the terminal facet 104_{facet} that may be used to form some embodiments of reflector structure 100 configured to be upward-facing reflector structures. Terminal facet 104_{facet}, in the embodiment, is positioned as, for example, to provide optical signal 170 to the reflector structure 100 as indicated by the dotted line with the arrow shown in FIG. 4I (as referenced throughout herein.) In this configuration, and as shown for example, in the cross-sectional drawing of FIG. 1A, the contoured reflecting surface 111, as used herein, is said to be “facing” the terminal facet 104_{facet} of the planar waveguide 104 that is intersected by the wall of cavity 108.

The contoured reflecting surface 111_{3Dcurved} shown in FIGS. 4I-4L, are configured having three-dimensional curvature to enable a reduction in the breadth and width of the optical signal 170 at focal point “FP” as indicated by the dotted lines labeled “FP” in FIGS. 4I-4L by the focusing of the optical signal upon reflection from the contoured reflecting surface 111_{3Dcurved}. The INSET in FIG. 4I illustrates how the optical signal may be brought to a common focal point over the height of the optical signal 170 in the cross-section shown for some embodiments having three-dimensional curvature in the contoured reflecting surface 111_{3Dcurved}.

FIG. 4J shows a schematic perspective drawing of a portion of an embodiment of reflector top 103 having a slope that varies in three dimensions with distance from the terminal facet 104_{facet} that may be used to form some embodiments of reflector structure 100 configured to be upward-facing reflector structures. Terminal facet 104_{facet}, in the embodiment, is positioned as, for example, to provide optical signal 170 to the reflector structure 100 as indicated by the dotted line with the arrow shown in FIG. 4J (as referenced throughout herein.) In this configuration, and as shown for example, in the cross-sectional drawing of FIG. 1A, the contoured reflecting surface 111_{3Dcurved}, as used herein, is said to be “facing” the terminal facet 104_{facet} of the planar waveguide 104 that is intersected by the wall of cavity 108.

The embodiments shown in FIGS. 4J and 4K are formed using transparent, or semitransparent, materials to enable the optical signals propagating in the reflector base 101 in FIG. 4J and the reflector top 103 in FIG. 4G to reach the contoured reflecting surface 111,113 in the embodiments shown.

FIGS. 4K and 4L show embodiments of reflector base 101 and reflector top 103, respectively, that are configured for reflector structures 100 that are downward-facing reflector structures. Reflector bases 101 and reflector tops 103 in embodiments of reflector structures 100 may be formed using two-photon polymerization processes as further described herein.

### Reflector Assemblies Having Cavity and Terminated Wave Guide

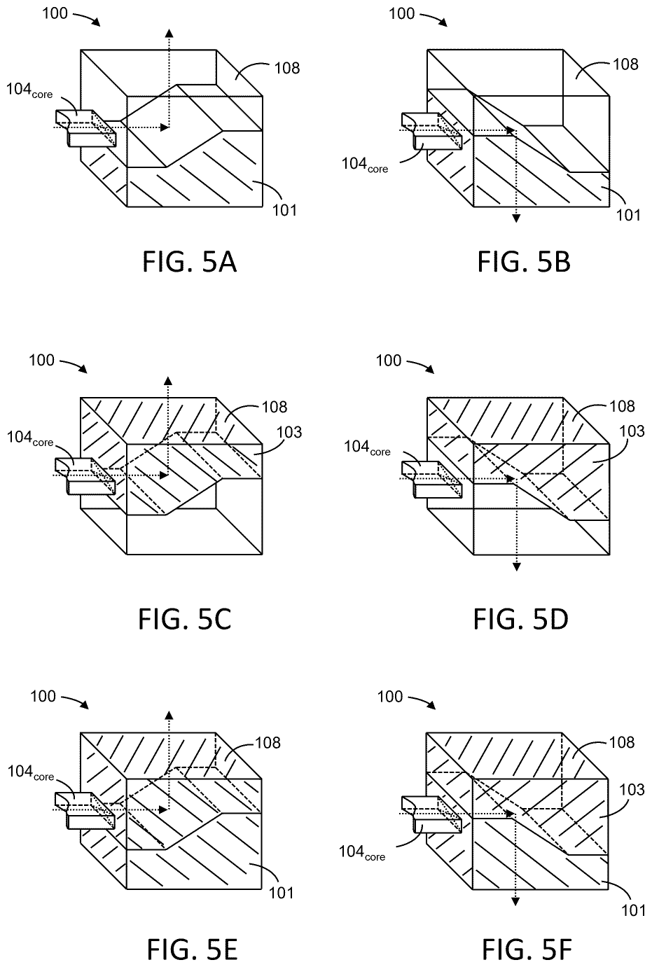

Embodiments of reflector structure 100 may be formed using various methods described in the following sections of this disclosure. Methods of forming embodiments disclosed herein describe steps in the formation of three upward-facing reflector structures and three downward-facing reflector structures as shown in FIGS. 5A-5F.

FIGS. 5A and 5B show reflector base 101 formed in cavity 108 within which the reflector bases 101 are formed at the bottom of the cavity 108. For the reflector structures 100 shown, no reflector top 103 is shown. Reflector base 101 shown in the upward-facing configuration shown in FIG. 5A and in the downward-facing configuration of FIG. 5B may be formed using two-photon polymerization. In some embodiments of the reflector structures 100 shown in FIGS. 5A and 5B, a reflector top 103 may also be formed in cavity 108 following the formation of the reflector base 101. In other embodiments of the reflector structures 100 shown in FIGS. 5A and 5B, a reflector top 103 may not be provided following the formation of the reflector base 101.

FIGS. 5C and 5D show base structures 101 formed in cavity 108 within which reflector top 103 is formed at the upper portion of cavity 108. For the reflector structures shown, no reflector base 101 is present in cavity 108 prior to formation of the reflector tops 103 in the embodiments. Reflector tops 103 shown in the embodiments in FIGS. 5C and 5D may be formed using two-photon polymerization. In some embodiments of the reflector structures 100 shown in FIGS. 5C and 5D, a reflector base 101 may also be formed in cavity 108 following the formation of the reflector top 103. In other embodiments of the reflector structures 100 shown in FIGS. 5C and 5D, a reflector base 101 may not be provided following the formation of the reflector top 103.

FIGS. 5E and 5F show reflector structures 100 formed in cavity 108 wherein the reflector structures are formed having reflector base 101 and reflector top 103. In some embodiments of the reflector structures 100 shown, reflector base 101 may be formed prior to the formation of the reflector top 103 as in the embodiments shown in FIGS. 5A and 5B. In other embodiments, the reflector top 103 may be formed prior to the formation of the reflector base 101 as in the embodiments shown in FIGS. 5C and 5D. The reflector bases 101 and the reflector tops 103 shown in the embodiments in FIGS. 5C and 5D may be formed using two-photon polymerization.

FIGS. 5A-5F illustrate configurations of the reflector base 101 and reflector top 103 that may be encountered in the methods of formation of embodiments to be described herein.

FIG. 6 shows a perspective drawing of a cavity 108 formed in substrate 110. The cavity 108 formed in substrate 110 enables the reflective layer or interface of a reflector structure 100 to be brought into alignment with the plane of the optical axis of the planar waveguide 104. Terminal facet 104_{facet} of planar waveguide core 104_{core} is shown in FIG. 6 terminating at the wall of cavity 108. Cavity 108, having terminal facet 104_{facet}, is receptive to the formation of reflector structure 100.

### Method of Forming Cavity in Substrate Having a Planar Waveguide Layer

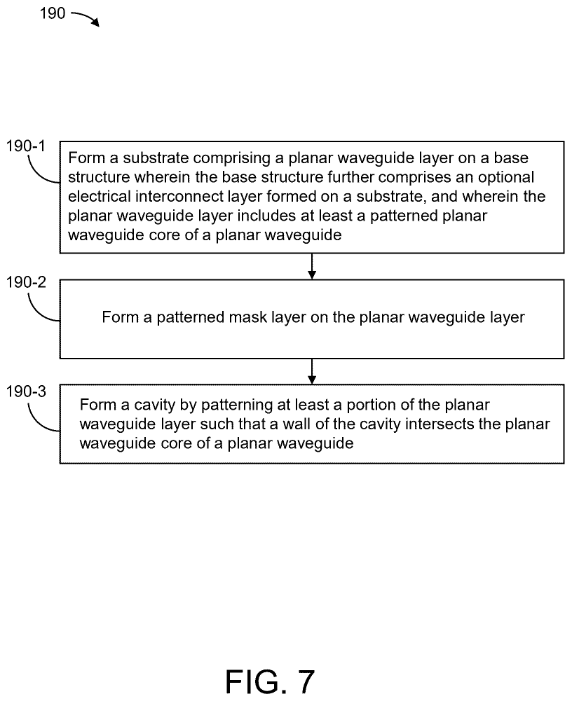

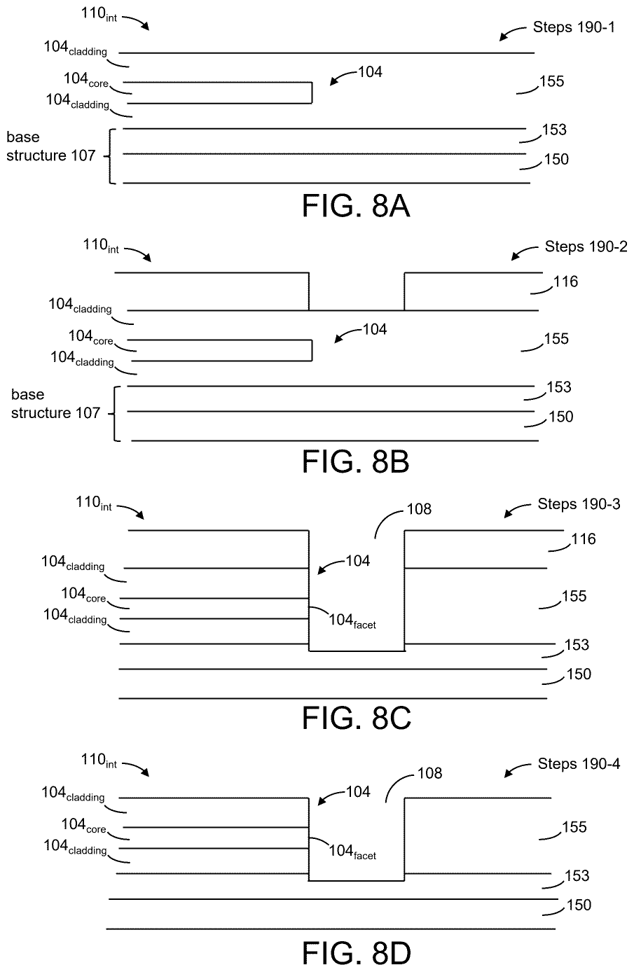

FIG. 7 shows a flowchart for a method 190 of forming a cavity 108 in substrate 110 wherein a wall of cavity 108 intersects a planar waveguide 104 formed in the substrate 110. Steps in method 190 are described in conjunction with the cross-sectional drawings in FIGS. 8A-8D.

Step 190-1 of method 190 is a forming step in which a substrate 110 is formed. In the embodiment, substrate 110 is an interposer substrate 110ᵢₙₜ, wherein the interposer substrate comprises all or a portion of a planar waveguide layer, and a base structure further comprising an optional electrical interconnect layer formed on a substrate. The cross-sectional schematic drawing in FIG. 8A shows a planar waveguide layer 155 on base structure 107 comprising electrical interconnect layer 153 and substratum 150. In FIG. 8A, the planar waveguide layer 105 is shown having planar waveguide 104 comprising a patterned planar waveguide core 104_{core} between planar waveguide cladding 104_{cladding} above and below (and sides, not shown) the patterned planar waveguide core layer 104_{core}. The interposer substrate 110ᵢₙₜ is a substrate 110 having an optional electrical interconnect layer 153. In some embodiments, optional electrical interconnect layer 153 can provide distinct advantages with regard to the formation of electrical interconnections between devices formed, mounted, and otherwise disposed on, or coupled to, substrate 110.

Interposer substrate 110ᵢₙₜ, as shown in the cross-sectional drawing in FIG. 8A includes all or a portion of a planar waveguide layer 155 formed on a base structure 107 comprising substratum 150 and optional electrical interconnect layer 153. Substratum 150 may be, for example, a silicon substrate. In some embodiments, substratum 150 may be a substrate formed from one or more of indium phosphide, gallium arsenide, and other semiconductor substrates. In yet other embodiments, a ceramic or insulating substrate may be used. In yet other embodiments, a metal substrate is used. And in yet other embodiments, a combination of one or more semiconductor layers, insulating layers, and metal layers may be used to form substratum 150 upon which the optional electrical interconnect layer 153 and all or a portion of the planar waveguide layer 155 are formed. In some embodiments, the electrical interconnect layer 153 is not in direct contact with the substrate but rather an intervening layer may be present. Similarly, the planar waveguide layer 155, in some embodiments, may not be in direct contact with the underlying electrical interconnect layer 153 but rather an intervening layer or layers may be present. In some embodiments, a semiconductor layer or substrate is mounted on a metal layer or substrate to form a composite substrate.

Optional electrical interconnect layer 153 may not be present, for example, for interposer structures that do not require underlying electrical connectivity between devices formed on substrate 110. An electrical interconnect layer, as used herein, refers to a composite layer that includes electrically conductive materials for transmitting electrical signals and the intermetal and other layers required to insulate the electrically conductive materials. An electrical interconnect layer may include a patterned layer of electrically conducting material such as copper or aluminum as well as the intermetal dielectric material such as silicon dioxide, and spacer layers above and below the electrically conductive materials, for example, among other layers. Other conductive layers may also be used to form the electrically conductive layers of electrical interconnect layer 153 in embodiments of reflective structure 100 formed on an interposer substrate 110ᵢₙₜ. And other insulating layers may be used to form the electrically insulating layers of the electrical interconnect layer 153 in embodiments of reflector structures 100 formed on interposer substrate 110ᵢₙₜ.

Step 190-2 of method 190 is a forming step in which a patterned mask layer is formed on the planar waveguide layer. Patterned mask layer 116 is shown on planar waveguide layer 155 in the cross-sectional drawing in FIG. 8B.

Step 190-3 of method 190 is a forming step in which a cavity is formed by patterning at least a portion of the planar waveguide layer to a depth that intersects a patterned planar waveguide core of the planar waveguide layer. FIG. 8C shows cavity 108 formed in the interposer substrate 110ᵢₙₜ. A wall of cavity 108 is shown to intersect the planar waveguide core 104_{core} to form terminal facet 104_{facet} in the planar waveguide layer 155. FIG. 8D shows the structure of FIG. 8C after removal of the patterned mask layer 116. The cross-sectional drawing of FIG. 8D is comparable to the embodiment shown in the perspective drawing of FIG. 6.

The formation of the cavity 108 enables the formation of embodiments of reflector structure 100 having an optical axis formed within the contoured reflecting surface of the reflector structure 100 to be brought into alignment with the plane of the optical axis of the planar waveguide core 104_{core} of the planar waveguide 104 that is intersected by the wall of the cavity 108. The optical axis of a contoured reflecting surface of an embodiment of a reflector structure 100, as used herein, is contained within the portion of the contoured reflecting surface for which the path of the optical signal is reflected. The optical axis may be contained within a sizable area of a linearly sloping contoured reflecting surface, for example, as the reflective properties and directionality of a reflected optical signal may remain consistent over a wide range of the surface area of the linearly sloping contoured reflecting surface. In embodiments of reflector structure 100 having a curved contoured reflecting surface, the optical axis may comprise a much smaller surface area as the effective area suitable for focusing the optical signal incident on the contoured reflecting surface may be limited.

### TIR Reflectors

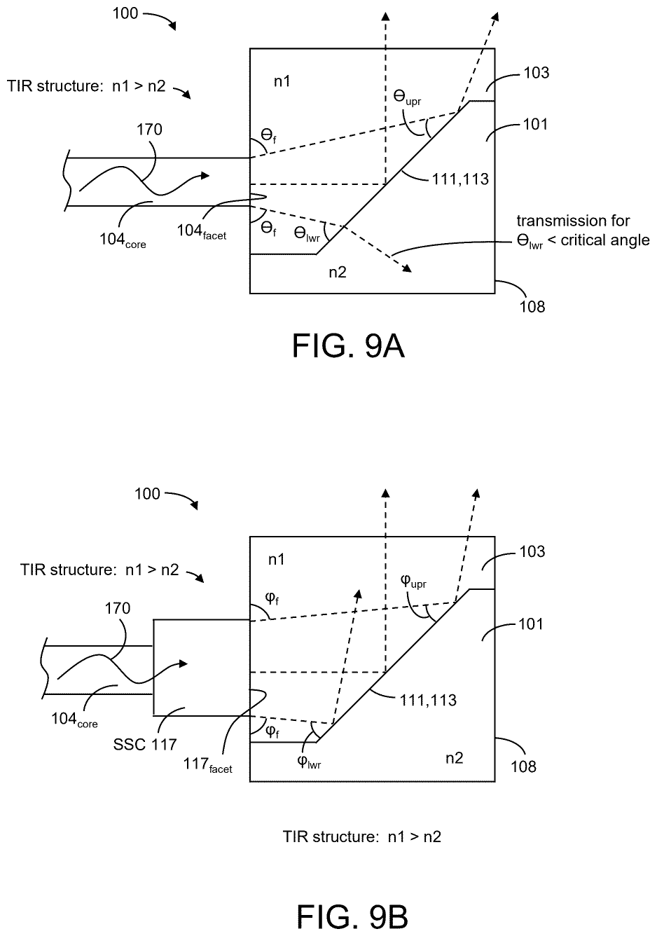

FIGS. 9A and 9B show cross-sectional schematic drawings of embodiments of reflector structure 100 configured as TIR reflector structures that illustrate the pathways of an optical signal propagating from a planar waveguide core 104_{core} of a planar waveguide 104 and the anticipated effect of having a spot size converter on the optical pathways to illustrate the effect of having a spot size converter included in the embodiment of reflector structure 100. The embodiment of reflector structure 100 shown in FIG. 9A does not include a spot size converter. The optical signal 170 shown in FIG. 9A emerges from the terminal facet 104_{facet} of the planar waveguide 104 to the reflector top 103 having an index of refraction, n1. In embodiments, some divergence of the optical signal may be anticipated, although the extent of the divergence may be reduced or minimized by configuring the refractive index of the reflector top 103 to be equal to, or approximately equal to, the refractive index of the planar waveguide core 104_{core} of the planar waveguide 104. To better illustrate the effect of having a spot size converter in the embodiment of reflector structure 100, some divergence of the optical signal is shown in FIG. 9A. The dotted lines in FIG. 9A show an example range in height for the optical signal 170 propagating in reflector structure 100 as the optical signal 170 emerges from the planar waveguide 104. The divergence of the optical signal is shown having an angle, θ_{f}, with respect to the wall of cavity 108 in proximity to the top and bottom of the terminal facet 104_{facet}. An upper portion of the optical signal from an upper portion of the terminal facet 104_{facet} is incident on the contoured reflecting surface 111,113 at an angle θᵤₚᵣ. A lower portion of the optical signal 170 from the lower portion of the terminal facet 104_{facet} is incident on the contoured reflecting surface 111,113 at an angle, θ_{lwr}. For incident angles above a critical angle, full reflection of the optical signals may be anticipated. For incident angles below a critical angle, the optical signal 170 will not be fully reflected. In embodiments of reflector structures having all or a portion of the optical signal incident on the contoured reflecting surface below the critical angle, transmission of the optical signal into the reflector base may occur resulting in a loss of intensity of the reflected portion of the optical signal 170.

The loss in intensity of a reflected optical signal intensity that results from the divergence of the optical signal propagating from the terminal facet 104_{facet} may be mitigated fully or in part with the inclusion of a spot size converter formed in all or a portion of the planar waveguide 104. Spot size converters are devices that may be formed all or in part, for example, from the planar waveguide layer 104. The cross-sectional schematic drawing of FIG. 9B shows spot size converter 117 formed between planar waveguide 104 and cavity 108 wherein the spot size converter 117 is shown having terminal facet 117_{facet} formed at the wall of the cavity 108. The range of height, for an example optical signal 170 emerging from the terminal facet 117_{facet}, is shown in dotted lines. The divergence of the optical signal is shown having an angle, φ_{f}, with respect to the wall of cavity 108 in proximity to the top and bottom of the terminal facet 117_{facet}. An upper portion of the optical signal 170 from an upper portion of the terminal facet 117_{facet} is incident on the contoured reflecting surface 111,113 at an angle φᵤₚᵣ. A lower portion of the optical signal 170 from the lower portion of the terminal facet 117_{facet} is incident on the contoured reflecting surface 111,113 at an angle, φ_{lwr}. For incident angles above a critical angle, full reflection of the optical signals may be anticipated. For incident angles below a critical angle, the optical signal 170 will not be fully reflected. In embodiments of reflector structures having all or a portion of the optical signal incident on the contoured reflecting surface 111,113 below the critical angle, transmission of the optical signal 170 into the reflector base may occur resulting in a loss of intensity of the reflected portion of the optical signal 170. In the embodiments shown in FIG. 9B, the inclusion of the spot size converter results in an increase in the angle φ_{f} in comparison to θ_{f} shown for the embodiment on FIG. 9A. The increase in the angle Φ_{f} is illustrative of the reduction in the divergence of the optical signal 170 emerging from the terminal facet 117_{facet} of the embodiment shown in FIG. 9B in comparison to the optical signal 170 emerging from the terminal facet 104_{facet} of the embodiment shown in FIG. 9A. The reduction in divergence, in embodiments having spot size converter 117, may lead to a larger portion of the optical signal 170 having incident angles greater than the critical angle, leading to a reduction in losses related to the transmission of portions of the optical signal into the reflector base 101.

### PIC Assemblies

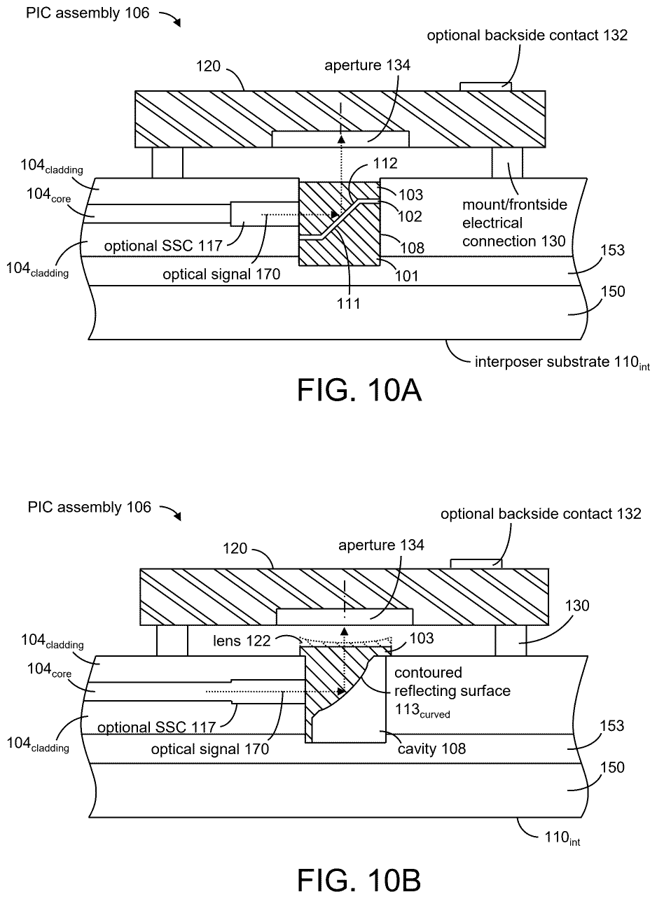

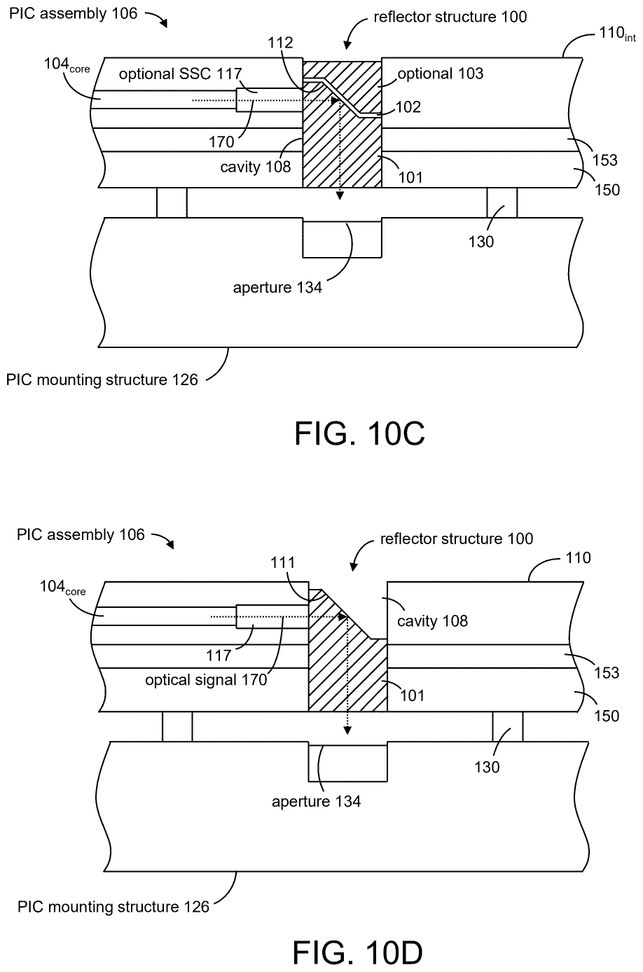

FIGS. 10A-10B, and FIGS. 11 and 12 show some examples of portions of photonic integrated circuit assemblies 106 having embodiments of reflector structures 100.

FIG. 10A shows a schematic cross-sectional drawing of an embodiment of a PIC assembly 106 that includes an embodiment of reflector structure 100 formed in part using two-photon polymerization wherein the reflector structure 100 includes a spot size converter 117, and wherein the PIC assembly 106 includes a mounted photodiode 120 receptive to optical signal 170 reflected from the contoured reflecting surface 112 of the reflector structure 100. In PIC assembly 106, mounted device 120 is shown mounted to electrical connections 130 formed at the top of substrate 110. Mounted device 120 may be further configured having optional backside contacts 132 to enable one or more of electrical power and signal processing, for example. In some embodiments, substrate 110 may be an interposer substrate 110ᵢₙₜ having an electrical interconnect layer 153. Mounted device 120, may be, for example, a photodiode having an optical aperture 134 receptive to optical signal 170 reflected from reflector structure 100. Optical signal 170 propagating in planar waveguide core 104_{core} of planar waveguide 104, in the embodiment, may propagate through, and emerge from, the spot size converter 117 to the reflector top 103 portion of the reflector structure 100. Optical signal 170 traverses the reflector top 103 to the contoured reflecting surface 112 of the reflective layer 102 and is redirected to an upward portion of the cavity 108 whereupon the optical signal 170 exits the cavity 108 through an upper surface of the reflector top 103 to the receptive aperture 134 of the mounted device 120. PIC assembly 106 shown in FIG. 10A configured having an embodiment of reflector structure 100 is formed having reflective layer 102, wherein the reflector structure 100 is configured to be an upward-facing reflector structure. contoured reflecting surface 112 is formed on contoured reflecting surface 111 of the reflector base 101. The embodiment depicted in FIG. 10A is shown having a linearly varying slope in the contoured reflecting surface 112. Other embodiments may be configured having contoured reflecting surface 112 that is curved in one or more two-dimensions and three-dimensions as described for example in FIGS. 4E and 4I, respectively.

FIG. 10B shows a schematic cross-sectional drawing of another embodiment of a PIC assembly 106 that includes an embodiment of reflector structure 100 formed in part using two-photon polymerization wherein the reflector structure 100 includes a spot size converter 117, and wherein the PIC assembly 106 includes a mounted photodiode 120 receptive to optical signal 170 reflected from the contoured reflecting surface 113 curved of the reflector structure 100. Contoured reflecting surface 113_{curved}, formed using two-photon polymerization, provides curvature in the contoured reflecting surface 113 of the TIR reflector to enable focusing of optical signal 170. Optical signal 170 reflected from the contoured reflecting surface 113_{curved} of reflector top 103 may be, for example, focused on all or a portion of the aperture 134 of mounted device 120 mounted on substrate 110. In the PIC assembly 106, mounted device 120 is shown mounted to electrical connections 130 formed at the top of substrate 110. In some embodiments, substrate 110 may be an interposer substrate 110ᵢₙₜ having an electrical interconnect layer 153. Mounted device 120, may be, for example, a photodiode having an optical aperture 134 receptive to optical signal 170 reflected from reflector structure 100. Optical signal 170 propagating in planar waveguide core 104_{core} of planar waveguide 104, in the embodiment, may propagate through, and emerge from, the spot size converter 117 to the reflector top 103 portion of the reflector structure 100. Optical signal 170 traverses the reflector top 103 to the contoured reflecting surface 113_{curved} of the reflector top 103 and is redirected to an upward portion of the cavity 108 whereupon the optical signal 170 exits the cavity 108 through an upper surface of the reflector top 103 to the receptive aperture 134 of the mounted device 120. The PIC assembly 106 shown in FIG. 10A, configured having an embodiment of reflector structure 100 that is a TIR reflector, is formed having contoured reflecting surface 113_{curved} of reflector top 103, wherein the reflector structure 100 is configured to be an upward-facing reflector structure. The embodiment depicted in FIG. 10B is shown having a contoured reflecting surface 113_{curved} that varies in two dimensions with distance from the terminal facet 117_{facet} of the spot size converter 117. Other embodiments may be configured having contoured reflecting surface 113 that is linearly varying. And in yet other embodiments, the contoured reflecting surface 113 may be configured having curvature that varies in three-dimensions as described for example in FIGS. 4B and 4J, respectively.

The embodiment of reflector structure 100 shown in FIG. 10B further includes an optional lens feature 122 formed in conjunction with the reflector top 103 using two-photon polymerization. Optional lens feature 122 may be included in embodiments of reflector structure 100 to enable further focusing of optical signals 170 reflected from contoured reflecting surfaces such as contoured reflecting surface 113_{curved} in the embodiment of FIG. 10B. In the embodiment, the optional lens feature 122 enables, for example, the focusing of the optical signal 170 from the contoured reflecting surface 113_{curved} to the aperture 134 of the mounted device 120. Focusing of the reflected optical signals onto the aperture 134 of mounted device 120, in the embodiment, may lead to improvements in the receptivity of the mounted device to the optical signals reflected from the reflector structure 100 resulting in, for example, improved resolution and improved signal integrity of the reflected optical signals, among other potential benefits.

FIGS. 10C and 10D show schematic cross-sectional drawings of other embodiments of PIC assemblies 106 that include an embodiment of reflector structure 100 formed in part using two-photon polymerization wherein the reflector structure 100 includes a spot size converter 117, wherein the substrate 110 is mounted on a PIC mounting structure 126, and wherein the reflector structure 100 is configured to be downward-facing. The downward-facing reflector structure 100 is configured, in the embodiment, to reflect an optical signal emerging from the terminal facet 117_{facet} of the spot size converter toward the bottom of cavity 108 formed in the substrate 110.

In the embodiment of PIC assembly 106 shown in FIG. 10C, the embodiment of reflector structure 100 is configured having reflective layer 102 formed on reflector base 101. An optional reflector top 103 for the embodiment is shown on reflective layer 102. The PIC assembly 106 includes a PIC mounting structure 126 upon which the PIC assembly 106 may be mounted. Aperture 134 of the PIC mounting structure 126 is receptive to optical signal 170 reflected from the contoured reflecting surface 112 of the reflector structure 100. Contoured reflecting surface 112 is shown on the reflective layer 102 wherein the reflective layer 102 is formed on the reflector base 101 having a contoured reflecting surface 111 formed using two-photon polymerization that provides the contoured structure upon which the reflective layer 102 may be formed. Optical signal 170 may be reflected from the contoured reflecting surface 112 of the reflective layer 102, for example, to all or a portion of the aperture 134 of the mounting structure 126. In the PIC assembly 106, substrate 110ᵢₙₜ is shown mounted to electrical connections 130 formed at the top of the mounting structure 126. In the embodiment, substrate 110 is configured as an interposer substrate 110ᵢₙₜ having an electrical interconnect layer 153 formed, for example, on substratum 150 as shown in FIG. 10C. PIC mounting structure 126, may be, for example, an interposer or other device structure receptive to the mounting of optical devices such as PIC assembly 106 to enable the formation of PIC assemblies comprising a plurality of devices. The aperture 134 of the mounting structure 126 may be, for example, the aperture of an optical receiving device mounted on the mounting structure 126. The aperture 134 of the mounting structure 126 may be, for example, the aperture of an optical receiving device formed on the mounting structure 126.

Optical signal 170 propagating in planar waveguide core 104_{core} of planar waveguide 104, in the embodiment, may propagate through, and emerge from, the spot size converter 117 to the reflector base 101 of the reflector structure 100 wherein the optical signal 170 traverses the reflector base 101 to the contoured reflecting surface 112 of the reflective layer 102 formed on the reflector base 101 and is redirected to a bottom portion of the cavity 108 whereupon the optical signal 170 exits the cavity 108 through the bottom surface of the reflector base 101 to the receptive aperture 134 of the mounting structure 126. The PIC assembly 106 shown in FIG. 10C, configured having an embodiment of reflector structure 100 that includes reflective layer 102, is formed having contoured reflecting surface 111 of reflector base 101, wherein the reflector structure 100 is configured to be a downward-facing reflector structure. The embodiment depicted in FIG. 10C is shown having a contoured reflecting surface 112 that varies linearly with distance from the terminal facet 117_{facet} of the spot size converter 117. Other embodiments may be configured having contoured reflecting surfaces 112 that have curvature as described herein in, for example, in conjunction with FIGS. 4G and 4K.

In the embodiment of PIC assembly 106 shown in FIG. 10D, the embodiment of reflector structure 100 is configured having as a TIR reflector structure. PIC assembly 106, in the embodiment, includes a PIC mounting structure 126 upon which the PIC assembly 106 may be mounted. Aperture 134 of the PIC mounting structure 126 is receptive to optical signal 170 reflected from the contoured reflecting surface 111 of the reflector structure 100. Reflector base 101 is formed having contoured reflecting surface 111 using two-photon polymerization in the embodiment. Optical signal 170 may be reflected from the contoured reflecting surface 111 of the reflector base 101, for example, to all or a portion of the aperture 134 of the mounting structure 126. In the embodiment, the refractive index of reflector base 101 is greater than that of the air or other gas that may be used to occupy the volume over the contoured reflecting surface 111. In the PIC assembly 106, substrate 110 is shown mounted to electrical connections 130 formed at the top of the mounting structure 126. In some embodiments, substrate 110 may be an interposer substrate 110ᵢₙₜ having an electrical interconnect layer 153 as shown. PIC mounting structure 126, may be, for example, an interposer or other device structure receptive to the mounting of optical devices such as PIC assembly 106 to enable the formation of PIC assemblies comprising a plurality of devices. The aperture 134 of the mounting structure 126 may be, for example, the aperture of an optical receiving device mounted on the mounting structure 126. The aperture 134 of the mounting structure 126 may be, for example, the aperture of an optical receiving device formed on the mounting structure 126.

Optical signal 170 propagating in planar waveguide core 104_{core} of planar waveguide 104, in the embodiment, may propagate through, and emerge from, the spot size converter 117 to the reflector base 101 of the reflector structure 100 wherein the optical signal 170 traverses the reflector base 101 to the contoured reflecting surface 111 of the reflector base 101 and is redirected to a bottom portion of the cavity 108 whereupon the optical signal 170 exits the cavity 108 through the bottom surface of the reflector base 101 to the receptive aperture 134 of the mounting structure 126. PIC assembly 106 shown in FIG. 10D, configured having an embodiment of reflector structure 100 that is a TIR reflector, is formed having contoured reflecting surface 111 of reflector base 101 configured to form a downward-facing reflector structure. The embodiment depicted in FIG. 10D is shown having a contoured reflecting surface 111 that varies linearly with distance from the terminal facet 117_{facet} of the spot size converter 117. Other embodiments may be configured having contoured reflecting surfaces 111 that have curvature as described herein in, for example, in conjunction with FIGS. 4G and 4K. In the embodiment, substrate 110 is configured as an interposer substrate 110ᵢₙₜ having an electrical interconnect layer 153 formed, for example, on substratum 150 as shown in FIG. 10D.

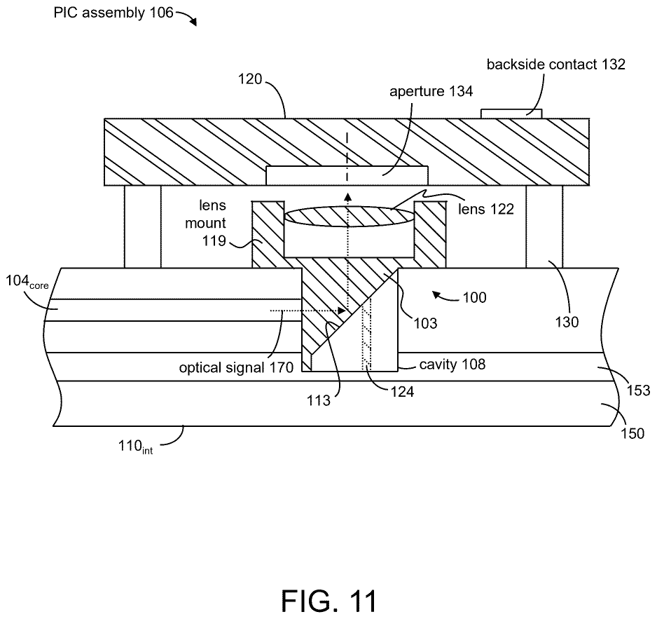

FIG. 11 shows a schematic cross-sectional drawing of another embodiment of a PIC assembly 106 that includes an embodiment of reflector structure 100 formed in part using two-photon polymerization wherein the reflector structure 100 includes an optional lens feature 122 formed between an upper portion of a reflector top 103 and the aperture 134 of a mounted device 120 mounted on substrate 110. In the embodiment, reflector structure 100 is configured as an upward-facing TIR reflector. Contoured reflecting surface 113, formed of reflector top 103 using two-photon polymerization, provides contoured reflecting surface 113 of the TIR reflector to enable reflection of optical signal 170 from the planar waveguide 104 to aperture 134 of the mounted device 120 through the optional lens feature 122. In the embodiment, optional lens feature 122 is shown configured having lens mount 119 to support the optional lens feature 122. Optical signal 170 reflected from the contoured reflecting surface 113 of reflector top 103 may be, for example, directed to all or a portion of the aperture 134 of mounted device 120 mounted on substrate 110 through the lens feature 122. In the PIC assembly 106, mounted device 120 is shown mounted to electrical connections 130 formed at the top of substrate 110. In some embodiments, substrate 110 may be configured as an interposer substrate 110ᵢₙₜ having an electrical interconnect layer 153 as shown in the embodiment of FIG. 11. Mounted device 120, may be, for example, a photodiode having an optical aperture 134 receptive to optical signal 170 reflected from reflector structure 100. Optical signal 170 propagating in planar waveguide core 104_{core} of planar waveguide 104, in the embodiment, may propagate through, and emerge from, the terminal facet 104_{facet} to the reflector top 103 portion of the reflector structure 100. Optical signal 170 traverses the reflector top 103 to the contoured reflecting surface 113 of the reflector top 103 and is redirected to an upward portion of the cavity 108 whereupon the optical signal 170 exits the cavity 108 through an upper surface of the reflector top 103 to the optional lens feature 122. Optional lens feature 122 provides a focused optical signal 170 to the receptive aperture 134 of the mounted device 120. The PIC assembly 106 shown in FIG. 11, configured having an embodiment of reflector structure 100 that is a TIR reflector, is formed having contoured reflecting surface 113 of reflector top 103, wherein the reflector structure 100 is configured to be an upward-facing reflector structure. The embodiment depicted in FIG. 11 is shown having a contoured reflecting surface 113 that varies linearly with distance from the terminal facet 104_{facet} of planar waveguide 104. Other embodiments may be configured having contoured reflecting surface 113 that include curvature. The contoured reflecting surface 113 may be configured, for example, having curvature that varies in one or more of two-dimensions and three-dimensions as described for example in FIGS. 4F and 4J, respectively. In other embodiments, reflector structure 100 may be configured having spot size converter 117. And in yet other embodiments, optional lens features 122 may formed on one or more the lower contoured reflecting surface 113 of the reflector top 103 and the upper surface of the reflector top 103, as shown for example, in the embodiment of FIG. 10B. In some embodiments, optional lens features may be formed in conjunction with the formation of reflector top 103 using two-photon polymerization in embodiments having optional lens feature 122. In other embodiments, a lens feature 122 may be a discrete lens mounted or otherwise formed in lens mount 119.

Focusing of the reflected optical signals onto the aperture 134 of mounted device 120, in the embodiment, may lead to improvements in the receptivity of the mounted device to the optical signals reflected from the reflector structure 100 resulting in, for example, improved resolution and improved signal integrity of the reflected optical signals, among other potential benefits.

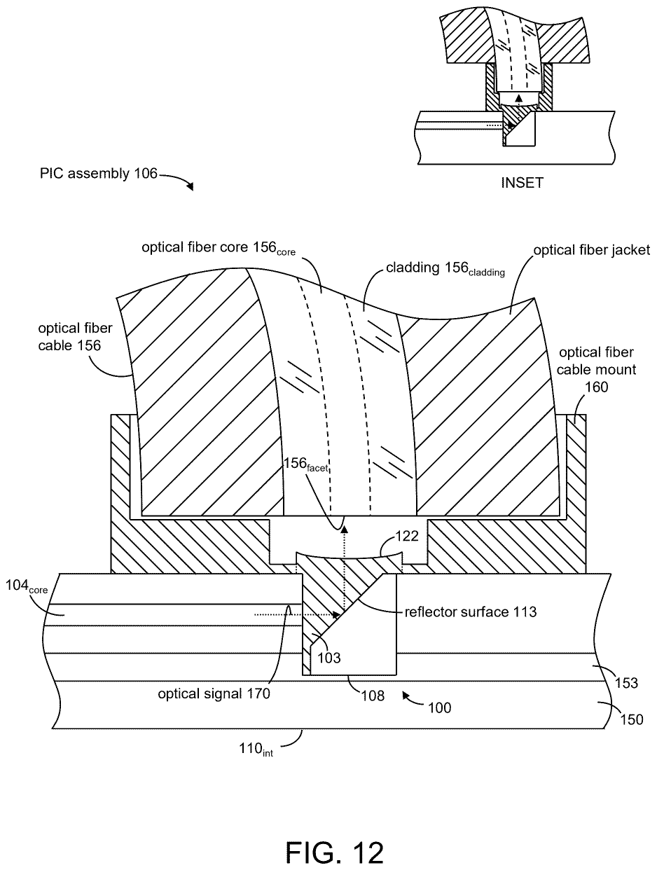

FIG. 12 shows a schematic cross-sectional drawing of an embodiment of PIC assembly 106 comprising an embodiment of a reflector structure 100 and a mounted optical fiber cable 156 wherein the reflector structure 100 is configured as a TIR reflector formed in cavity 108 using two-photon polymerization and further configured having an optional lens feature 122 formed between the reflector top 103 and an end facet 156_{facet} of the mounted optical fiber cable 156. The optical fiber cable 156 is shown mounted in optical fiber cable mount 160, that may be formed wholly, or in part, in conjunction with the reflector top 103 using two-photon polymerization. An inner fiber of the optical fiber cable 156 is shown having optical fiber cladding 156_{cladding} surrounding the optical fiber core 156_{core}. The core and cladding are shown encased in an optical fiber jacket. In some embodiments, all or a portion of the jacket may be removed to facilitate the formation of smaller mounting structures within which, for example, the optical fiber cladding 156_{cladding} and core 156_{core} may be supported by the optical fiber cable mount 160. In the embodiment, for example, shown in the INSET of FIG. 12, the optical fiber cable 156 is shown with the jacketing removed from a terminal end portion of the optical fiber cable 156. Removal of all or a portion of the jacketing of the fiber optic cable may facilitate the use of smaller mounting structures in some embodiments. In the embodiment shown in FIG. 12, substrate 110 is configured as an interposer substrate 110ᵢₙₜ further configured having an electrical interconnect layer 153 formed on substratum 150. The planar waveguide layer configured having core layer 104_{core} is formed all or in part on the electrical interconnect layer 153 shown in the embodiment of FIG. 12.

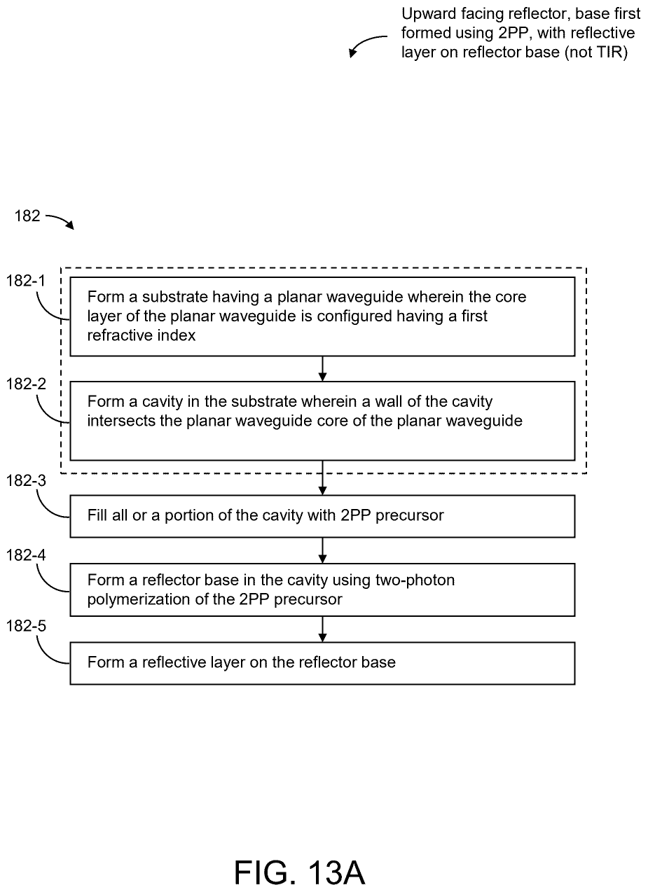

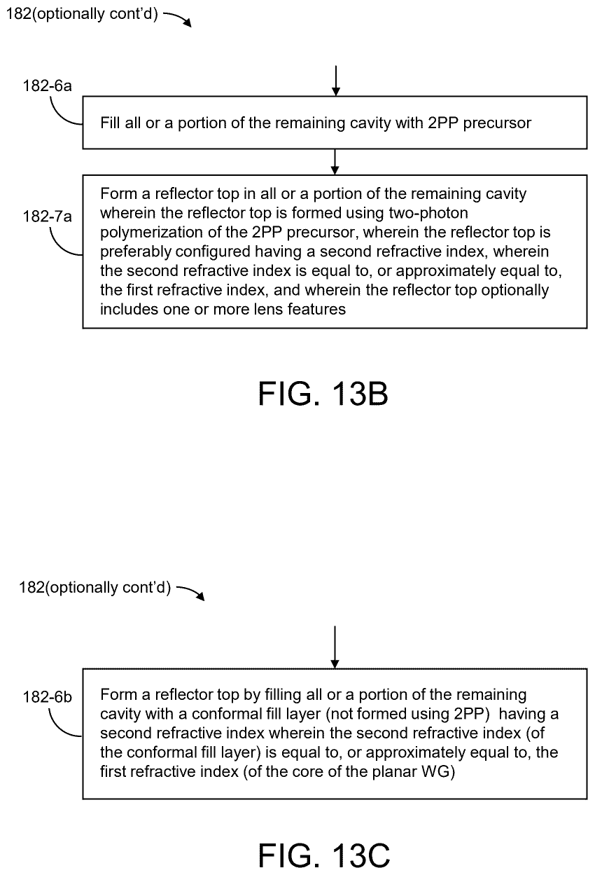

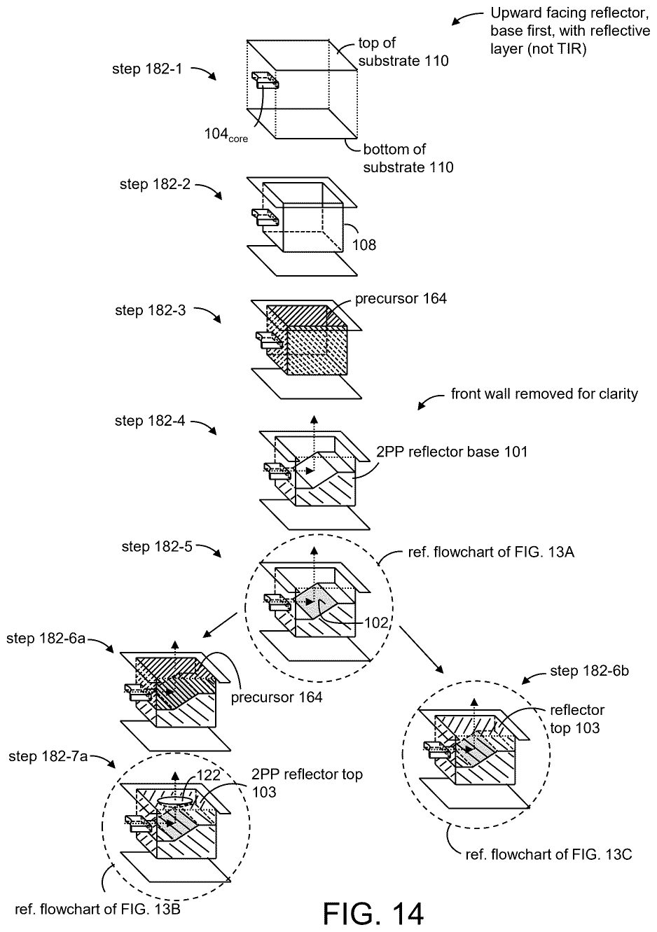

Methods of forming embodiments of reflector structure 100 are disclosed herein in FIGS. 13A-28. In the methods of forming embodiments of reflector structure 100 described herein, reflector structures 100 may be formed by firstly forming the reflector base 101 in cavity 108, as in the configurations shown in FIGS. 5A and 5B. Alternatively, reflector structure 100 may be formed by firstly forming the reflector top 103 in cavity 108, as in the configurations shown in FIGS. 5C and 5D. After formation of the configurations having the reflector base 101 firstly formed, as shown in FIGS. 5A and 5B, a reflector top 103 may be formed on the reflector base 101, with or without the inclusion of reflective layer 102 prior to formation of the reflector top 103 to form structures having a reflector base 101 and a reflector top 103 as shown in FIGS. 5E and 5F. After formation of the configurations having the reflector top 103 firstly formed, as shown in FIGS. 5C and 5D, a reflector base 101 may be formed below the reflector top 103, without the inclusion of reflective layer 102 to form structures having a reflector base 101 and a reflector top 103 as shown in FIGS. 5E and 5F. In the methods disclosed herein, steps in the formation of a number of embodiments of reflector structure 100 formed using two-photon polymerization are described. In some embodiments, reflector structure 100 is configured as an upward-facing reflector structure. In other embodiments, reflector structure 100 is configured as a downward-facing reflector structure. In some embodiments, reflector structure 100 is configured as an upward-facing reflector structure further configured as a reflector structure having a reflective layer 102. And in some embodiments, reflector structure 100 is configured as an upward-facing reflector structure further configured as a TIR reflector structure. Methods are disclosed herein for embodiments configured upward-facing, configured downward-facing, reflector structures configured having reflective layers, reflector structures configured as TIR reflectors, reflector structures 100 having a reflective layer 102 in which the reflector base 101 is firstly formed, reflector structures 100 configured as TIR reflectors in which the reflector base 101 is firstly formed, and reflector structures 100 configured as TIR reflectors in which the reflector top 103 is firstly formed. The formation of other methods may also be disclosed such as, for example, embodiments that include one or more optional lens feature 122, among other embodiments that may be disclosed herein.

### Methods of Forming Upward-Facing Reflector Structures

FIG. 13A shows a flowchart for a method 182 of forming embodiments of reflector structure 100 configured to provide an upward-facing reflector structure that includes reflective layer 102 formed on reflector base 101 wherein the reflector base 101 is formed using two-photon polymerization. Embodiments of an upward-facing reflector structure 100 formed using method 182 comprise substrate 110 having cavity 108 that intersects planar waveguide core 104_{core} of planar waveguide 104, reflector base 101 formed using two-photon polymerization, and reflective layer 102 formed on the reflector base 101.

FIG. 13B shows optional steps 182-6a and 182-7a for the flowchart of method 182, that when combined with steps 182-1 to 182-5, provide steps in the formation of an embodiment having the reflector structure 100 of FIG. 13A with the addition of an optional reflector top 103 formed on the reflective layer 102 wherein the optional reflector top 103 is also formed using two-photon polymerization.

FIG. 13C shows optional step 182-6b for the flowchart of method 182, that when combined with steps 182-1 to 182-5, provide steps in the formation of an embodiment having the reflector structure 100 of FIG. 13A with the addition of an optional reflector top 103 formed on the reflective layer 102 wherein the optional reflector top 103 is formed with a conformal fill layer.

Steps in the method 182 of FIGS. 13A-13C are described in conjunction with the perspective drawings shown in FIG. 14. The circled perspective drawings in FIG. 14 show embodiments of reflector structure 100.

Step 182-1 of method 182 is a forming step in which a substrate 110 is formed having planar waveguide 104, wherein the planar waveguide core 104_{core} of the planar waveguide 104 is configured having a first refractive index. The perspective drawing labeled “Step 182-1” in FIG. 14 shows the planar waveguide core 104_{core} of a planar waveguide 104 formed between the top of the substrate 110 and the bottom of the substrate 110 in the schematic drawing.

Step 182-2 of method 182 is a forming step in which cavity 108 is formed in the substrate 110 having the planar waveguide 104, wherein a wall of the cavity 108 intersects the planar waveguide core 104_{core} of the planar waveguide 104. The perspective drawing labeled “Step 182-2” in FIG. 14 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing.

Step 182-3 of method 182 is a filling step in which all or a portion of the cavity 108 is filled with a two-photon polymerization precursor 164. The perspective drawing labeled “Step 182-3” in FIG. 14 shows cavity 108 in substrate 110 filled with two-photon polymerization precursor 164 in the schematic drawing.

Step 182-4 of method 182 is a forming step in which a reflector base 101 is formed in cavity 108 using two-photon polymerization of the two-photon polymerization precursor 164. The perspective drawing labeled “Step 182-4” in FIG. 14 shows cavity 108 formed in substrate 110 having a reflector base 101 formed using two-photon polymerization of the two-photon polymerization precursor 164 in the schematic drawing.

For clarity, the front wall of cavity 108 is not shown in the perspective drawings labeled “Step 182-4”, “Step 182-5”, “Step 182-6a”, “Step 182-7a”, and “Step 182-6b” in FIG. 14.

Step 182-5 of method 182 is a forming step in which a reflective layer 102 is formed on the reflector base 101. The perspective drawing labeled “Step 182-5” in FIG. 14 shows the reflective layer 102 formed on the reflector base 101 in cavity 108.

Embodiments of reflector structure 100 are formed with the completion of steps 182-5, although additional steps may be included in method 182 to provide optional features. Optional features may include, for example, reflector top 103 formed on the reflective layer 102, and one or more optional lens feature 122 formed in the optional reflector top 103 for embodiments formed using method 182.

Two methods of forming an optional reflector top 103 are disclosed. Firstly, steps 182-6a and 182-7a may follow steps 182-1 to 182-5 to provide for the formation of an optional reflector top 103 in reflector structure 100 wherein the optional reflector top 103 is formed using two-photon polymerization. Alternatively, step 182-6b may follow steps 182-1 to 182-5 to provide for the formation of an optional reflector top 103 in reflector structure 100 wherein the optional reflector top 103 is formed using a conformal fill layer.

Step 182-6a of method 182 is an optional filling step in which all or a portion of the remaining cavity 108 having reflector base 101 and reflective layer 102 is filled with a two-photon polymerization precursor 164. The perspective drawing labeled “Step 182-6a” in FIG. 14 shows the two-photon polymerization precursor 164 filling the remaining cavity 108.

Step 182-7a of method 182 is an optional forming step in which an optional reflector top 103 is formed in all or a portion of the remaining cavity 108 using two-photon polymerization of the two-photon polymerization precursor 164. In preferred embodiments, the optional reflector top 103 is configured having a second refractive index wherein the second refractive index is equal to, or approximately equal to, the first refractive index (of the planar waveguide core 104_{core}). One or more optional lens feature 122 may also be formed in step 182-7a. The perspective drawing labeled “Step 182-7a” in FIG. 14 shows cavity 108 having the optional reflector top 103 formed on the reflective layer 102 using two-photon polymerization of the two-photon polymerization precursor 164 in the schematic drawing. The drawing also shows optional lens feature 122 formed in the optional reflector top 103. Use of two-photon polymerization to form the optional reflector top 103 in the embodiment of the reflector structure 100 enables the formation of one or more optional lens feature 122 with the formation of the optional reflector top 103 that may not be achievable using other methods of forming the optional reflector top 103.

Alternatively, optional reflector top 103 may be formed using a conformal fill layer. Step 182-6b of method 182 is an optional forming step in which optional reflector top 103 is formed in cavity 108 using a conformal fill layer. In preferred embodiments, the optional reflector top 103 is configured having a second refractive index wherein the second refractive index is equal to, or approximately equal to, the first refractive index (of the planar waveguide core 104_{core}). The perspective drawing labeled “Step 182-6b” in FIG. 14 shows cavity 108 having the optional reflector top 103 formed on the reflective layer 102 using a conformal fill layer in the schematic drawing. Optional lens features may be incorporated into embodiments of reflector structure 100, although additional steps may be required. Additional steps may follow step 6a to enable the formation of optional lens structures 122, such as the optional lens feature 122 shown in FIG. 11, for example, and these optional lens features 122 may be formed on the optional reflector top 103 using two-photon polymerization.

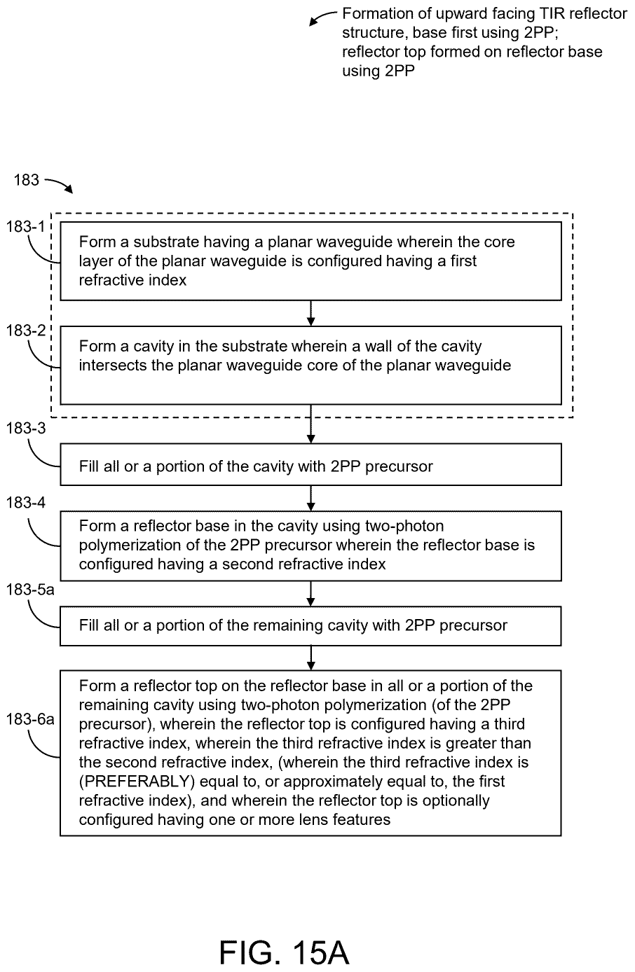

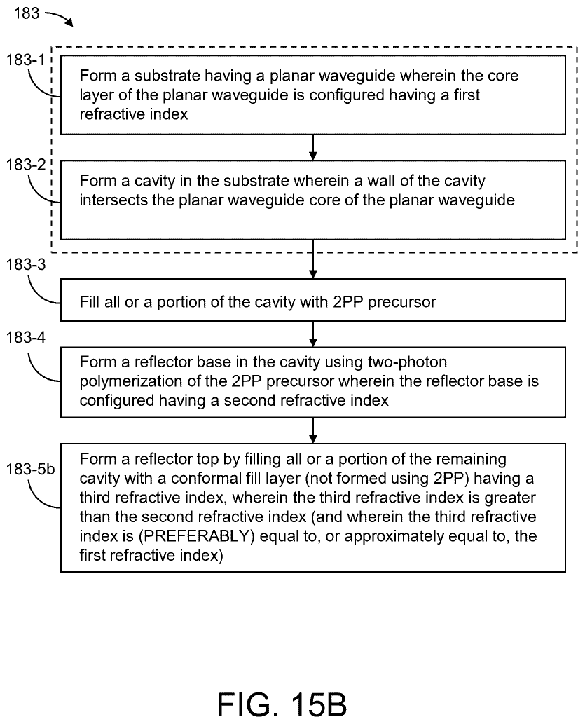

FIG. 15A shows a flowchart for a method 183 of forming embodiments of reflector structure 100 configured to provide an upward-facing TIR reflector structure that includes a reflector top 103 and a reflector base 101 wherein the reflector base 101 is firstly formed using two-photon polymerization and the reflector top 103 is subsequently formed on the reflector base 101 also using two-photon polymerization. TIR reflector structures 100, in embodiments, require differing refractive indices between the material in the reflector top 103 and the material in the reflector base 101. Embodiments of an upward-facing reflector structure 100 formed using method 183 comprise substrate 110 having cavity 108 that intersects planar waveguide core 104_{core} of planar waveguide 104, wherein the reflector structure 100 formed in cavity 108 further comprises reflector base 101 formed using two-photon polymerization, and reflector top 103 having a refractive index that is greater than the refractive index of the reflector base 101.

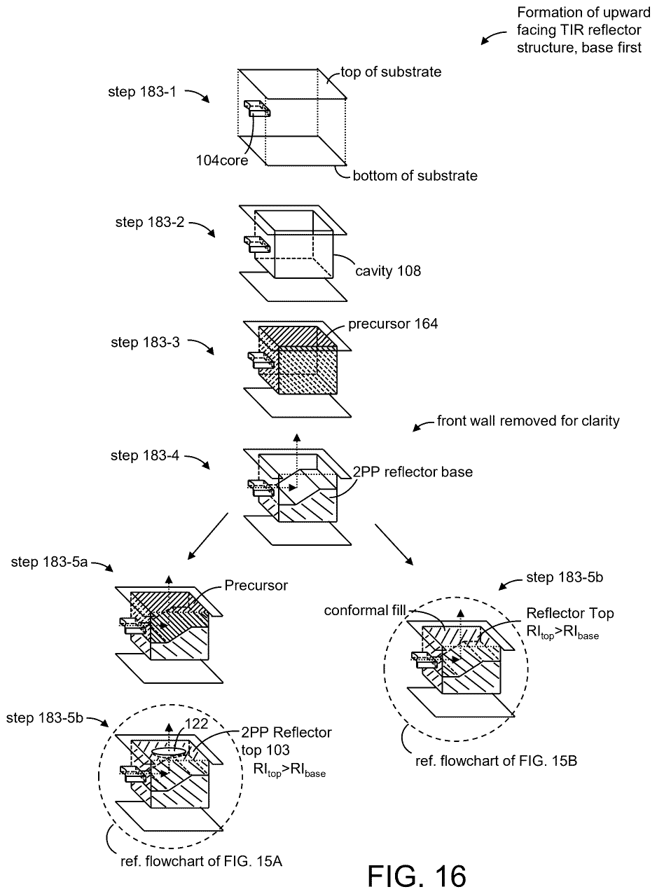

Steps in method 183 are described in conjunction with the perspective drawings shown in FIG. 16. The circled perspective drawings in FIG. 16 show embodiments of reflector structure 100.

Step 183-1 of method 183 is a forming step in which a substrate 110 is formed having planar waveguide 104, wherein the planar waveguide core 104_{core} of the planar waveguide 104 is configured having a first refractive index. The perspective drawing labeled “Step 183-1” in FIG. 16 shows the planar waveguide core 104_{core} of a planar waveguide 104 formed between the top of the substrate 110 and the bottom of the substrate 110 in the schematic drawing.

Step 183-2 of method 183 is a forming step in which cavity 108 is formed in the substrate 110 having the planar waveguide 104, wherein a wall of the cavity 108 intersects the planar waveguide core 104_{core} of the planar waveguide 104. The perspective drawing labeled “Step 183-2” in FIG. 16 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing.

Step 183-3 of method 183 is a filling step in which all or a portion of cavity 108 is filled with a two-photon polymerization precursor 164. The perspective drawing labeled “Step 183-3” in FIG. 16 shows cavity 108 in substrate 110 filled with two-photon polymerization precursor 164 in the schematic drawing.

Step 183-4 of method 183 is a forming step in which a reflector base 101 is formed in cavity 108 using two-photon polymerization of the two-photon polymerization precursor 164 wherein the reflector base 101 is formed having a second refractive index. The perspective drawing labeled “Step 183-4” in FIG. 16 shows cavity 108 formed in substrate 110 having a reflector base 101 formed using two-photon polymerization of the two-photon polymerization precursor 164 in the schematic drawing.

For clarity, the front wall of cavity 108 is not shown in the perspective drawings labeled “Step 183-4”, “Step 183-5a”, “Step 183-6a”, and “Step 183-5b” in FIG. 16.

Step 183-5a of method 183 is a filling step in which all or a portion of the remaining cavity 108 having reflector base 101 is filled with a two-photon polymerization precursor 164. The perspective drawing labeled “Step 183-5a” in FIG. 16 shows the two-photon polymerization precursor 164 filling the remaining cavity 108.

Step 183-6a of method 183 is an optional forming step in which reflector top 103 is formed in all or a portion of the remaining cavity 108 using two-photon polymerization of the two-photon polymerization precursor 164 wherein the reflector top 103 is configured having a third refractive index, wherein the third refractive index is greater than the second refractive index (of the reflector base 101), and wherein the reflector top is optionally configured having one or more lens feature 122. In preferred embodiments formed using method 183, the third refractive index is equal to, or approximately equal to, the first refractive index (of the planar waveguide core 104_{core}.) Matching, or approximate matching, of the refractive index of the reflector top 103 with the refractive index of the planar waveguide core 104_{core} of the planar waveguide 104 can reduce or minimize the divergence of optical signals propagating from the planar waveguide 104 to the reflector top 103 in the embodiments of the reflector structure 100 formed using method 183. The perspective drawing labeled “Step 183-6a” in FIG. 16 shows cavity 108 having reflector top 103 formed on reflector base 101 using two-photon polymerization of the two-photon polymerization precursor 164 in the schematic drawing. The drawing also shows optional lens feature 122 formed in the optional reflector top 103. Use of two-photon polymerization to form the optional reflector top 103 in the embodiment of the reflector structure 100 enables the formation of one or more optional lens feature 122 that may not be achievable using other methods of forming the optional reflector top 103.

Two methods of forming reflector top 103 are disclosed for embodiments of reflector structure 100 formed using method 183. Firstly, steps 183-5a and 183-6a may follow steps 183-1 to 183-4 to provide for the formation of reflector top 103 in reflector structure 100 wherein reflector top 103 is formed using two-photon polymerization. Alternatively, step 183-5b may follow steps 183-1 to 183-4 to provide for the formation of reflector top 103 in reflector structure 100 using a conformal fill layer.

Reflector top 103 may be formed using a conformal fill layer as shown in the flowchart for method 183 shown in FIG. 15B. Step 183-5b of method 183 is an alternative forming step to the filling and forming steps 183-5a and 183-6a, respectively, of the flowchart for method 183 shown in FIG. 15A. The reflector top 103 is formed in step 183-5b of method 183 in FIG. 15B using a conformal fill layer. Steps 183-1 to 183-4 in FIGS. 5A and 5B are identical.

The perspective drawing labeled “Step 183-5b” in FIG. 16 shows cavity 108 having the optional reflector top 103 formed on the reflective layer 102 using a conformal fill layer in the schematic drawing. Although optional lens features may be incorporated into embodiments of reflector structure 100, additional steps may be required. Additional steps may follow step 183-5a, for example, to enable the formation of optional lens structures 122, such as the optional lens feature 122 shown in FIG. 11, and these optional lens features 122 may be formed on the optional reflector top 103 using two-photon polymerization.

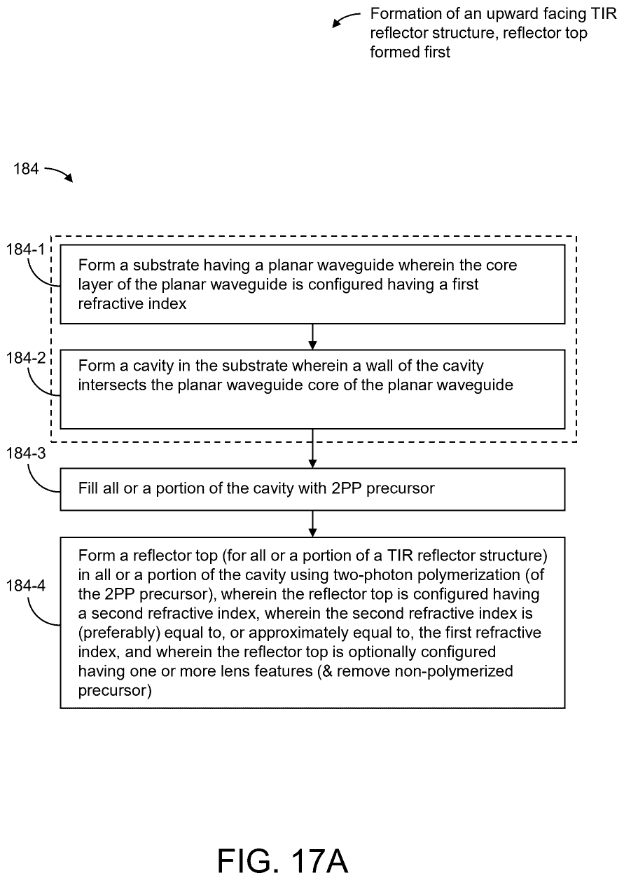

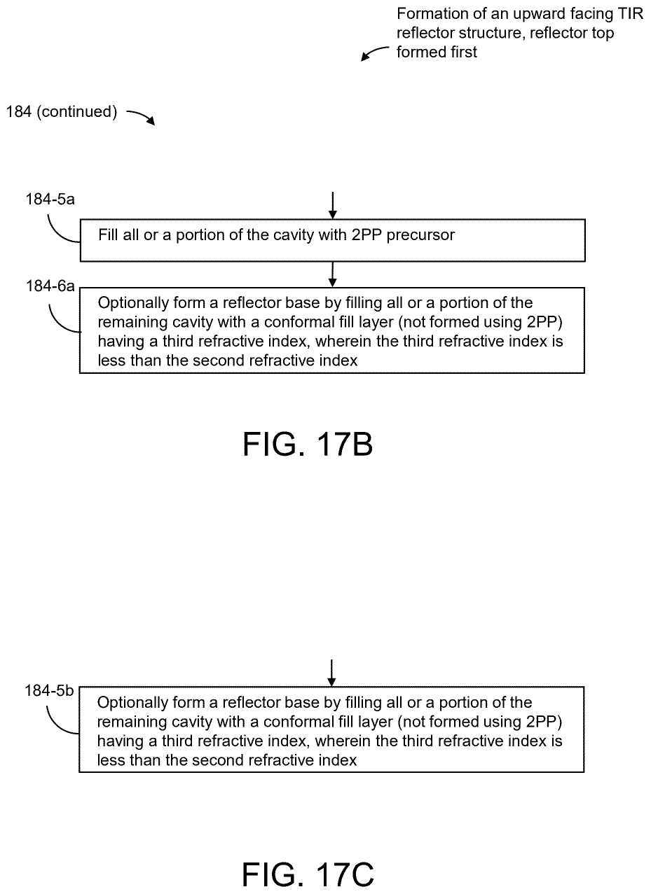

FIG. 17A shows a flowchart for a method 184 of forming embodiments of reflector structure 100 configured to provide an upward-facing TIR reflector structure that includes a reflector top 103 formed using two-photon polymerization. TIR reflector structures 100, in embodiments, require differing refractive indices between the material in the reflector top 103 and the material below the reflector top 103. Embodiments of an upward-facing reflector structure 100 formed using method 184 comprise reflector top 103, formed using two-photon polymerization, and substrate 110 having cavity 108 that intersects planar waveguide core 104_{core} of planar waveguide 104. In a first embodiment of reflector structure 100 formed using method 184 and shown in FIG. 17A, the reflector top 103 is formed having a refractive index that is greater than the refractive index of air or other gaseous substance used to occupy the portion of cavity 108 below the reflector top 103.

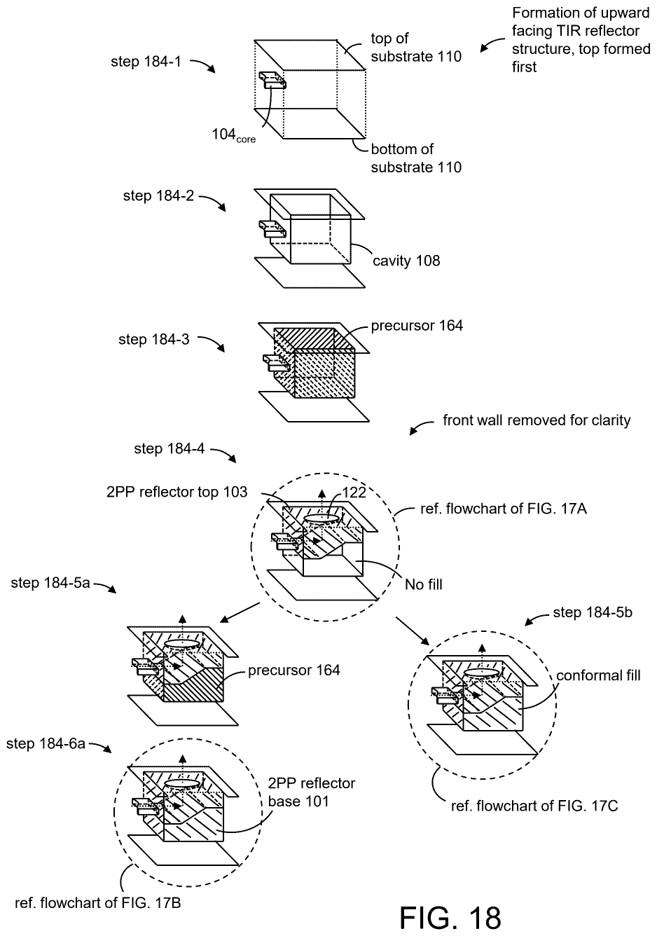

Steps in method 184 are described in conjunction with the perspective drawings shown in FIG. 18. The circled perspective drawings in FIG. 18 show embodiments of reflector structure 100.

Step 184-1 of method 184 is a forming step in which a substrate 110 is formed having planar waveguide 104, wherein the planar waveguide core 104_{core} of the planar waveguide 104 is configured having a first refractive index. The perspective drawing labeled “Step 184-1” in FIG. 18 shows the planar waveguide core 104_{core} of a planar waveguide 104 formed between the top of the substrate 110 and the bottom of the substrate 110 in the schematic drawing.

Step 184-2 of method 184 is a forming step in which cavity 108 is formed in substrate 110 having the planar waveguide 104, wherein a wall of the cavity 108 intersects the planar waveguide core 104_{core} of the planar waveguide 104. The perspective drawing labeled “Step 184-2” in FIG. 18 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing.

Step 184-3 of method 184 is a filling step in which all or a portion of cavity 108 is filled with a two-photon polymerization precursor 164. The perspective drawing labeled “Step 184-3” in FIG. 18 shows cavity 108 in substrate 110 filled with two-photon polymerization precursor 164 in the schematic drawing.

Step 184-4 of method 184 is a forming step in which a reflector top 103 is formed in all or a portion of cavity 108 using two-photon polymerization of the two-photon polymerization precursor 164, wherein the reflector top 103 is configured having a second refractive index. In some embodiments, the second refractive index is equal to, or approximately equal to, the refractive index of the planar waveguide core 104_{core} of the planar waveguide 104. In some embodiments, the second refractive index may not be equal to, or approximately equal to, the refractive index of the planar waveguide core 104. Having a second refractive index equal to, or approximately equal to the first refractive index, may reduce or minimize the divergence of optical signals exiting the planar waveguide core 104_{core} and propagating into the reflector top 103 in the embodiment. In some embodiments, the reflector top 103 may be optionally configured having one or more lens feature 122 formed using two-photon polymerization. The perspective drawing labeled “Step 184-4” in FIG. 18 shows cavity 108 in substrate 110 having a reflector top 103 formed using two-photon polymerization of the two-photon polymerization precursor 164 in the schematic drawing. An optional lens feature 122 is also shown.

For clarity, the front wall of cavity 108 is not shown in the drawings labeled “Step 184-4”, “Step 184-5a”, “Step 184-6a”, and “Step 184-5b” of FIG. 18.

Embodiments of reflector structure 100 are formed with the completion of steps 184-4, although additional steps may be included in method 184 to provide optional features. Optional features may include, for example, reflector base 101 formed below the reflector top 103.

Two methods for forming an optional reflector base 101 in method 184 are disclosed. Firstly, steps 184-5a and 184-6a may follow steps 184-1 to 184-4 to provide for the formation of an optional reflector base 101 in reflector structure 100 using two-photon polymerization. Alternatively, step 184-5b may follow steps 184-1 to 184-4 to provide for the formation of an optional reflector top 103 in reflector structure 100 using a conformal fill layer.

FIG. 17B shows a continuation of the flowchart of FIG. 17A that includes steps for the formation of an optional reflector base to the method 184 of FIG. 17A. Method 184 of FIG. 17A describes steps in a method of forming embodiments of reflector structure 100 configured to provide an upward-facing TIR reflector structure that includes a reflector top 103 formed using two-photon polymerization. The additional steps provided in the flowchart of FIG. 17B enable formation of an optional reflector base 101 to the reflector structure 100 wherein the optional reflector base 101 is also formed using two-photon polymerization.

Step 184-5a of method 184 is an optional filling step in which all or a portion of the remaining cavity 108 having reflector top 103 is filled with a two-photon polymerization precursor 164. The perspective drawing labeled “Step 184-5a” in FIG. 18 shows the two-photon polymerization precursor 164 filling the remaining cavity 108.

Step 184-6a of method 184 is an optional forming step in which an optional reflector base 101 is formed in all or a portion of the remaining cavity 108 using two-photon polymerization of the two-photon polymerization precursor 164. In preferred embodiments, the optional reflector base 101 is configured having a third refractive index wherein the third refractive index less than the second refractive index (of the reflector top 103). The perspective drawing labeled “Step 184-6a” in FIG. 18 shows cavity 108 having optional reflector base 101 formed using two-photon polymerization of the two-photon polymerization precursor 164 in the schematic drawing.

Alternatively, optional reflector base 101 may be formed using a conformal fill layer.

FIG. 17C shows a continuation of the flowchart of FIG. 17A that includes steps for the formation of an optional reflector base to method 184 of FIG. 17A. Method 184 of FIG. 17A describes steps in a method of forming embodiments of reflector structure 100 configured to provide an upward-facing TIR reflector structure that includes a reflector top 103 formed using two-photon polymerization. The additional steps provided in the flowchart of FIG. 17C enable formation of an optional reflector base 101 to the reflector structure 100 wherein the optional reflector base 101 is formed using a conformal fill layer below the reflector top 103.

Step 184-5b of method 184 is an optional forming step in which optional reflector base 101 is formed in cavity 108 using a conformal fill layer. In preferred embodiments, the optional reflector base 101 is configured having a third refractive index wherein the third refractive index is less than the second refractive index (of the reflector top 103). The perspective drawing labeled “Step 184-5b” in FIG. 18 shows optional reflector base 101 formed using a conformal fill layer below reflector top 103 in cavity 108 in the schematic drawing.

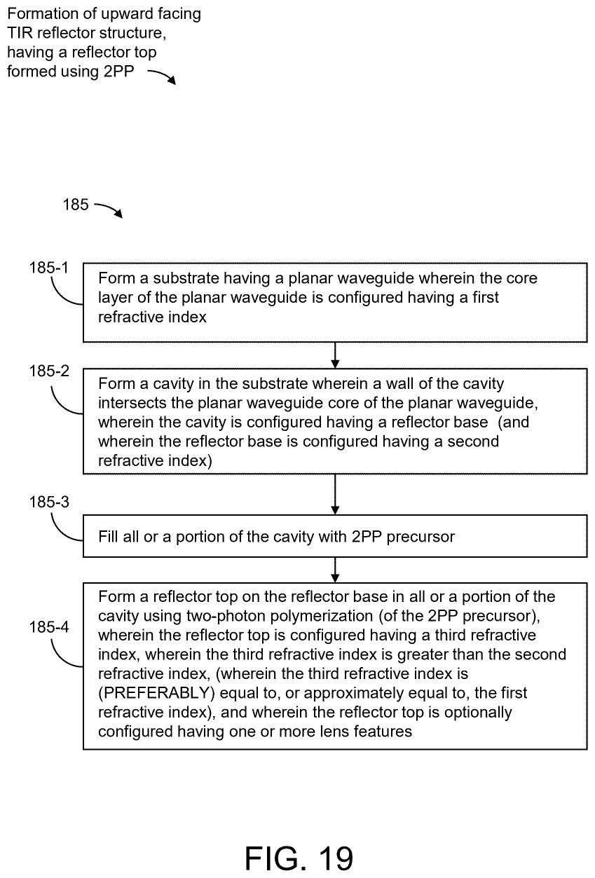

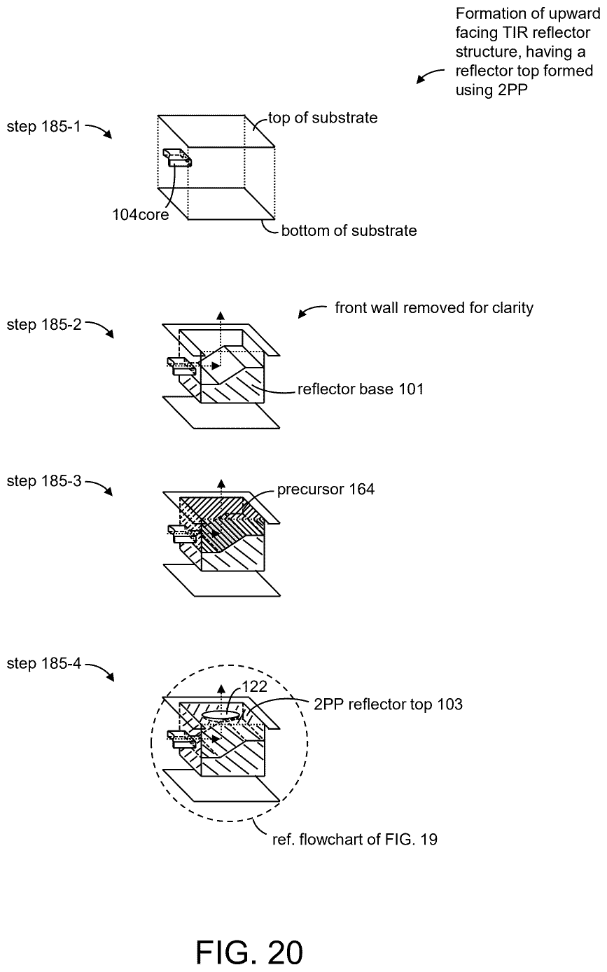

FIG. 19 shows a flowchart for a method 185 of forming embodiments of reflector structure 100 configured to provide an upward-facing TIR reflector structure that includes a reflector top 103 formed using two-photon polymerization wherein the reflector top 103 is formed in a cavity 108 having a preformed reflector base 101. The reflector base 101, in embodiments of reflector structure 100 formed using method 185, may be formed for example, using a patterned mask layer coupled with an etching process wherein an edge of the patterned mask layer gradually recedes to expose the underlying layer within which a contoured reflector base is formed. Other methods of forming a contoured reflector base 101 may also be used to form embodiments using method 185.

TIR reflector structures 100, in embodiments, require differing refractive indices between the material in the reflector top 103 and the material underlying the reflector top 103. Embodiments of an upward-facing reflector structure 100 formed using method 185 comprise reflector top 103, formed using two-photon polymerization, and substrate 110 having cavity 108 that intersects planar waveguide core 104_{core} of planar waveguide 104, wherein the cavity 108 is formed having a reflector base 101. In the embodiment of reflector structure 100 formed using method 185 and illustrated in the perspective drawing in FIG. 20, the reflector top 103 is formed having a refractive index that is greater than the refractive index of the preformed reflector base 101 in cavity 108.

Steps in method 185 are described in conjunction with the perspective drawings shown in FIG. 20. The circled perspective drawing in FIG. 20 shows an embodiment of reflector structure 100.

Step 185-1 of method 185 is a forming step in which a substrate 110 is formed having planar waveguide 104, wherein the planar waveguide core 104_{core} of the planar waveguide 104 is configured having a first refractive index. The perspective drawing labeled “Step 185-1” in FIG. 20 shows the planar waveguide core 104_{core} of a planar waveguide 104 formed between the top of the substrate 110 and the bottom of the substrate 110 in the schematic drawing.

Step 185-2 of method 185 is a forming step in which cavity 108 is formed in substrate 110 having the planar waveguide 104, wherein a wall of the cavity 108 intersects the planar waveguide core 104_{core} of the planar waveguide 104, and wherein the cavity 108 is configured having a reflector base 101. The perspective drawing labeled “Step 185-2” in FIG. 20 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing, and wherein the cavity 108 is configured having a reflector base 101.

For clarity, the front wall of cavity 108 is not shown in the drawings labeled “Step 185-2”, “Step 185-3”, and “Step 185-4” of FIG. 20.

Step 185-3 of method 185 is a filling step in which all or a portion of cavity 108 is filled with a two-photon polymerization precursor 164. The perspective drawing labeled “Step 185-3” in FIG. 20 shows cavity 108 in substrate 110 filled with two-photon polymerization precursor 164 in the schematic drawing.

Step 185-4 of method 185 is a forming step in which a reflector top 103 is formed in all or a portion of cavity 108 using two-photon polymerization of the two-photon polymerization precursor 164, wherein the reflector top 103 is configured having a second refractive index. In some embodiments, the second refractive index is equal to, or approximately equal to, the refractive index of the planar waveguide core 104_{core} of the planar waveguide 104. In some embodiments, the second refractive index may not be equal to, or approximately equal to, the refractive index of the planar waveguide core 104. Having a second refractive index equal to, or approximately equal to the first refractive index, may reduce or minimize the divergence of optical signals exiting the planar waveguide core 104_{core} and propagating into the reflector top 103 in the embodiment. In some embodiments, the reflector top 103 may be optionally configured having one or more lens feature 122 formed using two-photon polymerization. The perspective drawing labeled “Step 185-4” in FIG. 20 shows cavity 108 in substrate 110 having a reflector top 103 formed using two-photon polymerization of the two-photon polymerization precursor 164 in the schematic drawing. An optional lens feature 122 is also shown.

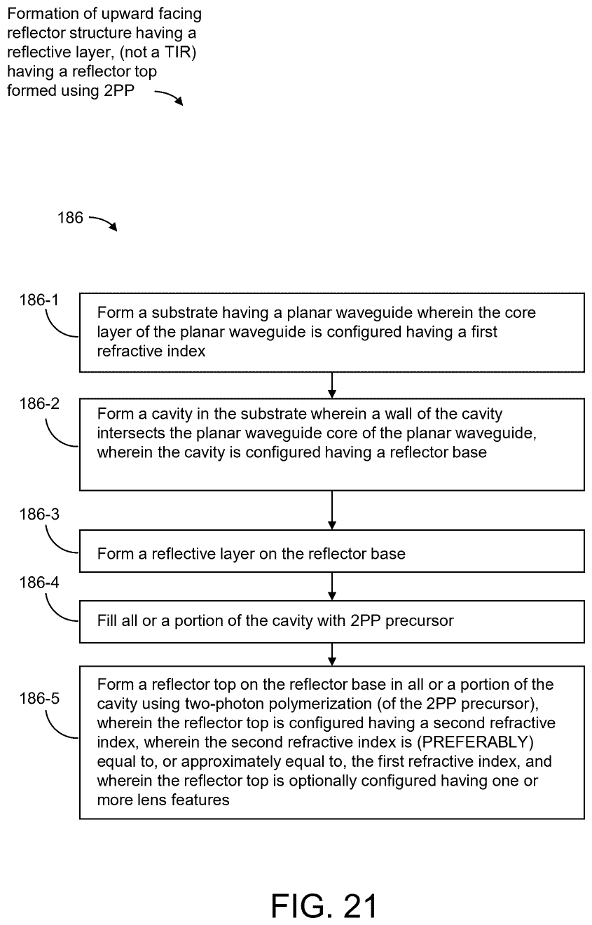

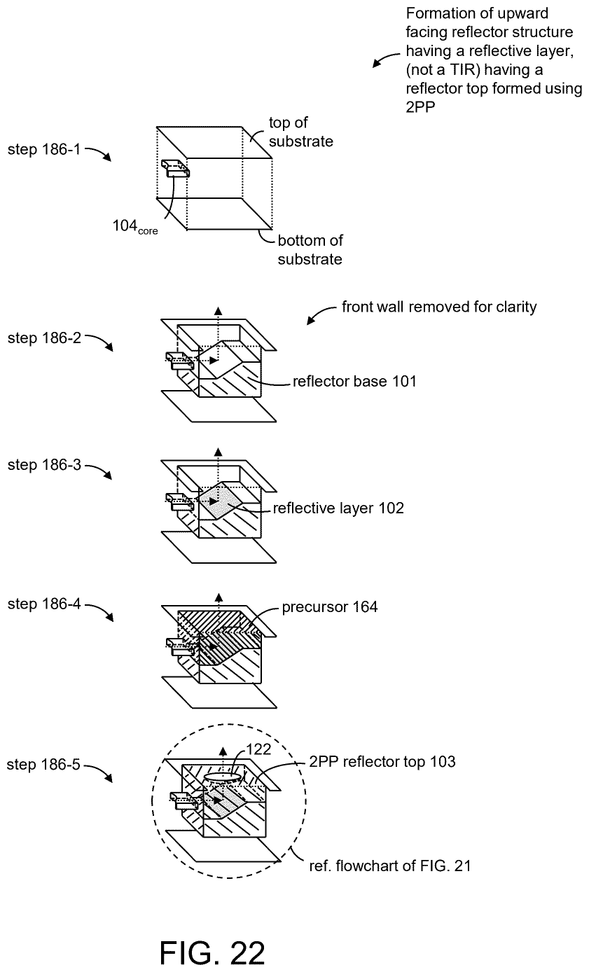

FIG. 21 shows a flowchart for a method 186 of forming embodiments of reflector structure 100 configured to provide an upward-facing TIR reflector structure that includes a reflector top 103 formed using two-photon polymerization wherein the reflector top 103 is formed in a cavity 108 having a reflective layer 102 on a preformed reflector base 101. The reflector base 101, in embodiments of reflector structure 100 formed using method 186, may be formed for example, using a patterned mask layer coupled with an etching process wherein an edge of the patterned mask layer gradually recedes to expose the underlying layer within which a contoured reflector base is formed. Other methods of forming a contoured surface in reflector base 101 may also be used to form embodiments using method 186. Reflective layer 102 may be formed, for example, using physical vapor deposition, metal evaporation, and other techniques using in semiconductor fabrication to form a reflective layer.

Embodiments of an upward-facing reflector structure 100 formed using method 186 comprise substrate 110 having cavity 108 that intersects planar waveguide core 104_{core} of planar waveguide 104, a reflector base 101 preformed in cavity 108 wherein the cavity 108 is formed having a reflector base 101, a reflective layer 102 formed on the reflector base 101, and a reflector top 103 formed on the reflective layer 102 wherein the reflector top 103 is formed using two-photon polymerization.

FIG. 22 shows perspective drawings that illustrate steps in the formation of an embodiment of reflector structure 100 formed using method 186. In the embodiment, reflector top 103 is preferably formed having a refractive index that is equal to, or approximately equal to, the refractive index of waveguide core 104_{core}.

Steps in method 186 are described in conjunction with the perspective drawings shown in FIG. 22. The circled perspective drawing in FIG. 22 shows an embodiment of reflector structure 100.

Step 186-1 of method 186 is a forming step in which a substrate 110 is formed having planar waveguide 104, wherein the planar waveguide core 104_{core} of the planar waveguide 104 is configured having a first refractive index. The perspective drawing labeled “Step 186-1” in FIG. 22 shows the planar waveguide core 104_{core} of a planar waveguide 104 formed between the top of the substrate 110 and the bottom of the substrate 110 in the schematic drawing.

Step 186-2 of method 186 is a forming step in which cavity 108 is formed in substrate 110 having the planar waveguide 104, wherein a wall of the cavity 108 intersects the planar waveguide core 104_{core} of the planar waveguide 104, and wherein the cavity 108 is configured having reflector base 101. The perspective drawing labeled “Step 186-2” in FIG. 22 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing, and wherein the cavity 108 is configured having a reflector base 101.

For clarity, the front wall of cavity 108 is not shown in the drawings labeled “Step 186-2”, “Step 186-3”, “Step 186-4”, and “Step 186-5” of FIG. 22.

Step 186-3 of method 186 is a forming step in which a reflective layer 102 is formed on the reflector base 101. The perspective drawing labeled “Step 186-3” in FIG. 22 shows the reflective layer 102 formed on reflector base 101 in cavity 108.

Step 186-4 of method 186 is a filling step in which all or a portion of cavity 108 is filled with a two-photon polymerization precursor 164. The perspective drawing labeled “Step 186-4” in FIG. 22 shows the portion of the cavity 108 above the reflector base 101 in substrate 110 filled with two-photon polymerization precursor 164 in the schematic drawing.

Step 186-5 of method 186 is a forming step in which a reflector top 103 is formed in all or a portion of cavity 108 using two-photon polymerization of the two-photon polymerization precursor 164, wherein the reflector top 103 is configured having a second refractive index. In some embodiments, the second refractive index is equal to, or approximately equal to, the refractive index of the planar waveguide core 104_{core} of the planar waveguide 104. In some embodiments, the second refractive index may not be equal to, or approximately equal to, the refractive index of the planar waveguide core 104_{core}. Having a second refractive index equal to, or approximately equal to the first refractive index, may reduce or minimize the divergence of optical signals exiting the planar waveguide core 104_{core} and propagating into the reflector top 103 in the embodiment. In some embodiments, the reflector top 103 may be optionally configured having one or more lens feature 122 formed using two-photon polymerization. The perspective drawing labeled “Step 186-5” in FIG. 22 shows cavity 108 in substrate 110 having a reflector top 103 formed using two-photon polymerization of the two-photon polymerization precursor 164 in the schematic drawing. An optional lens feature 122 is also shown.

### Methods of Forming Downward-Facing Reflector Structures

Methods 182-186, disclosed herein, describe steps in the formation of embodiments of reflector structure 100 having upward-facing contoured reflector surfaces that enable the redirection of optical signals propagating from planar waveguide 104 to the upper portion of cavity 108. In methods 182-186, one or more of reflector base 101 and reflector top are formed using two-photon polymerization. In the methods 192-194 disclosed in the following paragraphs, embodiments of reflector structure 100, also formed at least in part using two-photon polymerization, are formed having downward-facing contoured reflector surfaces that enable the redirection of optical signals propagating from planar waveguide 104 to a lower portion of cavity 108.

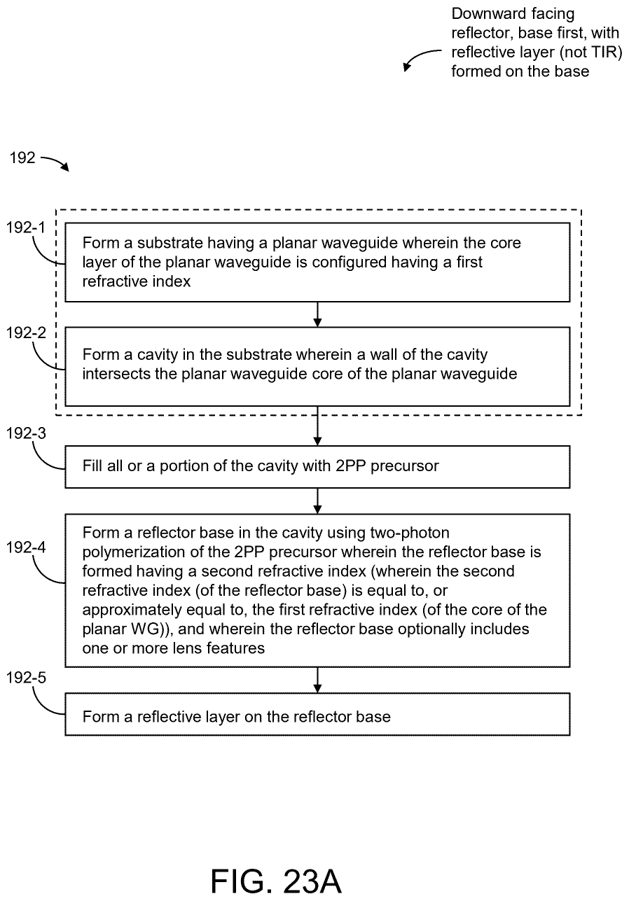

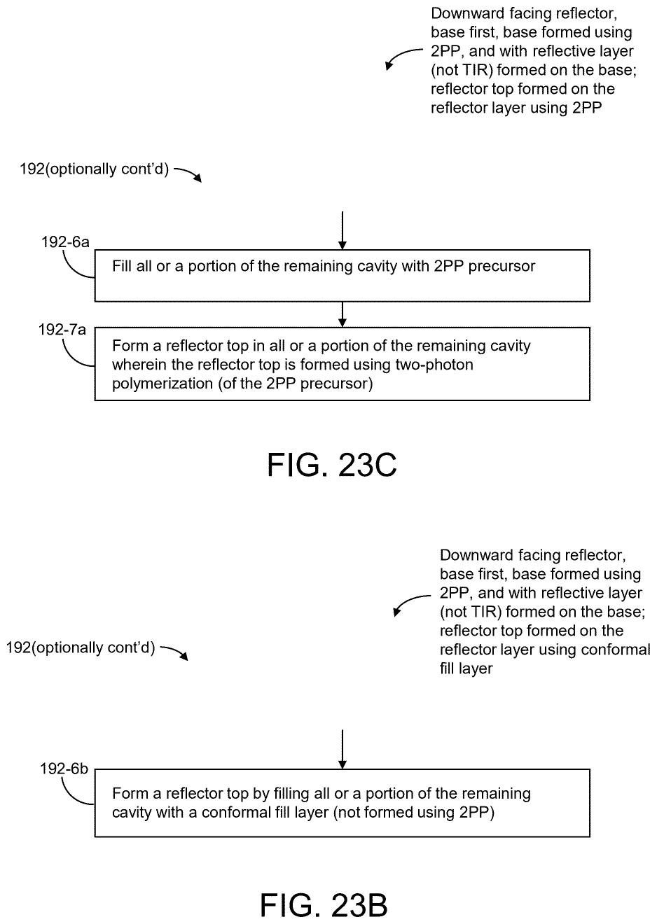

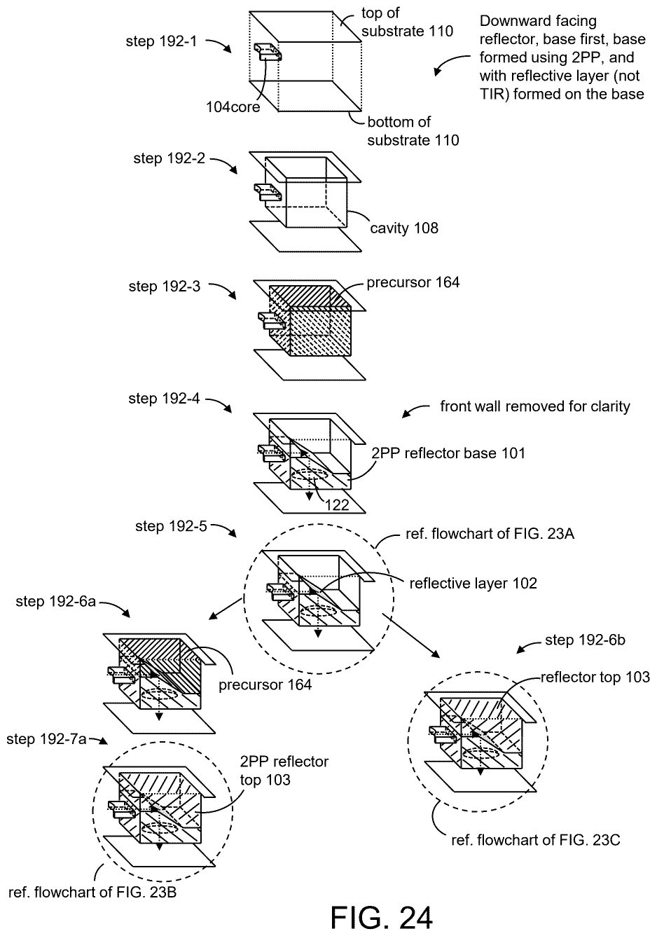

FIG. 23A shows a flowchart for a method 192 of forming embodiments of reflector structure 100 configured to provide a downward-facing reflector structure that includes reflective layer 102 formed on reflector base 101 wherein the reflector base 101 is formed using two-photon polymerization. Embodiments of a downward-facing reflector structure 100 formed using method 192 comprise substrate 110 having cavity 108 that intersects planar waveguide core 104_{core} of planar waveguide 104, reflector base 101 formed using two-photon polymerization, and reflective layer 102 formed on the reflector base 101. In embodiments formed using method 192, reflective layer 102 is formed on contoured surface of reflector base 101 to form a downward-facing contoured reflective surface 112 that reflects optical signals 170 propagating from the planar waveguide 104 into the reflector base 101.

FIG. 23B shows optional steps 192-6a and 192-7a for the flowchart of method 192, that when combined with steps 192-1 to 192-5, provide steps in the formation of an embodiment having the reflector structure 100 of FIG. 23A with the addition of an optional reflector top 103 formed on the reflective layer 102 wherein the optional reflector top 103 is also formed using two-photon polymerization.

FIG. 23C shows optional step 192-6b for the flowchart of method 192, that when combined with steps 192-1 to 192-5, provide steps in the formation of an embodiment having the reflector structure 100 of FIG. 23A with the addition of an optional reflector top 103 formed on the reflective layer 102 wherein the optional reflector top 103 is formed with a conformal fill layer.

Steps in the method 192 of FIGS. 23A-23C are described in conjunction with the perspective drawings shown in FIG. 24. The circled perspective drawings in FIG. 24 show embodiments of reflector structure 100.

Step 192-1 of method 192 is a forming step in which a substrate 110 is formed having planar waveguide 104, wherein the planar waveguide core 104_{core} of the planar waveguide 104 is configured having a first refractive index. The perspective drawing labeled “Step 192-1” in FIG. 24 shows the planar waveguide core 104_{core} of a planar waveguide 104 formed between the top of the substrate 110 and the bottom of the substrate 110 in the schematic drawing.

Step 192-2 of method 192 is a forming step in which cavity 108 is formed in the substrate 110 having the planar waveguide 104, wherein a wall of the cavity 108 intersects the planar waveguide core 104_{core} of the planar waveguide 104. The perspective drawing labeled “Step 192-2” in FIG. 24 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing.

Step 192-3 of method 192 is a filling step in which all or a portion of the cavity 108 is filled with a two-photon polymerization precursor 164. The perspective drawing labeled “Step 192-3” in FIG. 24 shows cavity 108 in substrate 110 filled with two-photon polymerization precursor 164 in the schematic drawing.

Step 192-4 of method 192 is a forming step in which a reflector base 101 is formed in cavity 108 using two-photon polymerization of the two-photon polymerization precursor 164. The perspective drawing labeled “Step 192-4” in FIG. 24 shows cavity 108 formed in substrate 110 having a reflector base 101 formed using two-photon polymerization of the two-photon polymerization precursor 164 in the schematic drawing. One or more optional lens feature 122 may also be formed in the reflector base in step 192-4 using two-photon polymerization. The perspective drawing labeled “step 192-4” in FIG. 24 also shows optional lens feature 122 formed in the reflector base 101. Use of two-photon polymerization to form the reflector base 101 in embodiments of the reflector structure 100 formed using method 192 enables the formation of one or more optional lens feature 122 with the formation of the reflector base 101 that may not be achievable using other methods of forming the reflector base 101.

For clarity, the front wall of cavity 108 is not shown in the perspective drawings labeled “Step 192-4”, “Step 192-5”, “Step 192-6a”, “Step 192-7a”, and “Step 192-6b” in FIG. 24.

Step 192-5 of method 192 is a forming step in which a reflective layer 102 is formed on the reflector base 101. The perspective drawing labeled “Step 192-5” in FIG. 24 shows the reflective layer 102 formed on the reflector base 101 in cavity 108. Reflective layer 102 may include a passivation layer such as a layer of silicon nitride or silicon oxide, to prevent oxidation, corrosion, and other deleterious effects that may result from exposure to ambient, from altering the properties of the reflective layer 102. Passivation layers may be included in other embodiments disclosed herein that include reflective layer 102.

Embodiments of reflector structure 100 are formed with the completion of steps 192-5, although additional steps may be included in the method 192 to provide optional features. Optional features may include, for example, reflector top 103 formed on the reflective layer 102, among other features.

Two methods of forming an optional reflector top 103 in method 192 are disclosed. Firstly, steps 192-6a and 192-7a may follow steps 192-1 to 192-5 to provide for the formation of an optional reflector top 103 in reflector structure 100 wherein the optional reflector top 103 is formed using two-photon polymerization. Alternatively, step 192-6b may follow steps 192-1 to 192-5 to provide for the formation of an optional reflector top 103 in reflector structure 100 using a conformal fill layer.

Step 192-6a of method 192 is an optional filling step in which all or a portion of the remaining cavity 108 having reflector base 101 and reflective layer 102 is filled with a two-photon polymerization precursor 164. The perspective drawing labeled “Step 192-6a” in FIG. 24 shows the two-photon polymerization precursor 164 filling the remaining cavity 108.

Step 192-7a of method 192 is an optional forming step in which an optional reflector top 103 is formed in all or a portion of the remaining cavity 108 using two-photon polymerization of the two-photon polymerization precursor 164. In preferred embodiments, the optional reflector top 103 is configured having a second refractive index wherein the second refractive index is equal to, or approximately equal to, the first refractive index (of the planar waveguide core 104_{core}). The perspective drawing labeled “Step 192-7a” in FIG. 24 shows cavity 108 having the optional reflector top 103 formed on the reflective layer 102 using two-photon polymerization of the two-photon polymerization precursor 164 in the schematic drawing.

Alternatively, optional reflector top 103 may be formed using a conformal fill layer. Step 192-6b of method 192 is an optional forming step in which optional reflector top 103 is formed in cavity 108 using a conformal fill layer. In preferred embodiments, the optional reflector top 103 is configured having a second refractive index wherein the second refractive index is equal to, or approximately equal to, the first refractive index (of the planar waveguide core 104_{core}). The perspective drawing labeled “Step 192-6b” in FIG. 24 shows cavity 108 having the optional reflector top 103 formed on the reflective layer 102 using a conformal fill layer in the schematic drawing. Optional lens features may be incorporated into embodiments of reflector structure 100, although additional steps may be required. Additional steps may follow step 6a to enable the formation of optional lens structures 122, such as the optional lens feature 122 shown in FIG. 11, for example, and these optional lens features 122 may be formed on the optional reflector top 103 using two-photon polymerization.

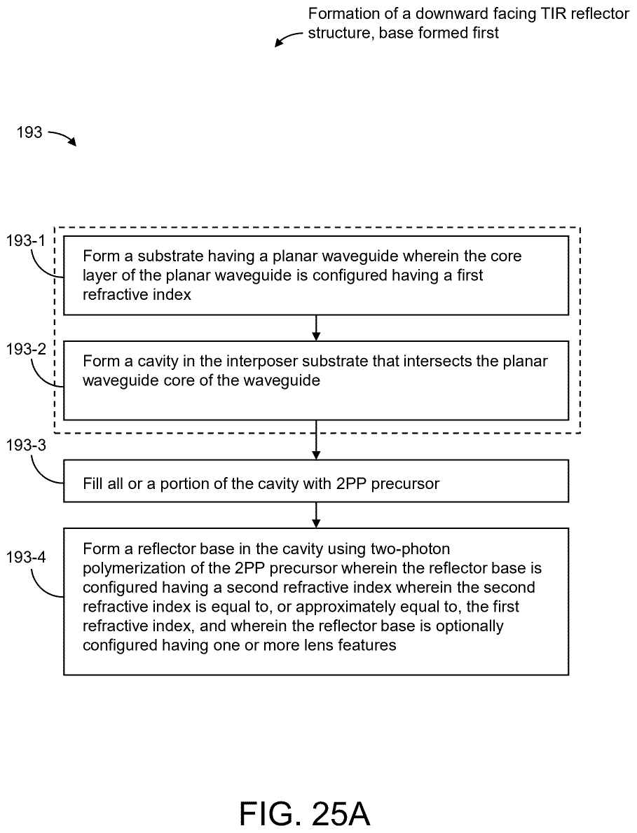

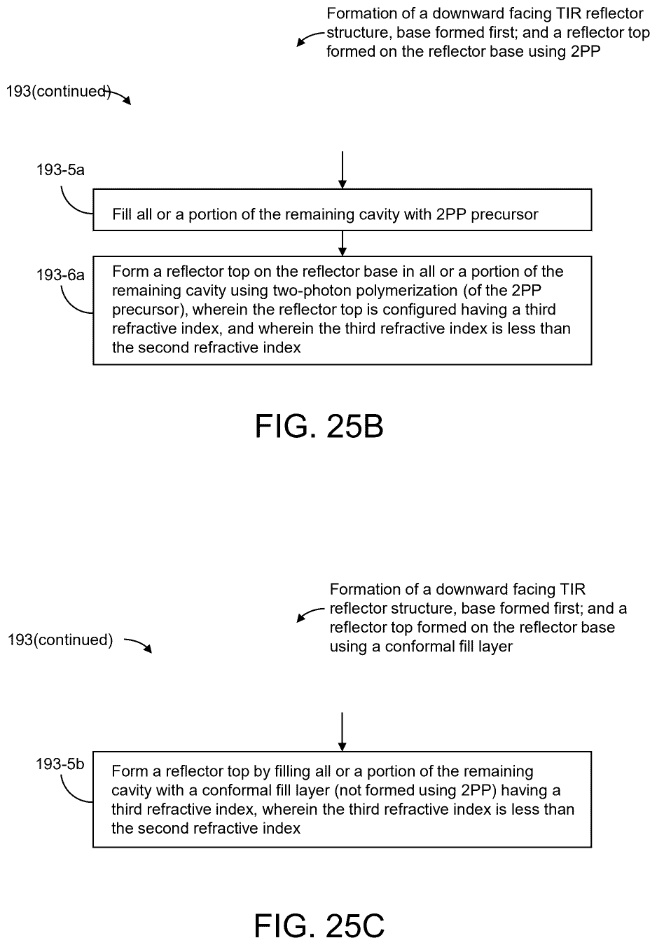

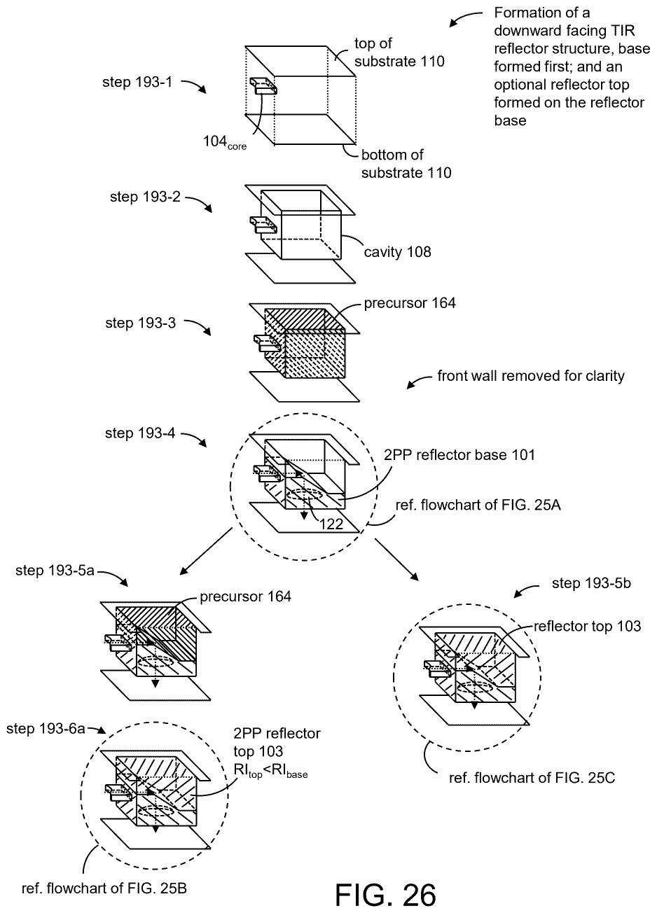

FIG. 25A shows a flowchart for a method 193 of forming embodiments of reflector structure 100 configured to provide a downward-facing TIR reflector structure that includes reflector base 101 formed using two-photon polymerization. TIR reflector structures, in general, and including those formed using method 193, require differing refractive indices between the material in the reflector base 101 and the material above the reflector base 101. Embodiments of a downward-facing reflector structure 100 formed using method 193 comprise reflector base 101 formed using two-photon polymerization, and an open portion of the cavity 108 above the reflector base 101 wherein the refractive index of the reflector base 101 is greater than the refractive index of air or other gaseous substance occupying the space above the reflector base 101. In these embodiments, the reflector base 101 is formed in cavity 108 on substrate 110 wherein the cavity 108 intersects planar waveguide core 104_{core} of planar waveguide 104.

FIG. 25B shows optional steps 193-5a and 193-6a for the flowchart of method 193, that when combined with steps 193-1 to 193-4 of method 193, provide steps in the formation of an embodiment having the embodiment of reflector structure 100 of FIG. 25A with the addition of an optional reflector top 103 formed on the reflector base 101 wherein the optional reflector top 103 is also formed using two-photon polymerization.

FIG. 25C shows optional step 193-5b for the flowchart of method 193, that when combined with steps 193-1 to 193-4, provide steps in the formation of an embodiment having the embodiment of reflector structure 100 of FIG. 25A with the addition of an optional reflector top 103 formed on the reflector base 101 wherein the optional reflector top 103 is formed using a conformal fill layer.

Steps in method 193 are described in conjunction with the perspective drawings shown in FIG. 26. The circled perspective drawings in FIG. 26 show embodiments of reflector structure 100.

Step 193-1 of method 193 is a forming step in which a substrate 110 is formed having planar waveguide 104, wherein the planar waveguide core 104_{core} of the planar waveguide 104 is configured having a first refractive index. The perspective drawing labeled “Step 193-1” in FIG. 26 shows the planar waveguide core 104_{core} of a planar waveguide 104 formed between the top of the substrate 110 and the bottom of the substrate 110 in the schematic drawing.

Step 193-2 of method 193 is a forming step in which cavity 108 is formed in the substrate 110 having the planar waveguide 104, wherein a wall of the cavity 108 intersects the planar waveguide core 104_{core} of the planar waveguide 104. The perspective drawing labeled “Step 193-2” in FIG. 26 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing.

Step 193-3 of method 193 is a filling step in which all or a portion of cavity 108 is filled with a two-photon polymerization precursor 164. The perspective drawing labeled “Step 193-3” in FIG. 26 shows cavity 108 in substrate 110 filled with two-photon polymerization precursor 164 in the schematic drawing.

Step 193-4 of method 193 is a forming step in which a reflector base 101 is formed in cavity 108 using two-photon polymerization of the two-photon polymerization precursor 164 wherein the reflector base 101 is formed having a second refractive index. The perspective drawing labeled “Step 193-4” in FIG. 26 shows cavity 108 formed in substrate 110 having a reflector base 101 formed using two-photon polymerization of the two-photon polymerization precursor 164 in the schematic drawing. In preferred embodiments, reflector base 101 is formed in step 193-4 having a second refractive index wherein the second refractive is configured to be equal to, or approximately equal to, the first refractive index (of the planar waveguide core 104_{core} of the planar waveguide 104). Matching, or approximate matching, of the refractive index of the reflector top 103 with the refractive index of the planar waveguide core 104_{core} of the planar waveguide 104 can reduce or minimize the divergence of optical signals propagating from the end facet 104_{facet} of planar waveguide 104 to the reflector top 103 in the embodiments of the reflector structure 100 formed using method 193. One or more optional lens feature 122 may also be formed in the reflector base in step 193-4 using two-photon polymerization. The perspective drawing labeled “step 193-4” in FIG. 26 also shows optional lens feature 122 formed in the reflector base 101. Use of two-photon polymerization to form the reflector base 101 in embodiments of the reflector structure 100 formed using method 193 enables the formation of one or more optional lens feature 122 with the formation of the reflector base 101 that may not be achievable using other methods of forming the reflector base 101.

For clarity, the front wall of cavity 108 is not shown in the perspective drawings labeled “Step 193-4”, “Step 193-5a”, “Step 193-6a”, and “Step 193-5b” in FIG. 26.

Embodiments of reflector structure 100 are formed with the completion of steps 193-4 of method 193, although additional steps may be included in method 193 to provide optional features. Optional features may include, for example, reflector top 103 formed on the reflector base 101, among other features.

Two methods of forming an optional reflector top 103 in method 193 are disclosed. Firstly, steps 193-5a and 193-6a may follow steps 193-1 to 193-4 to provide for the formation of an optional reflector top 103 in reflector structure 100 wherein the optional reflector top 103 is formed using two-photon polymerization. Steps 193-5a and 193-6a are shown in the flowchart in FIG. 25B. Alternatively, step 193-5b may follow steps 193-1 to 193-4 to provide for the formation of an optional reflector top 103 in reflector structure 100 using a conformal fill layer. Step 193-5b is shown in the flowchart in FIG. 25C.

Step 193-5a of method 193 is a filling step in which all or a portion of the remaining cavity 108 having reflector base 101 is filled with a two-photon polymerization precursor 164. The perspective drawing labeled “Step 193-5a” in FIG. 26 shows the two-photon polymerization precursor 164 filling the remainder of cavity 108 not occupied by the reflector base 101.

Step 193-6a of method 193 is an optional forming step in which reflector top 103 is formed in all or a portion of the remaining cavity 108 using two-photon polymerization of the two-photon polymerization precursor 164, wherein the reflector top 103 is configured having a third refractive index, and wherein the third refractive index is less than the second refractive index (of the reflector base 101). The perspective drawing labeled “Step 193-6a” in FIG. 26 shows cavity 108 having reflector top 103 formed on reflector base 101 using two-photon polymerization of the two-photon polymerization precursor 164 in the schematic drawing.

FIG. 25C shows an alternative flowchart for providing an optional reflector top 103 to embodiments of reflector structure 100 formed using method 193. In the flowchart in FIG. 25C, optional reflector top 103 is formed using a conformal fill layer wherein the reflector top is configured having a third refractive index, and wherein the third refractive index is lower than the second refractive index (of the reflector base 101). Step 193-5b of method 193 of FIG. 25C is an alternative forming step for the filling and forming steps 193-5a and 193-6a, respectively, of the flowchart for method 193 shown in FIG. 25B.

The perspective drawing labeled “Step 193-5b” in FIG. 26 shows cavity 108 having the optional reflector top 103 formed on the reflector base 101 using a conformal fill layer in the schematic drawing.

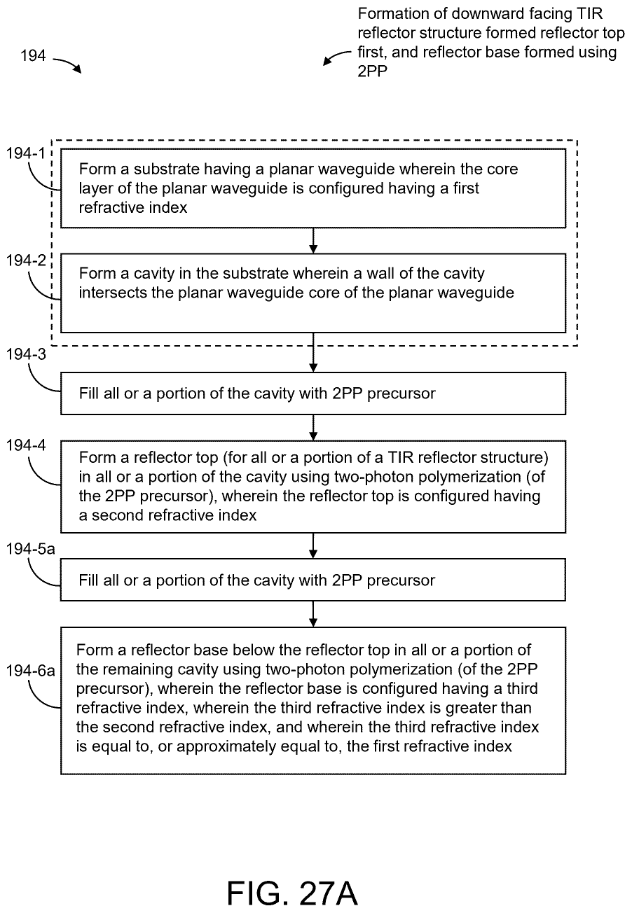

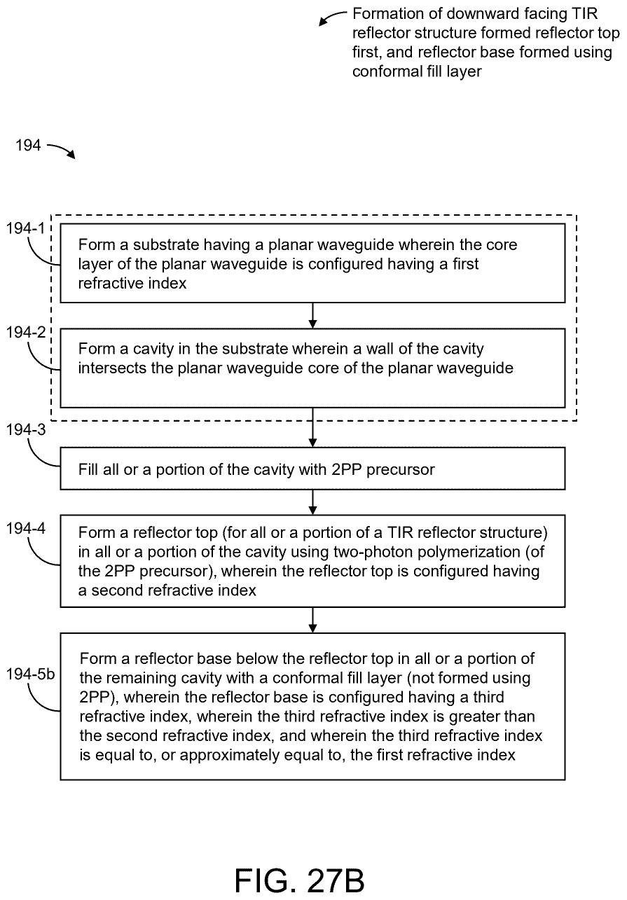

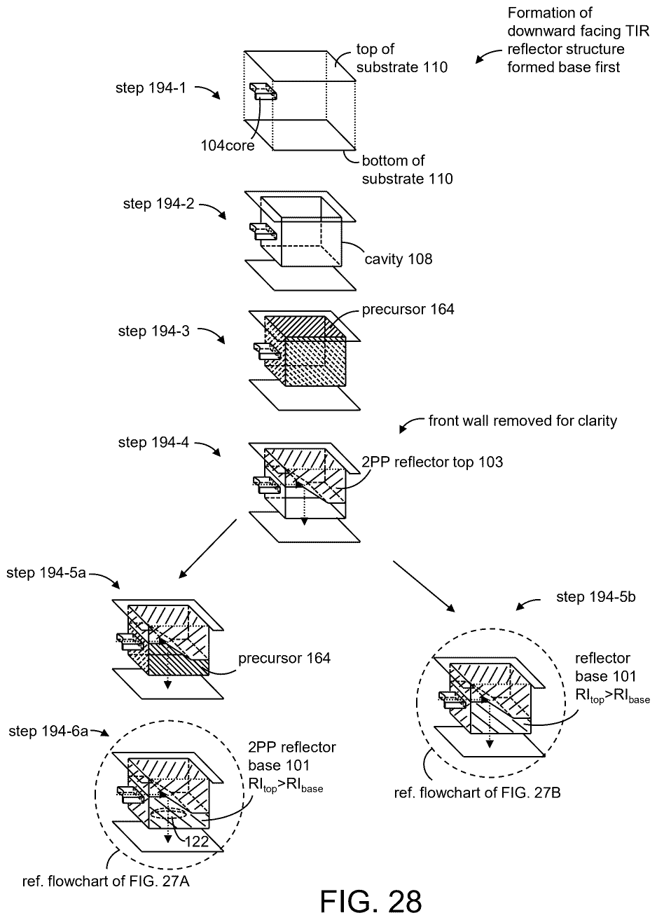

FIG. 27A shows a flowchart for a method 194 of forming embodiments of reflector structure 100 configured to provide a downward-facing TIR reflector structure that includes a reflector top 103 and a reflector base 101 formed below the reflector top 103 wherein the reflector top 103 is firstly formed using two-photon polymerization and the reflector base 101 is subsequently formed below the reflector top 103 also using two-photon polymerization. TIR reflector structures 100, in embodiments, require differing refractive indices between the material in the reflector top 103 and the material in the reflector base 101. Embodiments of a downward-facing reflector structure 100 formed using method 194 include a reflector top 103, a reflector base 101 configured having a refractive index that is greater than the refractive index of the reflector top 103, and substrate 110 having cavity 108 that intersects planar waveguide core 104_{core} of planar waveguide 104. Both the reflector top 103, and the reflector base 101 of the embodiment of reflector structure 100 are formed using two-photon polymerization.

Steps in method 194 are described in conjunction with the perspective drawings shown in FIG. 28. The circled perspective drawings in FIG. 28 show embodiments of reflector structure 100.

Step 194-1 of method 194 is a forming step in which a substrate 110 is formed having planar waveguide 104, wherein the planar waveguide core 104_{core} of the planar waveguide 104 is configured having a first refractive index. The perspective drawing labeled “Step 194-1” in FIG. 28 shows the planar waveguide core 104_{core} of a planar waveguide 104 formed between the top of the substrate 110 and the bottom of the substrate 110 in the schematic drawing.

Step 194-2 of method 194 is a forming step in which cavity 108 is formed in substrate 110 having the planar waveguide 104, wherein a wall of the cavity 108 intersects the planar waveguide core 104_{core} of the planar waveguide 104. The perspective drawing labeled “Step 194-2” in FIG. 28 shows cavity 108 formed in the substrate 110 wherein a wall of the cavity 108 intersects the planar waveguide core 104_{core} of the planar waveguide 104 formed between the top of the substrate 110 and the bottom of the substrate 110 in the schematic drawing.

Step 194-3 of method 194 is a filling step in which all or a portion of cavity 108 is filled with a two-photon polymerization precursor 164. The perspective drawing labeled “Step 194-3” in FIG. 28 shows cavity 108 in substrate 110 filled with two-photon polymerization precursor 164 in the schematic drawing.

Step 194-4 of method 194 is a forming step in which a reflector top 103 is formed in cavity 108 using two-photon polymerization of the two-photon polymerization precursor 164 wherein the reflector top 103 is formed having a second refractive index. The perspective drawing labeled “Step 194-4” in FIG. 28 shows cavity 108 formed in substrate 110 having a reflector top 103 formed using two-photon polymerization of the two-photon polymerization precursor 164 in the schematic drawing.

For clarity, the front wall of cavity 108 is not shown in the perspective drawings labeled “Step 194-4”, “Step 194-5a”, “Step 194-6a”, and “Step 194-5b” in FIG. 28.

Step 194-5a of method 194 is a filling step in which all or a portion of the remaining cavity 108 having reflector top 103 is filled with a two-photon polymerization precursor 164. The perspective drawing labeled “Step 194-5a” in FIG. 28 shows the two-photon polymerization precursor 164 filling the portion of the cavity 108 unoccupied by the reflector top 103.

Step 194-6a of method 194 is a forming step in which reflector base 101 is formed in all or a portion of the remaining cavity 108 using two-photon polymerization of the two-photon polymerization precursor 164 wherein the reflector base 101 is configured having a third refractive index, wherein the third refractive index is greater than the second refractive index (of the reflector top 103), and wherein the reflector base 101 is optionally configured having one or more lens feature 122. In preferred embodiments formed using method 194, the third refractive index is equal to, or approximately equal to, the first refractive index (of the planar waveguide core 104_{core}.) Matching, or approximate matching, of the refractive index of the reflector base 101 with the refractive index of the planar waveguide core 104_{core} of the planar waveguide 104 can reduce or minimize the divergence of optical signals propagating from the planar waveguide 104 to the reflector base 101 in the embodiments of the reflector structure 100 formed using method 194. The perspective drawing labeled “Step 194-6a” in FIG. 28 shows cavity 108 having reflector base 101 formed below reflector top 103 using two-photon polymerization of the two-photon polymerization precursor 164 in the schematic drawing. The drawing also shows optional lens feature 122 formed in reflector base 101. Use of two-photon polymerization to form the reflector base 101 in the embodiment of the reflector structure 100 enables the formation of one or more optional lens feature 122 that may not be achievable using other methods of forming the optional reflector base 101.

Two methods of forming reflector base 101 are disclosed for embodiments of reflector structure 100 formed using method 194. Firstly, steps 194-5a and 194-6a may follow steps 194-1 to 194-4 to provide for the formation of reflector base 101 in reflector structure 100 wherein reflector base 101 is formed using two-photon polymerization. Alternatively, step 194-5b may follow steps 194-1 to 194-4 to provide for the formation of reflector base 101 in reflector structure 100 using a conformal fill layer.

FIG. 27B shows a flowchart for a method 194 of forming embodiments of reflector base 101 using a conformal fill layer. Step 194-5b of method 194 is an alternative forming step to the filling and forming steps 194-5a and 194-6a, respectively, of the flowchart of method 194 shown in FIG. 27A. The reflector base 101 is formed in step 194-5b of the method 194 in FIG. 27B using a conformal fill layer. Steps 194-1 to 194-4 in the flowcharts in FIG. 27A and in FIG. 27B are identical.

FIG. 28 shows the perspective drawing labeled “Step 194-5b” wherein cavity 108 is configured having the reflector base 101 formed below the reflector top 103 using a conformal fill layer in the schematic drawing. The reflector base 101 in the embodiment of the reflector structure 100 formed using the flowchart in FIG. 27B is configured having a third refractive index, wherein the third refractive index is greater than the second refractive index, and wherein the third refractive index is preferably equal to, or approximately equal to, the first refractive index (of the planar waveguide core 104_{core} of the planar waveguide 104).

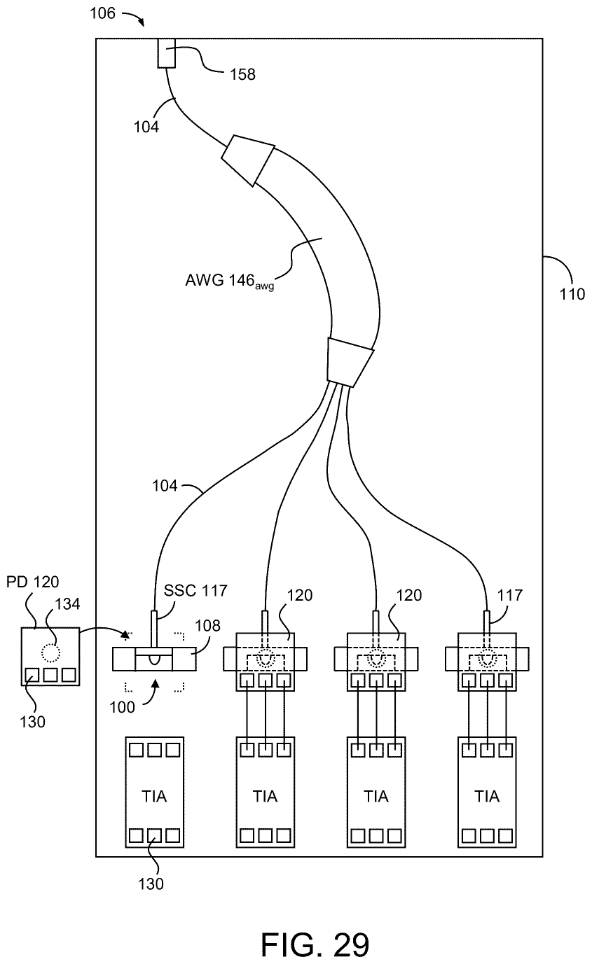

FIG. 29 shows an embodiment of a PIC assembly 106 comprising a plurality of reflector structures 100 wherein the reflector structures 100 are formed in part using two-photon polymerization. In the embodiment, four cavities 108 are shown formed in substrate 110 such that a wall of each cavity 108 intersects a planar waveguide 104 formed on the substrate 110. In some embodiments, substrate 110 may be an interposer substrate 110ᵢₙₜ having an optional electrical interconnect layer 153 formed on a substratum 150. Reflector structures 100 are shown comprising the substrate 110 having one or more planar waveguides 104, a cavity 108 that intersects the planar waveguide core 104_{core} of a planar waveguide 104, and one or more of a reflector base 101, a reflective layer 102, and a reflector top 103 formed in the cavity 108. Mounted devices 120, configured for example, as photodiodes, are shown in the embodiment of the PIC assembly 106 mounted over the cavity 108. In embodiments, an aperture 134 of a mounted device 120, as described herein, may be coupled to the reflector structure 100 to be receptive to an optical signal 170 propagating in a planar waveguide 104 and reflected by the reflector structure 100. A mounted device 120 is shown having labeled “aperture 134” in FIG. 29 in an unmounted position for clarity. Optional spot size converters 117, formed all or in part from a planar waveguide 104, may be included in reflector structure 100. Spot size converters may be used, for example, to improve the coupling of optical signals 170 to mounted devices 120.

In the embodiment of the PIC assembly 106 shown in FIG. 29, the plurality of reflector structures 100 are coupled to an arrayed waveguide 146_{awg} as may be used, for example, in an embodiment of a PIC assembly 106 configured as a demultiplexing device. An optical signal 170 may be, for example, a multiplexed optical signal 170ₘᵤₓ having a plurality of optical wavelengths. Optical signal 170ₘᵤₓ may be provided to substrate 110, for example, through an optical fiber cable 156 mounted in optical fiber cable mounting site 158. In some embodiments, mounting site 158 may be, for example, a v-groove. In other embodiments, mounting site 158 may be a mounting site for a fiber attachment unit. Multiplexed optical signal 170ₘᵤₓ, may be provided to PIC assembly 106 through an optical fiber cable 156 mounted in optical fiber cable mounting site 158 and further provided to a planar waveguide 104 on substrate 110. The multiplexed optical signal 170ₘᵤₓ may become a plurality of demultiplexed single wavelength optical signals 170_{demux} upon propagation through the arrayed waveguide 146_{awg}. The demultiplexed optical signals 170_{demux}, each propagating in a planar waveguide 104 in the embodiment shown in FIG. 29, may enter a cavity 108 that intersects one of the planar waveguides 104 to be reflected by a reflector structure 100 to be received by the mounted device 120, configured, for example, as a photodiode or other receiving device. Each mounted device 120, configured as a photodiode, may be further coupled to other circuit elements such as, for example, a transimpedance amplifier, which may be further coupled to one or more of another device, a circuit, or network.

Reflectors Configured for Reflecting Optical Signals into Planar Waveguides

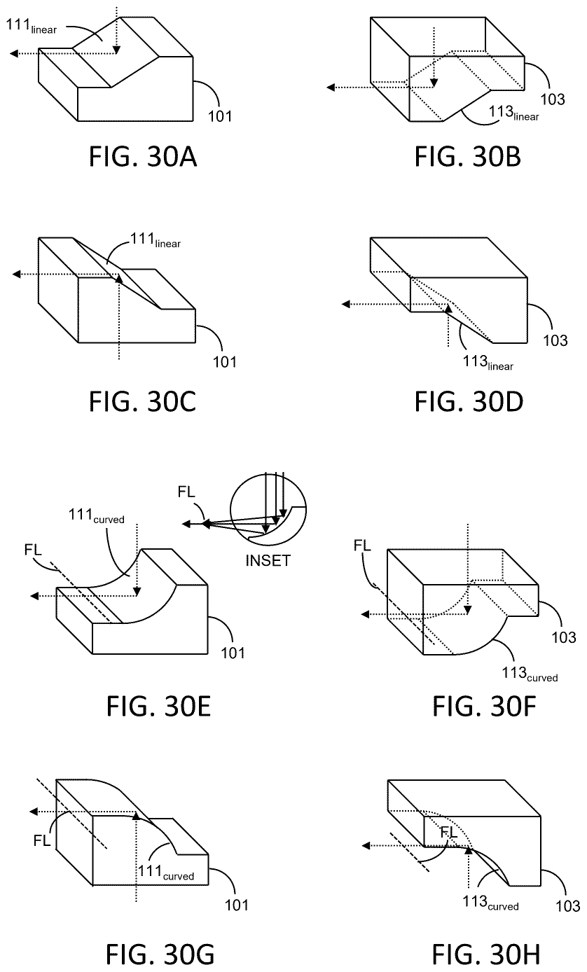

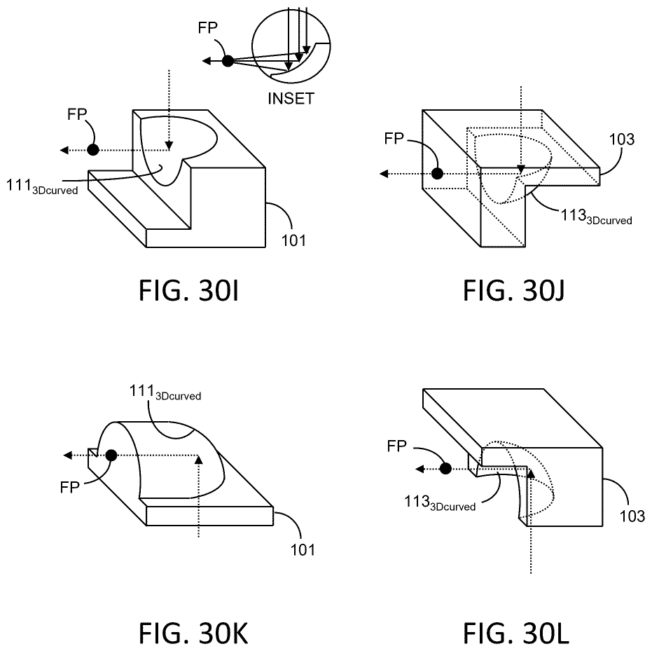

FIGS. 30A-30L show schematic perspective drawings of reflector bases 101 and reflector tops 103 used in embodiments of reflector structures 100 configured to reflect an optical signal into the terminal facet of a planar waveguide. In some embodiments that are upward-facing, the reflector structures 101 may be configured to receive an optical signal, for example, from a mounted device mounted or otherwise positioned over the cavity 108, that is reflected by a contoured reflecting surface of the reflector structure 100 and into the terminal facet of the planar waveguide 104. One or more optional lens features may be provided on portions of the reflector structure 100 formed all or in part using two-photon polymerization. And in other embodiments, that are downward-facing, the reflector structures 101 may be configured to receive an optical signal, for example, from a mounted device mounted or otherwise positioned below the cavity 108, that is reflected by a contoured reflecting surface of the reflector structure 100 and into the terminal facet of the planar waveguide 104.

FIG. 30A shows a schematic perspective drawing of a reflector base 101 that may be used in the formation of upward-facing embodiments wherein the reflector base 101 is configured having a linearly sloping contoured reflecting surface 111ₗᵢₙₑₐᵣ and wherein the reflector base 101 is configured to receive an optical signal from an upper portion of the cavity 108 and reflect the signal to the planar waveguide 104.

FIG. 30B shows a schematic perspective drawing of a reflector top 103 that may be used in the formation of upward-facing embodiments wherein the reflector top 103 is configured having a linearly sloping contoured reflecting surface 113ₗᵢₙₑₐᵣ.

FIG. 30C shows a schematic perspective drawing of a reflector base 101 that may be used in the formation of downward-facing embodiments wherein the reflector base 101 is configured having a linearly sloping contoured reflecting surface 111ₗᵢₙₑₐᵣ.

FIG. 30D shows a schematic perspective drawing of a reflector top 103 that may be used in the formation of downward-facing embodiments wherein the reflector top 103 is configured having a linearly sloping contoured reflecting surface 113ₗᵢₙₑₐᵣ.

FIG. 30E shows a schematic perspective drawing of a reflector base 101 that may be used in the formation of upward-facing embodiments wherein the reflector base 101 is configured having two-dimensionally curved, contoured reflecting surface 111_{curved}. The INSET shows an enlarged cross-section of an example optical signal received from an upper portion of the cavity 108, and reflected from a contoured reflecting surface to a focal line “FL” as determined, for example, by the curvature of the contoured reflecting surface 111_{curved}.

FIG. 30F shows a schematic perspective drawing of a reflector top 103 that may be used in the formation of upward-facing embodiments wherein the reflector top 103 is configured having two-dimensionally curved, contoured reflecting surface 113_{curved}.

FIG. 30G shows a schematic perspective drawing of a reflector base 101 that may be used in the formation of downward-facing embodiments wherein the reflector base 101 is configured two-dimensionally curved, contoured reflecting surface 111_{curved}.

FIG. 30H shows a schematic perspective drawing of a reflector top 103 that may be used in the formation of downward-facing embodiments wherein the reflector top 103 is configured having two-dimensionally curved, contoured reflecting surface 113_{curved}.

FIG. 30I shows a schematic perspective drawing of a reflector base 101 that may be used in the formation of upward-facing embodiments wherein the reflector base 101 is configured having three-dimensionally curved, contoured reflecting surface 111_{3Dcurved}. The INSET shows an enlarged cross-section of an example optical signal received from an upper portion of the cavity 108 and reflected from a contoured reflecting surface to a focal point “FP” as determined, for example, by the curvature of the contoured reflecting surface 111_{3Dcurved}.

FIG. 30J shows a schematic perspective drawing of a reflector top 103 that may be used in the formation of upward-facing embodiments wherein the reflector top 103 is configured having three-dimensionally curved, contoured reflecting surface 113_{3Dcurved}.

FIG. 30K shows a schematic perspective drawing of a reflector base 101 that may be used in the formation of downward-facing embodiments wherein the reflector base 101 is configured having three-dimensionally curved, contoured reflecting surface 111_{3Dcurved}.

FIG. 30L shows a schematic perspective drawing of a reflector top 103 that may be used in the formation of downward-facing embodiments wherein the reflector top 103 is configured having three-dimensionally curved, contoured reflecting surface 113_{3Dcurved}.

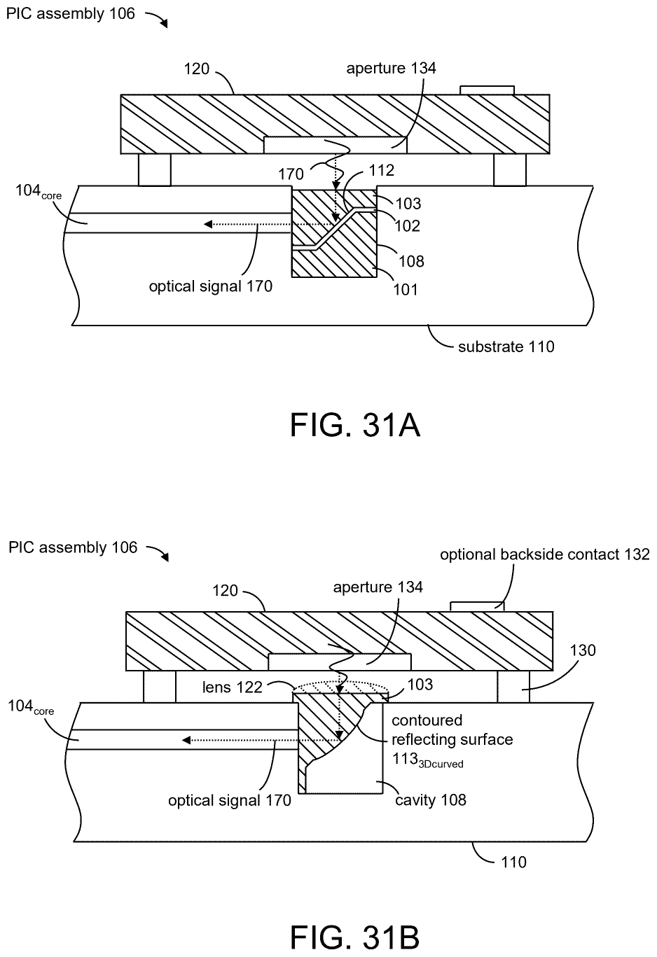

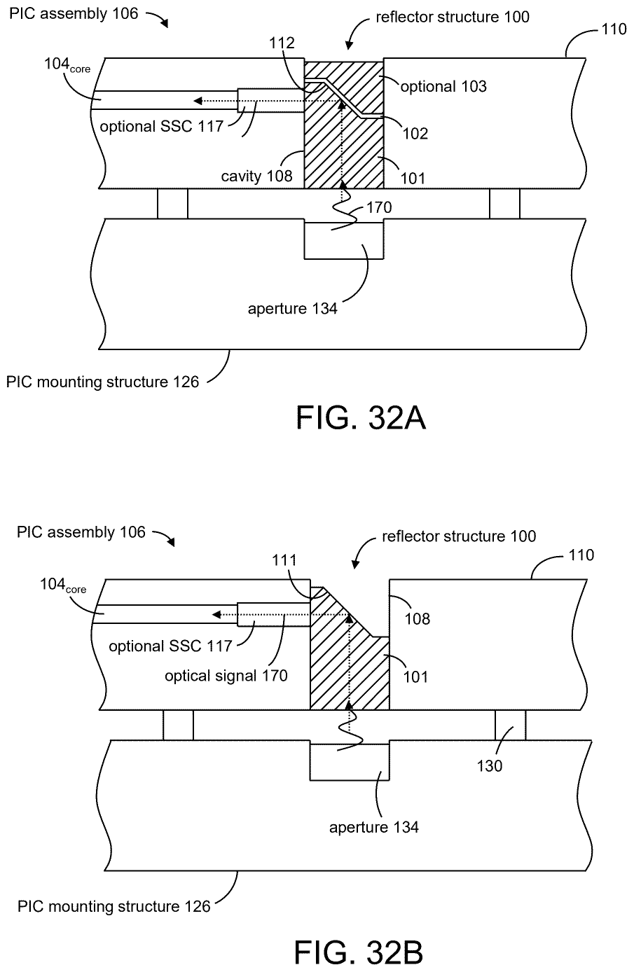

Embodiments of reflector bases 101 and reflector tops 103 as shown in FIGS. 30A-30L may be used, for example, in assemblies such as is shown in FIGS. 31A and 31B and FIGS. 32A and 32B.

FIG. 31A shows a schematic cross-sectional drawing of a PIC assembly 106 having upward-facing reflector structure 100 and mounted device 120 mounted on the substrate 110 of reflector structure 100 wherein the contoured reflective surface 112 is configured to receive an optical signal from the mounted device 120 and to reflect the optical signal to the planar waveguide core 104_{core} of the planar waveguide 104. FIG. 31A shows an embodiment configured having a reflector base as in FIG. 30A and a reflector top as in FIG. 30B. Also shown is reflective layer 102 having contoured reflecting surface 112. The reflector structures shown in FIG. 31A may also be configured having the curved contoured reflecting surface 113 of the reflector tops 103 as in FIGS. 30F and 30J, formed on the reflector bases 101 as in FIGS. 30E and 30I, respectively.

FIG. 31B shows a schematic cross-sectional drawing of a PIC assembly 106 having downward-facing reflector structure 100 and mounted device 120 mounted on the substrate 110 of reflector structure 100 wherein the contoured reflective surface 113 is configured to receive an optical signal from the mounted device 120 and to reflect the optical signal to the planar waveguide core 104_{core} of the planar waveguide 104. In the embodiment, the reflector top 103 is configured having a lens feature 122 to facilitate focusing of the optical signal 170 from the aperture 134 of the mounted device 120 onto the contoured reflector surface 113 of the reflector structure 100 in the embodiment. FIG. 31B shows an embodiment configured having a reflector top as in FIG. 30F. The reflector structures shown in FIG. 31B may also be configured having the linear contoured reflecting surface 113 of FIG. 30B and the two-dimensionally curved contoured reflecting surface 113 of FIG. 30J the reflector tops as in FIGS. 30F and 30J.

FIG. 32A shows a schematic cross-sectional drawing of a PIC assembly 106 having downward-facing reflector structure 100 and PIC mounting structure 126 on which the substrate 110 of reflector structure 100 is mounted. The contoured reflective surface 112 is configured to receive an optical signal from the underlying (as shown) PIC mounting structure 126 and to reflect the optical signal to an optional spot size converter 117 positioned between the cavity 108 and the planar waveguide core 104_{core} of the planar waveguide 104. In some embodiments, the spot size converter may be formed from all or a portion of the planar waveguide core 104_{core} of the planar waveguide 104. FIG. 32A shows an embodiment configured having a reflector base 101 as in FIG. 30C and optional reflector top 103 as in FIG. 30D. Also shown is reflective layer 102 having contoured reflecting surface 112. The reflector structures shown in FIG. 32A may also be configured having the curved contoured reflecting surface 111 of the reflector base 101 as in FIGS. 30G and 30K, and the optional reflector tops 103 as in FIGS. 30H and 30L, respectively.

FIG. 32B shows a schematic cross-sectional drawing of a PIC assembly 106 having downward-facing reflector structure 100 and PIC mounting structure 126 on which the substrate 110 of reflector structure 100 is mounted. The contoured reflective surface 112 is configured to receive an optical signal from the underlying (as shown) PIC mounting structure 126 and to reflect the optical signal to an optional spot size converter 117 positioned between the cavity 108 and the planar waveguide core 104_{core} of the planar waveguide 104. FIG. 32B shows an embodiment configured having a reflector base 101 as in FIG. 30C. The reflector structures shown in FIG. 32B may also be configured having the curved contoured reflecting surface 111 of the reflector base 101 as in FIGS. 30G and 30K.

Figures provided herein may not be drawn to scale but rather are intended to include and convey the various features comprising the embodiments described. As such, the various layers and regions illustrated in the figures are illustrated schematically. The physical dimensions of a substrate having a photonic integrated circuit as described herein, for example, may be on the order of 1-30 millimeters in length and width and formed on a substrate that may, for example, be on the order of 0.5 to 1 mm in thickness. In comparison, the dimensions of a typical optical fiber cable are approximately 900 microns for the jacket, 250 microns for the cladding coating, 125 microns for the cladding, and 10 microns for the core. In further comparison, the thicknesses of the core layer of a planar waveguide layer on a substrate may be, but are not limited to, 0.2 to 3 microns with cladding layers on the order of 1-10 microns in thickness. Although the actual dimensions may vary over a wide range, they indicate the broad differences in dimensions of key features described in embodiments. As such, efforts have been made to include and describe the features of the embodiments without undue concern for maintaining dimensional scale for these features in relation to other features.

The foregoing descriptions of embodiments have been presented for purposes of illustration and description and are not intended to be exhaustive or to limit embodiments to the forms disclosed. Modifications to, and variations of, the disclosed embodiments will be readily apparent to those skilled in the art, and the general principles defined herein may be applied to other embodiments without departing from the spirit and scope of the embodiments disclosed herein. Thus, embodiments should not be limited to those specifically described herein but rather are to be accorded the widest scope consistent with the principles and features disclosed herein.

Table of Key Components Numbering

| Component | | |
|---|---|---|
| Number | Component Name | Description |
| 100 | Reflector Structure | |
| 101 | Reflector Base | Base or bottom portion of reflector structure |
| 102 | Reflective Layer | Metallic or dielectric layer on reflector base |
| 103 | Reflector Top | top portion of reflector structure |
| 104 | Planar Waveguide | All or portion of optical WG formed on substratum |
| 106 | PIC assembly | |
| 107 | Base structure | Substrate and optional EIL |
| 108 | Cavity | Recess formed in substrate, intersects PWG core |
| 110 | Substrate | Base material supporting waveguide and cavity |
| 111 | Contoured surface | Contoured reflective surface of reflector base 101 |
| 112 | Contoured reflecting surface | Contoured reflective surface of reflective layer 102 |
| 113 | Contoured reflecting surface | Contoured reflective surface of reflector top 103 |
| 116 | Patterned layer | |
| 117 | Spot Size Converter | Device that alters the size of an optical signal |
| 119 | Lens mount | |
| 120 | Mounted Device | Device (e.g., photodiode, fiber) receiving or emitting |
| | | optical signals |
| 121 | Vertical lens | Vertical lens formed in reflector structure |
| 122 | Lens Feature | Integrated lens for focusing or conditioning optical signals |
| 124 | Pedestal | |
| 126 | PIC Mounting Structure | Structure on which a PIC assembly may be mounted |
| 130 | Electrical connection | Contact layer for forming an electrical connection |
| 132 | Electrical connection | Backside contact of mounted device |
| 134 | Aperture | Receiving aperture of mounted device |
| 146 | Arrayed waveguide | |
| 150 | Substratum | Mechanical support for the PWG and optional EIL |
| 153 | Electrical Interconnect Layer | Layer for electrical connections in substrate/interposer |
| 155 | Planar Waveguide layer | All or part of the layer from which a PWG is formed |
| 156 | Optical Fiber Cable | Fiber for optical signal transmission |
| 158 | Mounting site | Mounting site for optical fiber cable |
| 160 | Fiber Cable Mount | Mounting structure for optical fiber cable |
| 164 | 2PP Precursor | Two-photon polymerization resin used from which |
| | | reflector structures may be formed |
| 166 | 2PP Apparatus | Equipment for two-photon polymerization fabrication |
| 170 | Optical Signal | Light signal propagating through PWG & reflector |
| | | structures |

What is claimed is:

1. A structure comprising
a substrate,
a waveguide formed on the substrate,
a reflector element formed in the substrate,
wherein the reflector element comprises layers of solid cross-linked polymerized resin with the layers stacked with a resolution equal or less than 2 microns,
wherein the layers form a surface facing a terminal facet of the waveguide,
wherein the surface is configured to reflect an optical signal propagating from the waveguide to a top surface area or a bottom surface area of the substrate.

2. A structure as in claim 1, wherein one of
(i) the surface is configured as a top surface of the reflector element,
the top surface is configured to reflect the optical signal inside the reflector element in a total internal reflection mechanism,
the reflector element comprises a bottom surface opposite the top surface, with the bottom surface disposed below a horizontal plane intersecting the optical signal,
(ii) the surface is configured as a top surface of the reflector element,
the top surface is configured to reflect the optical signal outside the reflector element,
the reflector element comprises a bottom surface opposite the top surface, with the bottom surface disposed below a horizontal plane intersecting the optical signal,
(iii) the surface is configured as a top surface of the reflector element,
the reflector element comprises a reflective layer disposed on the top surface,
the reflective layer is configured to reflect the optical signal outside the reflector element,
the reflector element comprises a bottom surface opposite the top surface, with the bottom surface disposed below a horizontal plane intersecting the optical signal,
(iv) the surface is configured as a bottom surface of the reflector element,
the bottom surface is configured to reflect the optical signal inside the reflector element in a total internal reflection mechanism,
the reflector element comprises a top surface opposite the bottom surface, with the top surface disposed above a horizontal plane intersecting the optical signal,
(v) the surface is configured as a bottom surface of the reflector element,
the bottom surface is configured to reflect the optical signal outside the reflector element,
the reflector element comprises a top surface opposite the bottom surface, with the top surface disposed above a horizontal plane intersecting the optical signal, or
(vi) the surface is configured as a bottom surface of the reflector element,
the reflector element comprises a reflective layer disposed on the bottom surface,
the reflective layer is configured to reflect the optical signal outside the reflector element,
the reflector element comprises a top surface opposite the bottom surface, with the top surface disposed above a horizontal plane intersecting the optical signal.

3. A structure as in claim 1, further comprising
a filler portion comprising a polymer material,
wherein the filler portion contacts the surface and disposed above or below the surface.

4. A structure as in claim 1,
wherein the reflector element extends through a portion of a thickness of the substrate or through the whole substrate, or
wherein the reflector element is disposed in a cavity, with the cavity extending through the portion of the thickness of the substrate or through the whole substrate.

5. A structure as in 1,
wherein the resin comprises a solid or viscous liquid convertible into the cross-linked polymer under a UV or IR focused irradiation.

6. A structure as in claim 1,
wherein the surface comprises one or more of a planar surface, a curved surface varying in two dimensions, or a surface having three-dimensional curvature.

7. A structure as in claim 1, further comprising
a pedestal protruded from the reflector element to a substrate surface for providing support and rigidity to the reflector element.

8. A structure comprising
a substrate,
wherein the substrate comprises an interconnection layer,
wherein the interconnection layer comprises one or more interconnection lines disposed in one or more levels and one or more vias connected to the one or more interconnection lines,
a waveguide disposed on the substrate,
a first alignment aid element disposed on the substrate,
wherein the first alignment aid element is configured to align, in a plane perpendicular to the substrate, a first optical axis of the waveguide with a second optical axis of an optical or optoelectrical device to be mounted on the first alignment aid element,
a second alignment aid element disposed on the substrate,
wherein the second alignment aid element is configured to restrict movements of the optical or optoelectrical device, in a plane parallel to the substrate, by comprising at least one of a distance or an orientation between the first optical axis and the second alignment aid element within an alignment accuracy value or within less than 0.2 microns difference to a design value,
a reflector element formed in the substrate,
wherein the reflector element comprises layers of solid cross-linked polymerized resin with the layers stacked with a resolution equal or less than 2 microns,
wherein the layers form a surface facing a terminal facet of the waveguide,
wherein the surface is configured to reflect an optical signal propagating from the waveguide to a top surface area or a bottom surface area of the substrate.

9. A structure as in claim 8, further comprising
a reflective layer disposed on the surface.

10. A structure as in claim 8, further comprising
a first electrical device formed under the interconnection layer, and
wherein an electrical interconnection line of the one or more interconnection lines is electrically connected to a terminal of the first electrical device.

11. A structure as in claim 8, further comprising
the optical or optoelectrical device mounted on the first alignment aid element,
wherein a separation between the second alignment aid element and an edge of the optical or optoelectrical device is less than or equal to an accuracy of a pick-and-place process or less than or equal to 0.3 mm.

12. A structure as in claim 8, further comprising
a second optical or optoelectrical device mounted above the substrate or on a top surface of the substrate above the top opening of the cavity,
wherein the second optical or optoelectrical device is configured to intercept the optical signal reflected from the surface of the reflector.

13. A structure as in claim 8, further comprising
a second optical or optoelectrical device mounted above the substrate or on a top surface of the substrate above the top opening of the cavity,
wherein the second optical or optoelectrical device is configured to intercept the optical signal reflected from the surface of the reflector,
wherein the second optical or optoelectrical device is connected to an interconnect line of the one or more interconnection lines in the interconnection layer.

14. A structure as in claim 8, further comprising
a third optical or optoelectrical device mounted below the substrate or at a bottom surface of the substrate below the bottom opening of the cavity,
wherein the third optical or optoelectrical device is configured to intercept the optical signal reflected from the surface of the reflector,
wherein the third optical or optoelectrical device is connected to an interconnect line of the one or more interconnection lines in the interconnection layer.

15. A structure as in claim 8, further comprising
a second substrate configured to accept the substrate, with the second substrate comprising a fourth optical or optoelectrical device,
wherein the substrate is mounted on the second substrate, with the fourth optical or optoelectrical device configured to intercept the optical signal reflected from the surface of the reflector in the substrate,
wherein the fourth optical or optoelectrical device is connected to an interconnect line of the one or more interconnection lines in the interconnection layer.

16. A structure as in claim 8,
wherein the layers form a first lens comprising a spot size converter configured to reduce a spot size of the optical signal between the waveguide and the reflector element.

17. A structure as in claim 8,
wherein the layers form a second lens configured to reduce divergence of the optical signal between the reflector element and a top-mounted or a bottom mounted device, with the top-mounted or a bottom mounted device connected to an interconnect line of the one or more interconnection lines in the interconnection layer.

18. A structure as in claim 8,
wherein the layers form a first lens comprises a spot size converter configured to reduce a spot size of the optical signal between the waveguide and the reflector element,
wherein the layers form a second lens is configured to reduce divergence of the optical signal between the reflector element and an optical fiber assembled in a fiber mount with the optical fiber comprising a removed fiber cladding.

19. An assembly comprising
a first substrate,
wherein the first substrate comprises an interconnection layer,
wherein the interconnection layer comprises one or more interconnection lines disposed in one or more levels and one or more vias connected to the one or more interconnection lines,
a waveguide disposed on the first substrate,
a first alignment aid element disposed on the first substrate,
wherein the first alignment aid element is configured to align, in a plane perpendicular to the substrate, a first optical axis of the waveguide with a second optical axis of a first optical or optoelectrical device to be mounted on the first alignment aid element,
a second alignment aid element disposed on the first substrate,
wherein the second alignment aid element is configured to restrict movements of the optical or optoelectrical device, in a plane parallel to the substrate, by comprising at least one of a distance or an orientation between the first optical axis and the second alignment aid element within an alignment accuracy value or within less than 0.2 microns difference to a design value,
a reflector element formed in the first substrate,
wherein the reflector element comprises layers of solid cross-linked polymerized resin with the layers stacked with a resolution equal or less than 2 microns,
wherein the layers form a surface facing a terminal facet of the waveguide,
wherein the surface is configured to reflect an optical signal propagating from the waveguide to a bottom surface area of the first substrate,
a second substrate,
a second optical or optoelectrical device disposed on the second substrate,
wherein the first substrate is mounted on the second substrate so that the second optical or optoelectrical device is configured to intercept the optical signal reflected from the surface of the reflector and propagated through the bottom surface area of the first substrate,
wherein the second optical or optoelectrical device is connected to an interconnect line of the one or more interconnection lines in the interconnection layer.

20. An assembly as in claim 19,
wherein the layers further form a first lens comprising a spot size converter configured to reduce a spot size of the optical signal between the waveguide and the reflector element,
wherein the layers further form a second lens configured to reduce divergence of the optical signal between the reflector element and the second optical or optoelectrical device.
